(19) United States
(12) Patent Application Publication
(10) Pub. No.: US 2017/0300329 A1
(43) Pub. Date: Oct. 19, 2017

(54) INSTRUCTION EXECUTION CONTROL SYSTEM AND INSTRUCTION EXECUTION CONTROL METHOD

(71) Applicant: Renesas Electronics Corporation, Tokyo (JP)

(72) Inventors: Koichiro NOGUCHI, Tokyo (JP); Osamu OKAZAKI, Tokyo (JP); Shunichi KAERIYAMA, Tokyo (JP); Koichi NOSE, Tokyo (JP)

(21) Appl. No.: 15/513,544

(22) PCT Filed: Nov. 11, 2014
(86) PCT No.: PCT/JP2014/005663

§ 371 Date: Mar. 22, 2017

(51) Int. Cl. G06F 9/30; G06F 9/38

(52) U.S. Cl. CPC G06F 9/30076; G06F 9/38

(57) ABSTRACT

An instruction execution control system includes a plurality of instruction storage units configured to output instructions in an FIFO order to a plurality of instruction execution units configured to execute the instructions; an instruction control unit configured to assign each of a plurality of the sequentially input instructions to one of the instruction storage units, and an output control unit configured to control the output of the instructions from the instruction storage units. When the input instruction is a dummy instruction to be inserted between instructions that should be executed in an execution order, the instruction control unit distributes the input instruction to the plurality of instruction storage units. The output control unit stops the output of the instructions from the instruction storage unit, the instruction output therefrom has become the dummy instruction, to the instruction execution unit until instructions output from all instruction storage units become the dummy instructions.

### TECHNICAL FIELD

The present invention relates to an instruction execution control system and an instruction execution control method and, in particular, to a technique for executing instructions in parallel.

### BACKGROUND ART

Patent Literature 1 discloses a technique for guaranteeing an execution order of instructions in a system having a function to overtake other instructions in a memory access. With this technique, if an instruction issued by an instruction issue device is a barrier instruction, an instruction execution control device sets a pre barrier flag of the instruction registered in a storage unit to one. On the other hand, if an instruction issued by the instruction issue device is not a barrier instruction, the instruction is registered in the storage unit, and it is evaluated as to whether or not a pair of the registered instruction and the instruction, the pre barrier flag of which is one, is a combination of an instruction type on which order guarantee control is to be performed.

If the pair of the instructions is a combination of the instruction type on which the order guarantee control is to be performed, the instruction execution control device sets an overtake prohibition flag of the instruction, the pre barrier flag of which is one, to one. When the instruction execution control device executes the instruction, the instruction execution control device clears the pre barrier flag and the overtake prohibition flag of the executed instruction. The instruction execution control device then suspends execution of an instruction(s) that has been registered after a previously registered instruction(s) until the overtake prohibition flag is cleared. In this way, the execution order of instructions is guaranteed.

### CITATION LIST

### Patent Literature

Patent Literature 1: Japanese Unexamined Patent Application Publication No. 2014-153851

### SUMMARY OF INVENTION

### Technical Problem

However, the technique disclosed in Patent Literature 1 is not a technique that guarantees an execution order of instructions in a system in which a plurality of instruction execution units independently execute instructions in parallel.

Other problems of the related art and new features of the present invention will become apparent from the following descriptions of the specification and attached drawings.

### Solution to Problem

According to an embodiment, in an instruction execution control system, when an input instruction is a dummy instruction to be inserted between instructions that should be executed in an execution order, the input instruction is distributed to all of a plurality of instruction storage units, and an output of the instructions from the instruction storage unit, the instruction output therefrom has become the dummy instruction, to an instruction execution unit is stopped until the instructions output from all of the plurality of instruction storage units become the dummy instructions.

### Advantageous Effects of Invention

According to the above embodiment, it is possible to guarantee an execution order of instructions.

### BRIEF DESCRIPTION OF DRAWINGS

FIG. 1 is a block diagram of a module control system according to a first embodiment;

FIG. 2 is a block diagram of an interface board and an external calculator according to the first embodiment;

FIG. 3 is a drawing showing a software configuration and a hardware configuration of the external calculator 3 according to the first embodiment;

FIG. 4 is a drawing showing an execution order of instructions according to the first embodiment;

FIG. 5 is a flowchart showing an operation of the module control system according to the first embodiment;

FIG. 6 is a flowchart showing an operation of the external calculator according to the first embodiment;

FIG. 7 is a flowchart showing an operation of the interface board (a transmission control function and a dummy instruction detection function) according to the first embodiment;

FIG. 8 is a flowchart showing an operation of the interface board (a timing adjusting function) according to the first embodiment;

FIG. 9 is a block diagram clearly showing a reception function of the interface board according to the first embodiment;

FIG. 10 is a drawing showing an example in which instructions are not executed in an execution order;

FIG. 11 is a block diagram showing a modified example 1 of the module control system according to the first embodiment;

FIG. 12 is a block diagram showing a modified example 2 of the module control system according to the first embodiment;

FIG. 13 is a block diagram showing an interface board and an external calculator according to a second embodiment;

FIG. 14 is a block diagram showing a modified example of the module control system according to the second embodiment;

FIG. 15 is a block diagram showing an interface board and an external calculator according to a third embodiment;

FIG. 16 is a drawing showing an execution order of instructions according to the third embodiment;

FIG. 17 is a flowchart showing an operation of the interface board (a timing adjusting function) according to the third embodiment;

FIG. 18 is a block diagram showing an interface board and an external calculator according to a fourth embodiment;

FIG. 19 is a drawing showing an execution order of instructions according to the fourth embodiment;

FIG. 20 is a block diagram showing a modified example of a module control system according to the fourth embodiment;

FIG. 21 is a block diagram showing an interface board and an external calculator according to a fifth embodiment;

FIG. 22 is a drawing showing an execution order of instructions according to the fifth embodiment;

FIG. 23 is a flowchart showing an operation of the interface board (a timing adjusting function) according to the fifth embodiment;

FIG. 24 is a block diagram showing an interface board and an external calculator according to a sixth embodiment;

FIG. 25 is a block diagram showing an interface board and an external calculator according to a seventh embodiment;

FIG. 26 is a block diagram showing an interface board and an external calculator according to an eighth embodiment;

FIG. 27 is a drawing showing an execution order of instructions according to the eighth embodiment;

FIG. 28 is a flowchart showing an operation of the interface board (a transmission control function and a dummy instruction detection function) according to the eighth embodiment;

FIG. 29 is a block diagram showing a module control system according to a ninth embodiment;

FIG. 30 is a block diagram showing the module control system according to the ninth embodiment;

FIG. 31 is a block diagram showing the module control system according to the ninth embodiment;

FIG. 32 is a drawing showing an execution order of instructions according to the ninth embodiment;

FIG. 33 is a block diagram showing a module control system according to a tenth embodiment;

FIG. 34 is a block diagram showing the module control system according to the tenth embodiment;

FIG. 35 is a block diagram showing the module control system according to the tenth embodiment; and

FIG. 36 is a drawing showing an execution order of instructions according to the tenth embodiment.

### DESCRIPTION OF EMBODIMENTS

Hereinafter, preferred embodiments will be described with reference to the drawings. Specific numeric values shown in the following embodiments are merely illustrative for easier understanding of the invention, and the present invention is not limited to them unless otherwise specified. Following descriptions and drawings obvious to those skilled in the art are omitted and simplified as appropriate in order to clarity the descriptions.

### First Embodiment

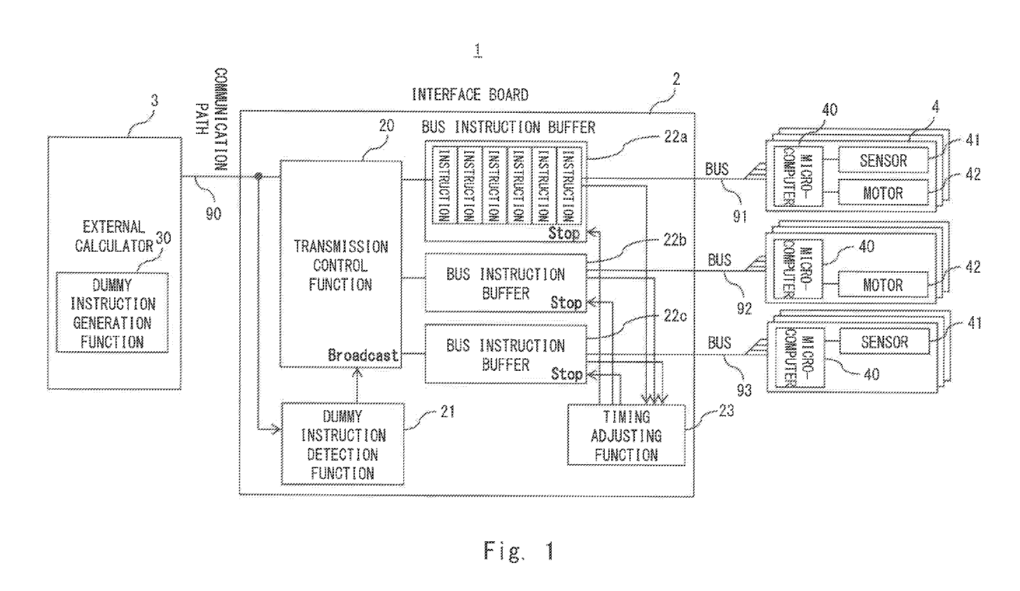

Firstly, a configuration of a module control system 1 according to a first embodiment will be described with reference to FIG. 1. As shown in FIG. 1, the module control system 1 includes an interface board 2, an external calculator 3, and a plurality of modules 4.

The interface board 2 is connected to the external calculator 3 through a communication path 90. Further, the interface board 2 is connected to the plurality of modules 4 through buses 91 to 93. At least one of the modules 4 is connected to each of the buses 91 to 93. To be precise, when the interface board 2 is connected to the plurality of modules 4, signal lines inside those components are connected to form the buses 91 to 93. Note that in the first embodiment, although an example in which the number of buses 91 to 93 that connect the interface board 2 to the modules 4 is three will be described, the number of the buses is not limited to this.

The interface board 2 receives instructions from the external calculator 3 through the communication path 90. The interface board 2 assigns received instructions to the buses 91 to 93. In other words, the interface board 2 transmits the received instruction to the bus to which the modules 4, which will execute the instruction, are connected.

The external calculator 3 generates instructions to be executed by the modules 4. The external calculator 3 transmits the generated instructions to the interface board 2 through the communication path 90. The external calculator 3 is typically, for example, a PC (Personal Computer).

Each of the plurality of modules 4 executes the instruction received from the interface board 2. The plurality of modules 4 connected to one another constitute one operating gadget. The gadget may be, for example, an electronic device such as a home electric appliance or a transport device such as an automobile. An operation of the gadget is achieved by the plurality of modules 4 executing the instructions, respectively.

As shown in FIG. 1, each of the plurality of modules 4 includes, for example, a microcomputer 40, a sensor 41, and a motor 42. Note that the modules 4 may each include one of the sensor 41 and the motor 42. The microcomputer 40 executes the instructions received from the interface board 2. When the received instruction is a sensor value acquisition instruction, the microcomputer 40 performs a process to acquire a sensor value from the sensor 41 and transmit it to the interface board 2. The interface board 2 transmits the sensor value received from the module 4 to the external calculator 3. When the received instruction is a motor drive instruction, the microcomputer 40 executes a process to drive the motor 42. This motor drive instruction, for example, is generated based on the sensor value acquired by the external calculator 3 from the module 4. To be more precise, execution of an instruction in the first embodiment indicates execution of a process by the module 4 according to the instruction. In other words, the instructions in this embodiment are information items instructing the modules 4 to perform processes.

For example, when the gadget composed of the plurality of modules 4 is a moving transport device, the gadget can be moved by driving the motor 42 based on the sensor value generated by the sensor 41 in the manner described above. Note that the configuration of the module 4 is not limited to this. The modules 4 may each include information acquisition means other than the sensor 41 and may each include operation achieving means other than the motor 42.

The connection of the modules 4 to other modules or the interface board 2 may be achieved by an arbitrary connection method. The connection method may be, for example, an indirect connection through cables or connection parts or a direct connection without using a cable or the like. Further, when the plurality of modules 4 are to be connected, a combination of two or more these connection methods may be used.

In the first embodiment, the external calculator 3 controls the plurality of modules 4 through the interface board 2, so that the external calculator 3 can control more of the modules 4. That is, as the external calculator 3 is connected to the plurality of modules 4 through the interface board 2 that can connect the modules 4 by using the plurality of buses 91 to 93, more of the modules 4 can be connected than when a single bus is used to directly connect the external calculator 3 to the modules 4.

On the other hand, with such a configuration, a group of the modules 4 connected to the bus 91, a group of the modules 4 connected to the bus 92, and a group of the modules 4 connected to the bus 93 execute instructions independently from one another. Therefore, if no consideration is given to the independence of the groups of the modules 4 from each other, there is a problem that when instructions that should be executed in an execution order are transmitted to different groups of the modules 4 connected to the buses, an instruction that should be executed after another instruction is executed may be executed before that instruction is executed. Note that these groups of the modules 4 serve as instruction execution units.

In the first embodiment, when the instructions are transmitted to the independent groups of the modules 4 through the different buses 91 to 93, an order of the instructions executed by the plurality of modules 4 is guaranteed by the functions described below.

The external calculator 3 includes a dummy instruction generation function 30. The dummy instruction generation function 30 generates a dummy instruction and inserts it between instructions that should be executed in an execution order among a plurality of instructions sequentially transmitted to the interface board 2. That is, among a plurality of instructions, if there are a first instruction and a second instruction that should be executed after the first instruction, the dummy instruction is inserted between the first instruction and the second instruction. Thus, the first instruction, the dummy instruction, and the second instruction are transmitted from the external calculator 3 to the interface board 2 in this order.

For example, the first instruction corresponds to the sensor value acquisition instruction, and the second instruction corresponds to the motor drive instruction that is generated based on a sensor value acquired according to the sensor value acquisition instruction. Note that the types of the instructions that should be executed in the execution order are not limited to the sensor value acquisition instruction and the motor drive instruction, which are illustrated in this embodiment. An order of execution may be guaranteed in the following manner for other types of instructions.

The interface board 2 includes a transmission control function 20, a dummy instruction detection function 21, a plurality of bus instruction buffers 22a to 22c, and a timing adjusting function 23. Hereinafter, the bus instruction buffers 22a to 22c are each referred to as merely a “bus instruction buffer(s) 22” if any particular one of the bus instruction buffers 22a to 22c is not indicated.

The transmission control function 20 assigns or distributes the instructions received from the external calculator 3 to the bus instruction buffers 22a to 22c. In other words, the transmission control function 20 stores the instructions received from the external calculator 3 in the bus instruction buffers 22a to 22c. To be more specific, if the received instruction is a dummy instruction, the transmission control function 20 outputs the dummy instruction to all of the bus instruction buffers 22a to 22c. Whereas if the received instruction is not a dummy instruction, the transmission control function 20 outputs the instruction to any one of the bus instruction buffers 22a to 22c. More specifically, the transmission control function 20 outputs the instruction to the bus instruction buffer 22 that corresponds to the bus to which the module 4, which will execute the instruction, is connected. The transmission control function 20 recognizes whether or not the received instruction is a dummy instruction based on a result of detection by the dummy instruction detection function 21.

The dummy instruction detection function 21 evaluates as to whether or not the instruction received from the external calculator 3 is a dummy instruction. That is, the dummy instruction detection function 21 evaluates as to whether or not the instruction input to the transmission control function 20 is a dummy instruction. If the dummy instruction detection function 21 determines that the instruction received from the external calculator 3 is a dummy instruction, the dummy instruction detection function 21 notifies the transmission control function 20 that the dummy instruction is detected.

To be more specific, the transmission control function 20 and the dummy instruction detection function 21 are achieved by, for example, the following circuits. If the instruction input to the transmission control function 20 is a dummy instruction, the dummy instruction detection function 21 outputs a broadcast instruction signal to a broadcast terminal included in the transmission control function 20. The broadcast instruction signal corresponds to a signal indicating the abovementioned result of detection of the dummy instruction. On the other hand, if the instruction input to the transmission control function 20 is not a dummy instruction, the dummy instruction detection function 21 does not output the broadcast instruction signal to the broadcast terminal included in the transmission control function 20. If the broadcast instruction signal is input from the dummy instruction detection function 21, the transmission control function 20 distributes the input instruction to all of the bus instruction buffers 22a to 22c. On the other hand, if the broadcast instruction signal is not input from the dummy instruction detection function 21, the transmission control function 20 assigns the input instruction to one of the bus instruction buffers 22a to 22c.

By such an operation, if there are the first instruction and the second instruction that should be executed after the first instruction, the dummy instruction is stored in all of the bus instruction buffers 22a to 22c after the first instruction, and the second instruction is stored in one of the bus instruction buffers 22a to 22c after the dummy instruction. The transmission control function 20 and the dummy instruction detection function 21 serve as instruction control units.

Each of the bus instruction buffers 22a to 22c can store a plurality of instructions. Each of the bus instruction buffers 22a to 22c stores instructions input from the transmission control function 20. Each of the bus instruction buffers 22a to 22c stores instructions in an FIFO (First In First Out) order. Therefore, the instructions stored in each of the bus instruction buffers 22a to 22c are sequentially retrieved in the order they are stored therein and then transmitted to the buses 91 to 93, respectively.

The bus instruction buffer 22a is connected to the bus 91, the bus instruction buffer 22b is connected to the bus 92, and the bus instruction buffer 22c is connected to the bus 93. Thus, the instructions stored in the bus instruction buffer 22a are output to the modules 4 through the bus 91. The instructions stored in the bus instruction buffer 22b are output to the modules 4 through the bus 92. The instructions stored in the bus instruction buffer 22c are output to the modules 4 through the bus 93.

As the timing adjusting function 23 uses the dummy instruction to control output of instructions from the bus instruction buffers 22a to 22c to the modules 4, an order of the instructions is guaranteed. The timing adjusting function 23 serves as an output control unit.

The timing adjusting function 23 monitors the instructions output from the bus instruction buffers 22a to 22c. When the timing adjusting function 23 detects the bus instruction buffer 22 that outputs a dummy instruction, the timing adjusting function 23 suspends the operation of the corresponding bus instruction buffer 22. In other words, the timing adjusting function 23 suspends an output of instructions from the corresponding bus instruction buffer 22 to the modules 4. After that, every time the timing adjusting function 23 detects the bus instruction buffer 22 that outputs a new dummy instruction, the timing adjusting function 23 suspends an operation of the corresponding bus instruction buffer 22. When the instructions output from all of the bus instruction buffers 22a to 22c become dummy instructions, the timing adjusting function 23 resumes the operation of the bus instruction buffers 22, which have been suspended. That is, the timing adjusting function 23 resumes output of the instructions from the bus instruction buffers 22, which have been suspended, to the modules 4.

In this way, until all of the bus instruction buffers 22a to 22c output the dummy instructions, outputs to the modules 4 after the dummy instructions are suspended. Therefore, if there is a first instruction and a second instruction that should be executed after the first instruction, until at least the first instruction is output and the dummy instruction after the first instruction is output, the second instruction after the dummy instruction will not be output. Thus, an order of the first instruction and the second instruction is guaranteed.

To be more specific, the bus instruction buffers 22a to 22c and the timing adjusting function 23 are achieved by, for example, the following circuits. The timing adjusting function 23 outputs a suspension signal to a suspension signal input terminal of the bus instruction buffer 22 that outputs the dummy instruction until the dummy instructions are output from all the bus instruction buffers 22a to 22c. In response to the suspension signal from the timing adjusting function 23, the bus instruction buffer 22 suspends its operation. To be more specific, the bus instruction buffers 22 suspend an output operation of instructions to the modules 4 in response to the suspension signal from the timing adjusting function 23. Thus, for example, a transfer sequence of data (instructions) from the bus instruction buffers 22 to the modules 4 is interrupted. Note that the transfer sequence complies with the communication standard of the buses 91 to 93. That is, transmission of the dummy instructions from the bus instruction buffers 22 to the modules 4 is interrupted. Thus, reception of the dummy instruction by the modules 4 is not completed, and the dummy instructions continue to stay inside the bus instruction buffers 22. Accordingly, the instructions following the dummy instruction are not transmitted and stay inside the bus instruction buffers 22. In this way, the transmission of the instructions from the bus instruction buffers 22 to the modules 4 is stopped. The transmission of the instructions is stopped while the suspension signal is being input from the timing adjusting function 23 to the bus instruction buffers 22.

Note that although the method for interrupting the transfer sequence of the instructions from the bus instruction buffers 22 to the modules 4 by suspending the operations of the bus instruction buffers 22 has been described as one of the methods for stopping the transmission of the instructions from the bus instruction buffers 22 to the modules 4, it is not limited to this method and other methods may be used. For example, the timing adjusting function 23 may acquire the instruction output from the bus instruction buffer 22, and if the acquired instruction is a dummy instruction, the timing adjusting function 23 may stop transmission of the instructions. If the acquired instruction is not a dummy instruction, the timing adjusting function 23 may transmit the instruction to the modules 4.

When the timing adjusting function 23 detects outputs of the dummy instructions from all the bus instruction buffers 22a to 22c, the timing adjusting function 23 stops outputting the suspension signal. The bus instruction buffers 22, operations of which have been suspended, resume their operations when the suspension signal is not input from the timing adjusting function 23. To be more specific, the bus instruction buffers 22 resume the output operation of the instructions to the modules 4 when the suspension signal from the timing adjusting function 23 is canceled. As described later, the dummy instruction is discarded at this time. Thus, the transfer sequence of the instructions from the bus instruction buffers 22 to the modules 4 is started for the next instruction following the dummy instruction. That is, the transmission of the instructions from all the bus instruction buffers 22a to 22c to the modules 4 is resumed.

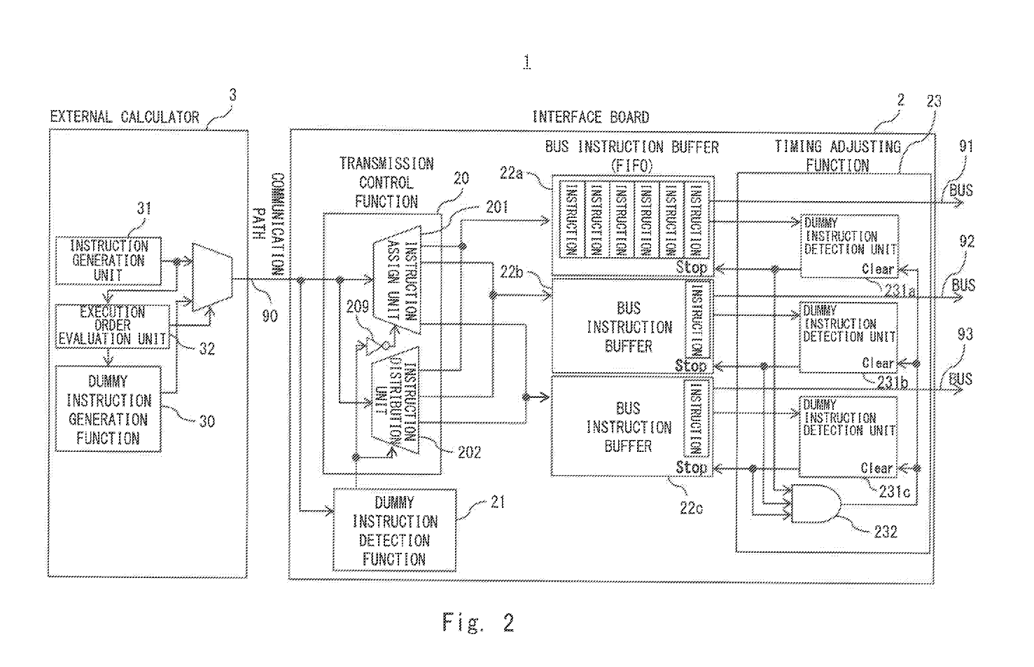

Next, configurations of the interface board 2 and the external calculator 3 according to the first embodiment will be described with reference to FIG. 2.

Firstly, the interface board 2 will be described. FIG. 2 shows specific configurations of the transmission control function 20 and the timing adjusting function 23 included in the interface board 2. As shown in FIG. 2, the transmission control function 20 includes an instruction assign unit 201, an instruction distribution unit 202, and an inverter 209. The timing adjusting function 23 includes dummy instruction detection units 231a to 231c and an AND circuit 232. Hereinafter, the dummy instruction detection units 231a to 231c are each referred to as merely “dummy instruction detection units 231” if any particular one of the dummy instruction detection units 231a to 231c is not indicated.

The instruction input to the transmission control function 20 is input to both the instruction assign unit 201 and the instruction distribution unit 202. The instruction assign unit 201 assigns the input instruction to one of the bus instruction buffers 22a to 22c according to a destination. The instruction distribution unit 202 distributes the input instruction to all of the bus instruction buffers 22a to 22c.

The instruction assign unit 201 and the instruction distribution unit 202 operate in a manner complementary to each other according to whether or not the broadcast instruction signal is input from the dummy instruction detection function 21 to the transmission control function 20. If the broadcast instruction signal is not input to the transmission control function 20, the instruction assign unit 201 operates, and the instruction distribution unit 202 suspends operating. On the other hand, if the broadcast instruction signal is input to the transmission control function 20, the instruction assign unit 201 suspends operating, and the instruction distribution unit 202 operates. In this way, the above operation of the transmission control function 20 is achieved.

To be more specific, the instruction assign unit 201 and the instruction distribution unit 202 operate, for example, in the following manner. The dummy instruction detection function 21 outputs a signal that is switched to a high level or a low level to the instruction assign unit 201 and the instruction distribution unit 202. When the dummy instruction is input to the instruction assign unit 201 and the instruction distribution unit 202, the dummy instruction detection function 21 outputs a high level signal. On the other hand, when the dummy instruction is not input to the instruction assign unit 201 and the instruction distribution unit 202, the dummy instruction detection function 21 outputs a low level signal. This signal is input as it is to the instruction distribution unit 202, and a signal obtained by inverting this signal by the inverter 209 is input to the instruction assign unit 201. The instruction assign unit 201 and the instruction distribution unit 202 operate when the high level signal is input thereto and suspends operating when the low level signal is input thereto. That is, the high level signal corresponds to the broadcast instruction signal.

Each of the dummy instruction detection units 231a to 231c monitors an instruction output from the bus instruction buffers 22a to 22c, respectively, and detects an output of a dummy instruction. The dummy instruction detection unit 231a monitors the bus instruction buffer 22a. The dummy instruction detection unit 231b monitors the bus instruction buffer 22b. The dummy instruction detection unit 231c monitors the bus instruction buffer 22c.

When a dummy instruction is output from the bus instruction buffer 22a, the dummy instruction detection unit 231a outputs a suspension signal to the bus instruction buffer 22a and the AND circuit 232. When a dummy instruction is output from the bus instruction buffer 22b, the dummy instruction detection unit 231b outputs a suspension signal to the bus instruction buffer 22b and the AND circuit 232. When a dummy instruction is output from the bus instruction buffer 22c, the dummy instruction detection unit 231c outputs a suspension signal to the bus instruction buffer 22c and the AND circuit 232.

The AND circuit 232 outputs a signal obtained by ANDing signals input from the dummy instruction detection units 231a to 231c to each of the dummy instruction detection units 231a to 231c. When the suspension signals are input from all of the dummy instruction detection units 231a to 231c, the AND circuit 232 outputs a clear signal to each of the dummy instruction detection units 231a to 231c. On the other hand, when the suspension signal is not input from at least one of the dummy instruction detection units 231a to 231c to the AND circuit 232, the AND circuit 232 will not output the clear signal to any of the dummy instruction detection units 231a to 231c.

To be more specific, the dummy instruction detection units 231a to 231c and the AND circuit 232 operate, for example, as described below. Each of the dummy instruction detection units 231a to 231c outputs a signal that can be switched to a high level or a low level to the bus instruction buffers 22a to 22c, respectively, and the AND circuit 232. When the dummy instruction is output from the bus instruction buffers 22a to 22c, the corresponding one of the dummy instruction detection units 231a to 231c outputs a high level signal. On the other hand, when the dummy instruction is not output from the bus instruction buffers 22a to 22c, the corresponding one of the dummy instruction detection units 231a to 231c outputs a low level signal. The bus instruction buffers 22a to 22c operate when the high level signal is input thereto and suspend operating when the low level signal is input thereto. That is, the high level signal corresponds to the suspension signal.

When the high level signals are input from all of the dummy instruction detection units 231a to 231c to the AND circuit 232, the AND circuit 232 outputs a high level signal to each of the dummy instruction detection units 231a to 231c. When the low level signal is input from at least one of the dummy instruction detection units 231a to 231c to the AND circuit 232, the AND circuit 232 outputs a low level signal to each of the dummy instruction detection units 231a to 231c. When the high level signal is input from the AND circuit 232 to the dummy instruction detection units 231a to 231c, each of the dummy instruction detection units 231a to 231c switches a signal to be output to the bus instruction buffers 22a to 22c and the AND circuit 232 from a high level to a low level. On the other hand, when the low level signal is input from the AND circuit 232 to the dummy instruction detection units 231a to 231c, each of the dummy instruction detection units 231a to 231c does not switch a level of a signal to be output to the bus instruction buffers 22a to 22c and the AND circuit 232. That is, the high level signal output by the AND circuit 232 corresponds to the clear signal.

Next, the external calculator 3 will be described. FIG. 2 shows a configuration of the external calculator 3 in more detail. As shown in FIG. 2, the external calculator 3 includes an instruction generation unit 31 and an execution order evaluation unit 32 in addition to the dummy instruction generation function 30.

The instruction generation unit 31 generates a plurality of instructions to be executed by the plurality of modules 4. The execution order evaluation unit 32 evaluates as to whether or not there are instructions that should be executed in an execution order among the plurality of instructions generated by the instruction generation unit 31. The dummy instruction generation function 30 generates a dummy instruction and inserts it between the instructions that should be executed in the execution order, which have been detected by the execution order evaluation unit 32. By doing so, among the plurality of instructions generated by the external calculator 3, if there is a first instruction and a second instruction that should be executed after the first instruction, the first instruction, the dummy instruction, and the second instruction are transmitted in this order.

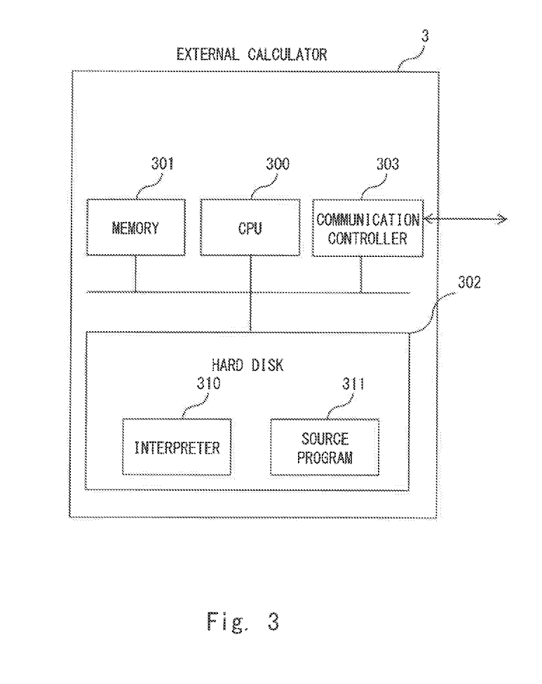

Next, a software configuration and a hardware configuration of the external calculator 3 according to the first embodiment will be described with reference to FIG. 3. As shown in FIG. 3, the external calculator 3 includes a CPU (Central Processing Unit) 300, a memory 301, a hard disk 302, and a communication controller 303.

The CPU 300 integrally controls the external calculator 3. The CPU 300 loads an interpreter 310 stored in the hard disk 302 into the memory 301 and executes the interpreter 310 to thereby interpret a source program 311 stored in the hard disk 302 and generate an executable program. When the CPU 300 executes the generated executable program, the CPU 300 generates instructions and transmits them to the interface board 2. In other words, the interpreter 310 and the executable program generated by interpreting the source program 311 include codes for causing the CPU 300 to execute various processes as the dummy instruction generation function 30, the instruction generation unit 31, and the execution order evaluation unit 32.

The memory 301 temporarily stores information used by the CPU 300. This information includes, as described above, the interpreter 310, the source program 311, and the like that are loaded from the hard disk 302. The memory 301 is, for example, a non-volatile storage device such as a DRAM (Dynamic Random Access Memory), an SRAM (Static Random Access Memory), or the like.

The hard disk 302, as described above, stores various information items such as the interpreter 310, the source program 311, and the like. Note that other storage devices such as a flash memory may be used in place of the hard disk 302 as long as it is a non-volatile storage device like the hard disk 302. The memory 301 and the hard disk 302 serve as storage units that store information used by the external calculator 3. Note that the number of the storage devices and a combination of the storage devices that serve as the storage units are not limited to the above example.

The communication controller 303 converts information output by the CPU 300 into a format that can be transmitted to the interface board 2 and transmits the converted information to the interface board 2. The converted format complies with the communication standard between the external calculator 3 and the interface board 2. Further, the communication controller 303 receives information from the interface board 2, converts it into a format that can be processed by the external calculator 3, and outputs the converted information to the CPU 300.

The interpreter 310 has a function to generate dummy instructions. The source program (a source code, a source program) 311 describes codes for controlling the plurality of modules 4. The CPU 300 executes the executable program (a load module, a machine language program, an object code) generated by the interpreter 310 sequentially interpreting (may be referred to as sequential compiling) the source program 311 to thereby generate instructions to be executed by the plurality of modules 4 and sequentially transmits the instructions to the plurality of modules 4 through the interface board 2. At this time, when the CPU 300 generates instructions that should be executed in an execution order and transmits them, the CPU 300 generates a dummy instruction(s) and transmits the dummy instruction(s) between the instructions. That is, when codes for generating instructions that should be executed in an execution order and transmitting them are executed, the interpreter 310 adds codes for generating the dummy instruction(s) between those codes and transmitting them and causes the CPU 300 to execute the codes. Then, the external calculator 3 can insert the dummy instruction(s) between the instructions that should be executed in the execution order and transmit the instructions to the interface board 2.

Note that a scheme for controlling the plurality of modules 4 is not limited to the abovementioned example in which the executable program, which is generated by the interpreter 310 sequentially interpreting the source program 311, is executed. Alternatively, a compiler in place of the interpreter 310 may be stored in the hard disk 302, and the CPU 300 may execute the executable program generated by the complier collectively interpreting (may be referred to as collective compiling) the source program 311. In this case, the compiler causes the CPU 300 to execute a process to add codes for generating a dummy instruction(s) and transmitting it to codes for generating instructions that should be executed in an execution order and transmitting the instructions to thereby generate the executable program. Alternatively, an instruction evaluation function that evaluates instructions that should be executed in an execution order and a dummy instruction generation function may be included in the executable program, so that the CPU 300 can execute a process for generating a dummy instruction(s) while checking the order of the instructions. By doing so, when the CPU 300 executes the executable program, the dummy instruction(s) is inserted between the instructions that should be executed in the execution order, and the instructions are transmitted to the interface board 2.

As described above, it is possible to insert the dummy instruction(s) not only by the interpreter 310 but also by the compiler.

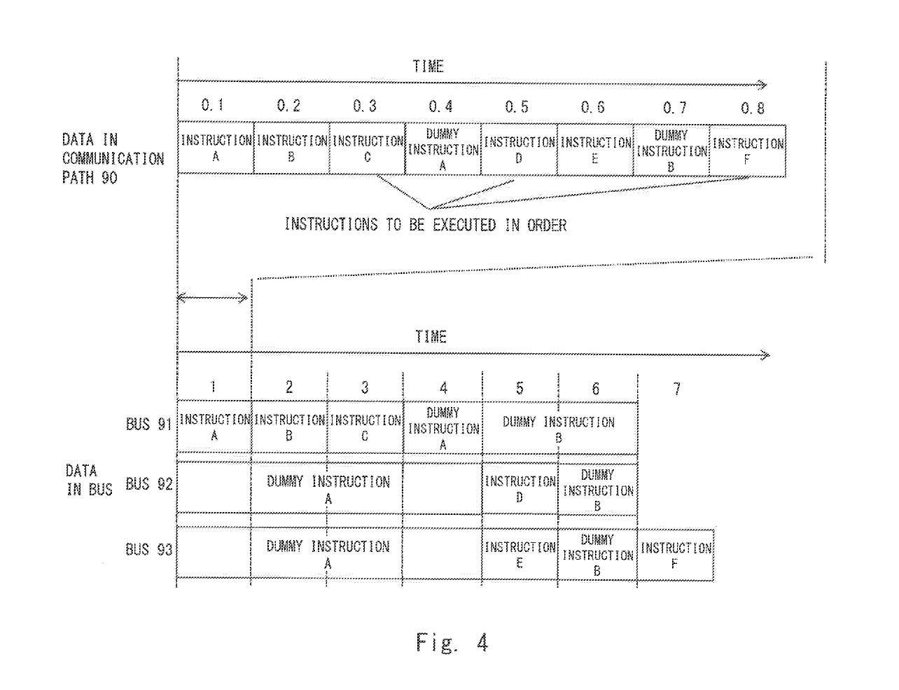

Next, an order for executing instructions according to the first embodiment will be described with reference to FIG. 4. With reference to FIG. 4, an example in which the instruction generation unit 31 of the external calculator 3 generates instructions in the order from an instruction A to an instruction F is given.

The instructions C, D, and F need to be executed in an execution order. That is, the instruction D needs to be executed after the instruction C is executed, and the instruction F needs to be executed after the instruction D is executed. Note that in FIG. 4, a time taken for transmission of one instruction through the buses 91 to 93 to be completed is indicated as one unit time (=1.0).

In this case, the dummy instruction generation function 30 inserts a dummy instruction A between the instructions C and D and inserts a dummy instruction B between the instructions D and F. Accordingly, as indicated by “data in communication path 90” in FIG. 4, the external calculator 3 transmits the instructions one by one to the interface board 2 through the communication path 90 in the order of the instruction A, the instruction B, the instruction C, the dummy instruction A, the instruction D, the instruction E, the dummy instruction B, and the instruction F.

Note that a communication speed of the communication path 90 is desirably greater than communication speeds of the buses 91 to 93. For example, as shown in FIG. 4, a plurality of instructions (the instructions A to F and the dummy instructions A and B) can be transmitted through the communication path 90 within a time in which one instruction is transmitted through the buses 91 to 93. In FIG. 4, although an example in which at least eight instructions can be transmitted through the communication path 90 within the time in which one instruction is transmitted through the buses 91 to 93 is shown, the relationship between the number of the instructions transmitted through the communication path 90 and the number of the instructions transmitted through the buses 91 to 93 is not limited to this. Because of the relationship between the number of instructions transmitted through the communication path 90 and the number of instructions transmitted through the plurality of buses 91 to 93, instructions will not run out in the buses 91 to 93, and the instructions can be successively transmitted to the modules 4.

Further, the instructions A, B, and C are executed by the modules 4 connected to the bus 91, the instruction D is executed by the modules 4 connected to the bus 92, and the instructions E and F are executed by the modules 4 connected to the bus 93.

In this case, as indicated by “data in bus” in FIG. 4, the bus instruction buffers 22a to 22c transmit instructions to the buses 91 to 93, respectively. That is, the bus instruction buffer 22a stores the instruction A, the instruction B, the instruction C, the dummy instruction A, and the dummy instruction B in this order and transmits the instructions in this order. The bus instruction buffer 22b stores the dummy instruction A, the instruction D, and the dummy instruction B in this order and transmits the instructions in this order. The bus instruction buffer 22c stores the dummy instruction A, the instruction E, the dummy instruction B, and the instruction F in this order and transmits the instructions in this order. Hereinafter, states of the buses 91 to 93 in this a case as the time passes will be described.

### (Time 1)

The instruction A stored in the bus instruction buffer 22a is transmitted to the bus 91. The modules 4 connected to the bus 91 receive the instruction A transmitted from the bus instruction buffer 22a and execute it. At this time, the instruction transmitted from the bus instruction buffer 22a is not the dummy instruction A, while the instructions transmitted from the bus instruction buffers 22b and 22c are the dummy instructions A. Thus, the timing adjusting function 23 suspends operations of the bus instruction buffers 22b and 22c that transmit the dummy instruction A. Thus, the modules 4 have not completed receiving the dummy instructions A transmitted by the bus instruction buffers 22b and 22c.

### (Time 2)

The instruction B stored in the bus instruction buffer 22a is transmitted to the bus 91. The modules 4 connected to the bus 91 receive the instruction B transmitted from the bus instruction buffer 22a and execute it. At this time, the instruction transmitted from the bus instruction buffer 22a is not the dummy instruction A, while the instructions transmitted from the bus instruction buffers 22b and 22c are the dummy instructions A. Accordingly, the timing adjusting function 23 continues to suspend the operations of the bus instruction buffers 22b and 22c that transmit the dummy instructions A.

### (Time 3)

The instruction C stored in the bus instruction buffer 22a is transmitted to the bus 91. The modules 4 connected to the bus 91 receive the instruction C transmitted from the bus instruction buffer 22a and execute it. At this time, the instruction transmitted from the bus instruction buffer 22a is not the dummy instruction A, while the instructions transmitted from the bus instruction buffers 22b and 22c are the dummy instructions A. Accordingly, the timing adjusting function 23 continues to suspend the operations of the bus instruction buffers 22b and 22c that transmit the dummy instructions A.

### (Time 4)

The dummy instruction A stored in the bus instruction buffer 22a is also transmitted to the bus 91. Accordingly, the instructions transmitted from all of the bus instruction buffers 22a to 22c are the dummy instructions A. Thus, the timing adjusting function 23 resumes the operations of the bus instruction buffers 22b and 22c. Note that at this time, the bus instruction buffers 22a to 22c discard the dummy instructions A, which will be described later.

### (Time 5)

The dummy instruction B stored in the bus instruction buffer 22a is transmitted to the bus 91. On the other hand, the instruction D stored in the bus instruction buffer 22b, which has resumed its operation, is transmitted to the bus 92. The modules 4 connected to the bus 92 receive the instruction D transmitted from the bus instruction buffer 22b and execute it. The instruction E stored in the bus instruction buffer 22c, which has resumed its operation, is also transmitted to the bus 93. The modules 4 connected to the bus 93 receive the instruction E transmitted from the bus instruction buffer 22c and execute it. As described above, transmission of the instruction D that should be executed after the instruction C is suspended until the instruction C is transmitted. It is thus possible to guarantee the execution order of the instructions C and D. At this time, the instructions transmitted from the bus instruction buffers 22b and 22c are not the dummy instruction B, and the instruction transmitted from the bus instruction buffer 22a is the dummy instruction B. Accordingly, the timing adjusting function 23 continues to suspend the operation of the bus instruction buffer 22a that transmits the dummy instruction B.

### (Time 6)

The dummy instruction B stored in the bus instruction buffer 22b is also transmitted to the bus 92. The dummy instruction B stored in the bus instruction buffer 22c is also transmitted to the bus 93. Accordingly, the instructions transmitted from all the bus instruction buffers 22a to 22c are the dummy instruction B. Thus, the timing adjusting function 23 resumes the operation of the bus instruction buffer 22a.

### (Time 7)

The instruction F stored in the bus instruction buffer 22c is transmitted to the bus 93. The modules 4 connected to the bus 93 receive the instruction F transmitted from the bus instruction buffer 22c and execute it. As described above, transmission of the instruction F that should be executed after the instruction D is suspended until the instruction D is transmitted. It is thus possible to guarantee the execution order of the instructions D and F.

As illustrated above, the above-described module control system 1 according to the first embodiment can guarantee an order of instruction execution even for the groups of modules 4 that independently execute instructions in parallel.

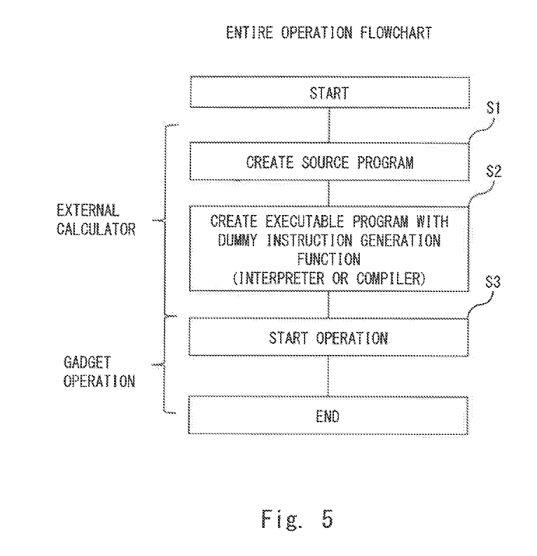

Next, an operation of the module control system 1 according to the first embodiment will be described with reference to FIG. 5.

The CPU 300 of the external calculator 3 creates the source program 311 in response to an input by a user (S1). Codes for controlling the plurality of modules 4 are described in the source program 311. For example, codes for generating the sensor value acquisition instruction and the motor drive instruction and transmitting them to the modules 4 are described in the source program 311. The above input by the user is performed by the user operating an input device (not shown) included in the external calculator 3. The input device is, for example, a keyboard, a mouse, or the like.

The CPU 300 of the external calculator 3 executes the interpreter 310 to thereby sequentially interpret the source program 311, generate the executable program, and executes it (S2). Then, various instructions are generated by the external calculator 3 and sequentially transmitted to the plurality of modules 4 through the interface board 2. When the plurality of modules 4 execute the received instructions, an operation of the gadget composed of the plurality of modules 4 is achieved (S3).

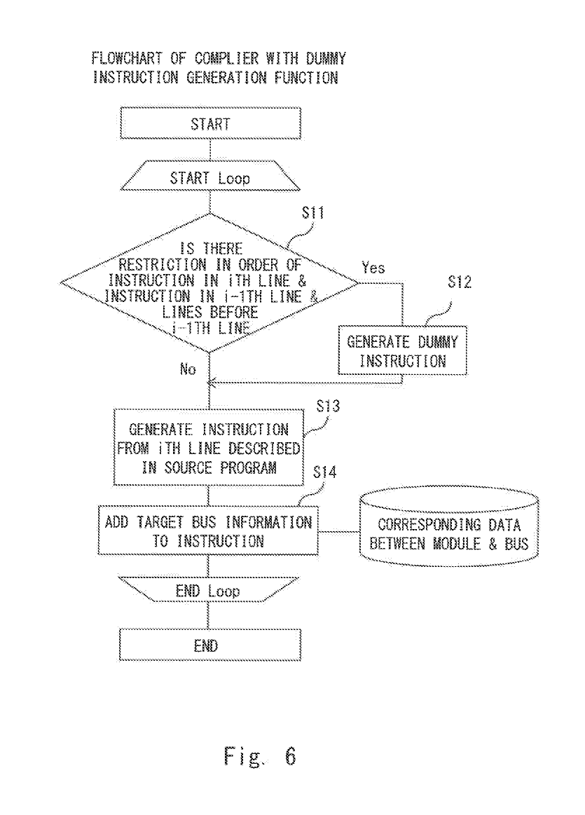

Next, an operation of the external calculator 3 according to the first embodiment will be described with reference to FIG. 6. The external calculator 3 executes the interpreter 310 to thereby repeatedly execute the following processes in the steps S11 to S14 when the external calculator 3 sequentially interprets the source program 311 and executes the executable program.

The execution order evaluation unit 32 evaluates as to whether or not there is a restriction in an order between an instruction generated by codes in an ith line, which will be interpreted, and an instruction generated by codes in an i−1th line and lines before the i−1th line (S11) (i is any positive integer). The execution order evaluation unit 32, for example, analyzes the source code 311, and if the instruction generated by the codes in the i−1th line and lines before the i−1th line is the sensor value acquisition instruction, and if the instruction generated by the codes in the ith line is the motor drive instruction based on the sensor value acquired according to the sensor value acquisition instruction, the execution order evaluation unit 32 determines that there is a restriction in the order of these instructions.

A range to be investigated for a restriction in an order of instructions may be determined by, for example, any one of the following methods (1) to (4).

(1) Investigating Lines up to a Line where a Dummy Instruction is Generated Previously

In this method, the execution order evaluation unit 32 investigates the lines from the i−1th reversely to the line where a dummy instruction is generated previously.

### (2) Investigating Predetermined Lines

In this method, the execution order evaluation unit 32 investigates predetermined lines reversely from the i−1th line.

(3) Investigating Lines until an Instruction with a Restriction in an Order is Detected

In this method, the execution order evaluation unit 32 investigates lines reversely from the i−1th line to the line where codes for generating an instruction with a restriction in an order are detected.

(4) Investigating the i−1th Line and Lines before the i−1th Line

In this method, the execution order evaluation unit 32 investigates lines reversely from the i−1th line to a first line of the source program 311.

When the execution order evaluation unit 32 determines that there is a restriction in an order of an instruction in the ith line and an instruction in the i−1th line and lines before the i−1th line (S11: YES), the dummy instruction generation function 30 generates a dummy instruction (S12). In the executable program generated from the source program 311, codes for transmitting the dummy instruction are inserted between the code corresponding to the ith line and the codes corresponding to the i−1th line and lines before the i−1th line that are determined to include the restriction in the order of the instructions generated by these codes.

On the other hand, when the execution order evaluation unit 32 determines that there is no restriction in the order in the instruction generated by the code in the ith line and the instructions generated by the codes in the i−1th line and lines before the i−1th line (S11: No), the dummy instruction generation function 30 does not generate the dummy instruction.

When a process for transmitting an instruction to the modules 4 is described in the ith line of the source program 311, the instruction generation unit 31 generates the instruction from the description in the ith line of the source program 311 (S13).

The instruction generation unit 31 adds, to the generated instruction, target bus information indicating a bus to which the instruction is transmitted (S14). The bus to which the instruction is transmitted is evaluated based on corresponding data indicating the modules 4 and the bus to which the modules 4 are connected. The corresponding data is previously stored in, for example, the hard disk 302. In the description of the source program 311, the codes for generating the instruction indicate the modules 4 to which the instruction is transmitted. Therefore, the instruction generation unit 31 generates the target bus information indicating the bus, which is a destination of the instruction transmitted from the modules 4 to which the instruction is transmitted, based on the corresponding data and adds the target bus information to the instruction. When the transmission control function 20 (the instruction assign unit 201) of the interface board 2 receives the instruction from the external calculator 3, the transmission control function 20 assigns the instruction to the bus instruction buffer 22 that corresponds to the bus indicated by the target bus information which has been added to the instruction. This enables the transmission control function 20 (the instruction assign unit 201) to correctly assign the instruction to the bus instruction buffer 22 corresponding to the transmission destination.

As described above, if it is determined that there is a restriction in the order between the instruction generated by the codes in the ith line and the instruction generated by the codes in the i−1th line and lines before the i−1th line, the dummy instruction generation function 30 generates and transmits the dummy instruction in the step S12, and then the instruction generation unit 31 generates and transmits the instruction in the step S13. On the other hand, if it is determined that there is no restriction in the order between the instruction generated by the codes in the ith line and the instruction generated by the codes in the i−1th line and lines before the i−1th line, the dummy instruction is not transmitted, and only the instruction generation unit 31 generates and transmits the instruction in the step S13.

By doing so, when, for example, the sensor value acquisition instruction and the motor drive instruction, which have a restriction in the order therebetween, are transmitted to separate buses, the dummy instruction can be inserted between the sensor value acquisition instruction and the motor drive instruction and the instructions can be transmitted. Accordingly, the control using the dummy instruction by the interface board 2 prevents the motor drive instruction from being executed before the sensor value acquisition instruction is executed, as described with reference to FIG. 4. In this way, it is possible to avoid, for example, a malfunction such that a motor is driven based on a sensor value that is one period before.

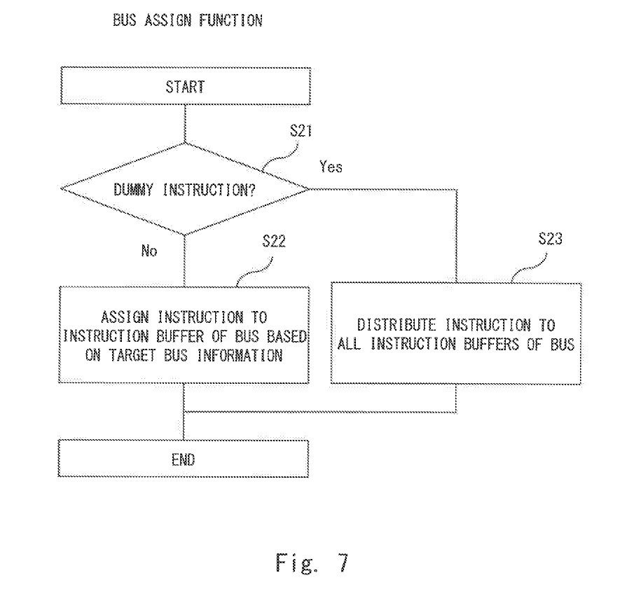

Next, operations of the transmission control function 20 and the dummy instruction detection function 21 of the interface board 2 according to the first embodiment will be described with reference to FIG. 7.

The dummy instruction detection function 21 evaluates as to whether or not the instruction received from the external calculator 3 is a dummy instruction (S21). If the instruction received from the external calculator 3 is determined not to be a dummy instruction (S21: No), the transmission control function 20 controls the instruction assign unit 201 to assign the instruction to the bus indicated by the target bus information included in the instruction (S22). On the other hand, if the instruction received from the external calculator 3 is determined to be a dummy instruction (S21: Yes), the transmission control function 20 controls the instruction distribution unit 202 to distribute the instruction to all of the buses 91 to 93 (S23).

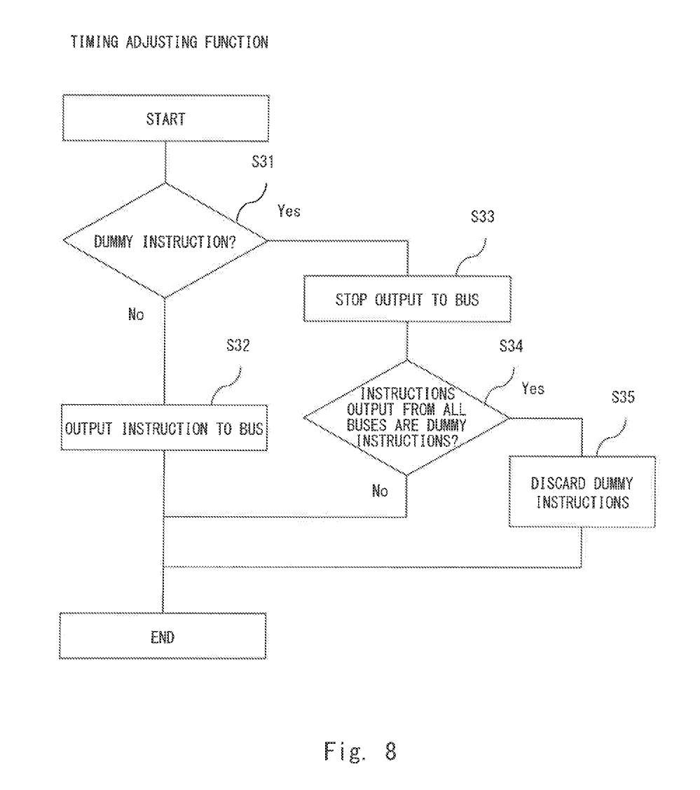

Next, an operation of the timing adjusting function 23 of the interface board 2 according to the first embodiment will be described with reference to FIG. 8.

The dummy instruction detection units 231a to 231c of the timing adjusting function 23 evaluate as to whether or not instructions output from the bus instruction buffers 22a to 22c are dummy instructions, respectively (S31). If the dummy instruction detection units 231a to 231c determine that the instructions output from the bus instruction buffers 22a to 22c are not dummy instructions, respectively (S31: No), the dummy instruction detection units 231a to 231c allow the bus instruction buffers 22a to 22c to output the instructions, respectively (S32).

On the other hand, if the dummy instruction detection units 231a to 231c determine that the instructions output from the corresponding bus instruction buffers 22a to 22c are dummy instructions, respectively (S31: Yes), the dummy instruction detection units 231a to 231c suspend the bus instruction buffers 22a to 22c from outputting the instructions, respectively (S33). The timing adjusting function 23 evaluates as to whether or not the dummy instructions are output from all of the bus instruction buffers 22a to 22c (S34). That is, the dummy instruction detection units 231 each evaluate as to whether or not a clear signal has been input.

When the timing adjusting function 23 determines that the dummy instructions are output from all of the bus instruction buffers 22a to 22c (S34: Yes), the timing adjusting function 23 instructs the bus instruction buffers 22a to 22c to discard the dummy instructions (S35). The dummy instructions are discarded when the bus instruction buffers 22a to 22c discard the instructions output at the timings when the respective dummy instruction detection units 231a to 231c cancel outputting the suspension instructions. Then, as the instructions output by the bus instruction buffers 22a to 22c are no longer dummy instructions (S31: No), the bus instruction buffers 22a to 22c output the instructions (S32). On the other hand, when the timing adjusting function 23 determines that the dummy instructions are not output from all of the bus instruction buffers 22a to 22c (S34: No), the timing adjusting function 23 does not instruct the bus instruction buffers 22a to 22c to discard the dummy instructions.

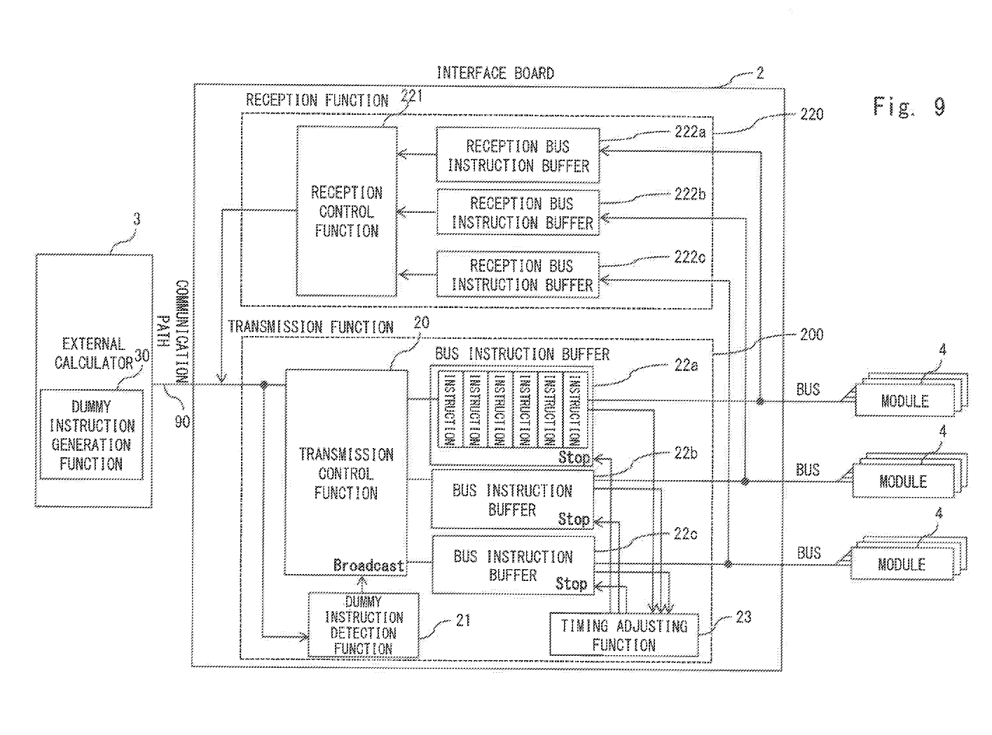

It is obvious that the instructions may be received from the respective modules 4, which has not been mentioned in the above description in order to clarity the operation regarding the dummy instructions. More specifically, as shown in FIG. 9, the interface board 2 includes a reception function 220 in addition to a transmission function 200 that includes the transmission control function 20, the dummy instruction detection function 21, the bus instruction buffers 22a to 22c, and the timing adjusting function 23. The reception function 220 includes a reception control function 221 and reception bus instruction buffers 222a to 222c.

Each of the reception bus instruction buffers 222a to 222c can store a plurality of instructions. Each of the reception bus instruction buffers 222a to 222c stores instructions received from the modules 4 through the buses 91 to 93, respectively. Each of the reception bus instruction buffers 222a to 222c stores instructions in an FIFO order. Therefore, each of the reception bus instruction buffers 222a to 222c sequentially outputs the instructions to the reception control function 221 in the order they are stored therein.

The reception control function 221 sequentially transmits the instructions input from the reception bus instruction buffers 222a to 222c one by one to the external calculator 3 through the communication path 90 in the order they arrive thereat. That is, like the instructions that occupy the communication path 90 and the buses 91 to 93 shown in FIG. 4, instructions transmitted from the modules 4 to the external calculator 3 could occupy the communication path 90 and the buses 91 to 93.

Note that the instructions transmitted from the modules 4 to the external calculator 3 are not only the instructions for the modules 4 to instruct the external calculator 3 to perform processes but also the instructions including information with which the modules 4 respond to the instructions from the external calculator 3. This information includes, for example, the sensor value transmitted by the modules 4 to the external calculator 3 in response to the sensor value acquisition instruction.

As described above, the module control system 1 according to the first embodiment includes the bus instruction buffers 22a to 22c that output instructions in an FIFO order to the respective buses 91 to 93 (the group of modules 4), the transmission control function 20 that assigns each of the sequentially input instructions to one of the bus instruction buffers 22a to 22c, and the timing adjusting function 23 that controls the output of the instructions from the bus instruction buffers 22a to 22c.

When the input instruction is a dummy instruction to be inserted between instructions that should be executed in an execution order, the transmission control function 20 distributes the input instruction to all of the bus instruction buffers 22a to 22c. Then, the timing adjusting function 23 suspends the output of the instructions from the bus instruction buffer 22, the instruction output therefrom has become the dummy instruction, to the bus (the group of modules 4) until instructions output from all of the bus instruction buffers 22a to 22c become dummy instructions.

By doing so, instructions after the dummy instruction will not be output to the modules 4 and executed until the instruction(s) before the dummy instruction is output and dummy instructions are output from all of the bus instruction buffers 22a to 22c. It is thus possible to guarantee the execution order of the instructions that should executed in the execution order.

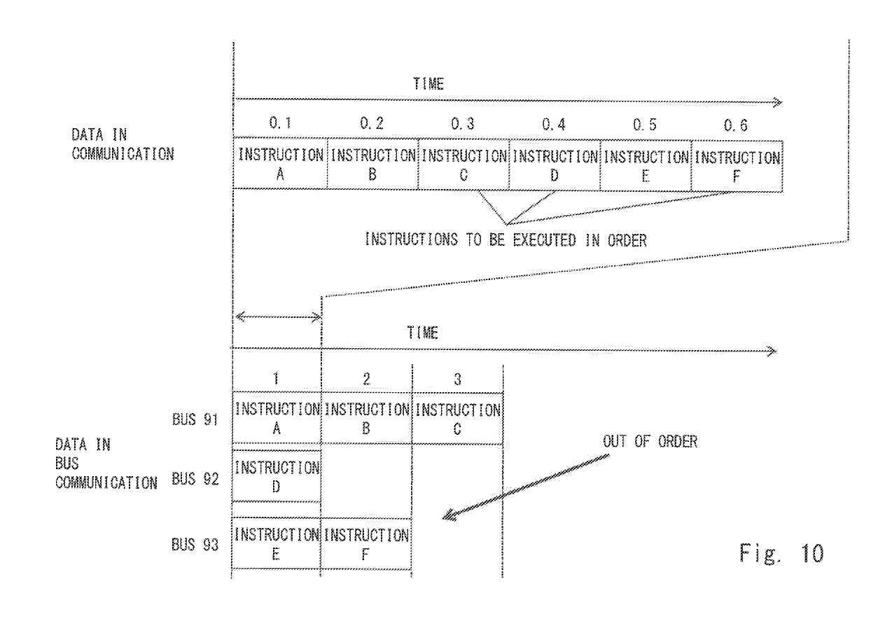

For example, when the instructions A to F shown in FIG. 4 are transmitted without being controlled by the dummy instruction according to the first embodiment, the instructions A to F are transmitted as shown in FIG. 10. That is, the interface board 2 immediately assigns and transmits the instructions A to F received from the external calculator 3 to the buses 91 to 93 through the communication path 90.

Accordingly, at the (time 1), the instruction A is transmitted to the bus 91, the instruction D is transmitted to the bus 92, and the instruction E is transmitted to the bus 93. At the (time 2), the instruction B is transmitted to the bus 91, and the instruction F is transmitted to the bus 93. At the (time 3), the instruction C is transmitted to the bus 91. In this way, the instruction D that should be executed after the instruction C is transmitted to the modules 4 and executed before the instruction C. On the other hand, according to the first embodiment, it is possible to guarantee the order of the instructions as shown in FIG. 4 even when instructions A to F the same as those in the above example are transmitted.

### MODIFIED EXAMPLE 1 OF FIRST EMBODIMENT

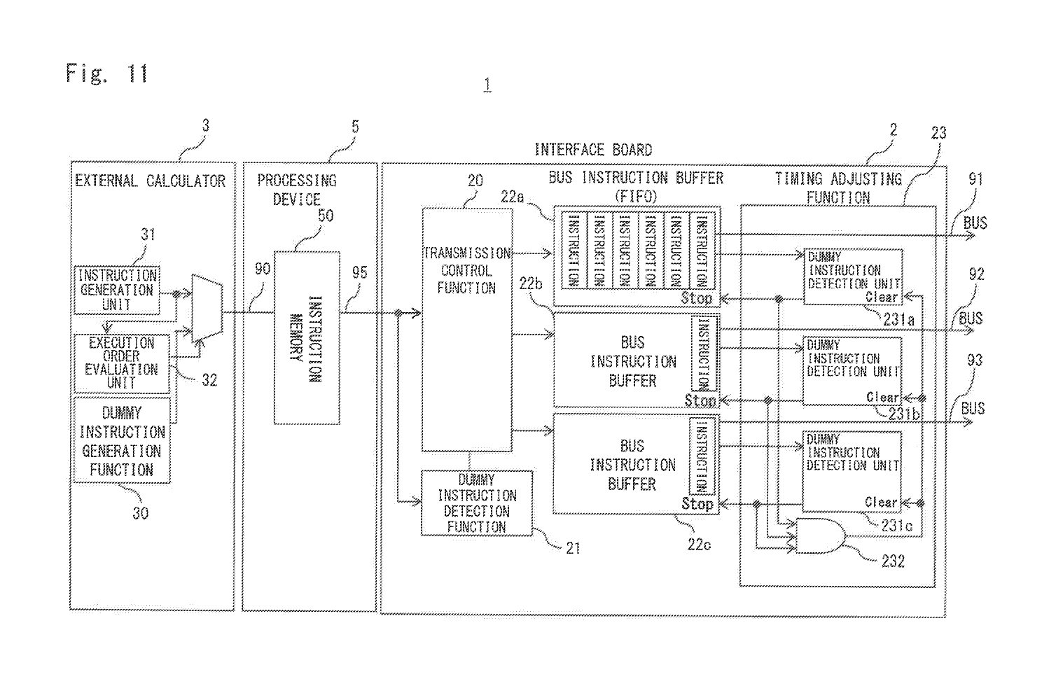

The module control system 1 is not limited to a configuration shown in FIGS. 1 and 2 in which the external calculator 3 is directly connected to the interface board 2. As shown in FIG. 11, the module control system 1 may be configured in such a way that the external calculator 3 and the interface board 2 are connected with a processing device 5 interposed therebetween. The external calculator 3 is connected to the processing device 5 through the communication path 90. The processing device 5 is connected to the interface board 2 through a communication path 95.

The processing device 5 is, for example a microcomputer board. The processing device 5 includes an instruction memory 50. The instruction memory 50 temporarily stores instructions received from the external calculator 3. The instruction memory 50 is, for example, a volatile storage device such as a DRAM, an SRAM, or the like. The processing device 5 may temporarily store the instructions received from the external calculator 3 in the instruction memory 50 and then sequentially transmit the instructions to the interface board 2. Accordingly, the instruction memory 50 stores the instructions in an FIFO order.

### MODIFIED EXAMPLE 2 OF FIRST EMBODIMENT

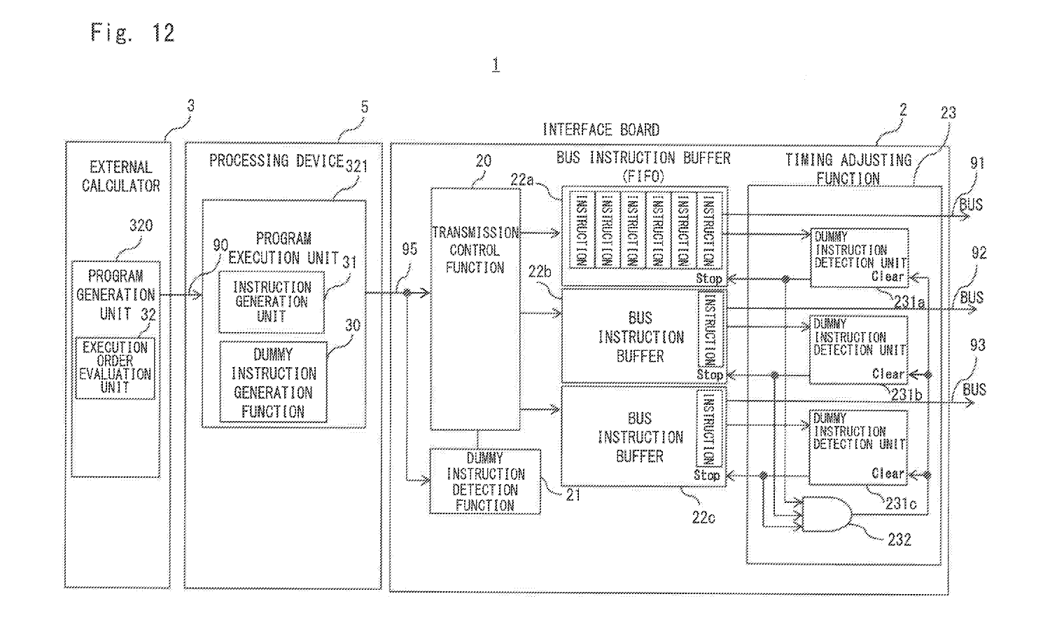

Usage of the processing device 5 is not limited to relaying the instructions transmitted from the external calculator 3 as described above. As shown in FIG. 12, the processing device 5 may execute the executable program that is generated by the compiler of the external calculator 3 collectively interpreting the source program 311 to thereby transmit the instructions are to the interface board 2.

In this modified example, the external calculator 3 includes a program generation unit 320. As the CPU 300 of the external calculator 3 has the function of the above compiler, the CPU 300 serves as the program generation unit 320. Further, the program generation unit 320 includes the execution order evaluation unit 32. When the execution order evaluation unit 32 detects instructions that should be executed in an execution order, the program generation unit 320 adds codes for generating and transmitting a dummy instruction(s) to codes for generating and transmitting the instructions that should be executed in the execution order in order to generate the executable program. The external calculator 3 transmits the generated executable program to the processing device 5.

Moreover, in this modified example, the processing device 5 includes a program execution unit 321. When a CPU (not shown) of the processing device 5 executes the executable program received from the external calculator 3, the CPU serves as the program execution unit 321. The program execution unit 321 includes the dummy instruction generation function 30 and the instruction generation unit 31. When the CPU of the processing device 5 executes the executable program, instructions are sequentially generated and transmitted to the interface board 2. At this time, a dummy instruction(s) is generated and inserted between the instructions that should be executed in an execution order. That is, when the CPU of the processing device 5 executes the executable program, the CPU serves as the instruction generation function 30 and the instruction generation unit 31.

Note that the processing device 5 may not immediately execute the executable program upon reception thereof and instead may store the executable program in a storage device of the processing device 5 and executes it at an arbitrary timing. By doing so, the plurality of modules 4 can be controlled by connecting only the processing device 5 and the interface board 2 thereto without the external calculator 3 being connected thereto. It is thus possible to eliminate a limitation in an operating range of the gadget composed of the plurality of modules 4. For example, when the external calculator 3 is connected to the interface board 2 by means of a cable, there is a limitation in the operating range of the gadget by a length of the cable. On the other hand, when only the processing device 5 (e.g., a microcomputer board) and the interface board 2 are connected to the gadget, as the processing device 5 and the interface board 2 are smaller than the external calculator 3 (e.g., a PC), it is possible to operate the gadget with the processing device 5 and the interface board 2 mounted thereon without a limitation in the operating range.

### Second Embodiment

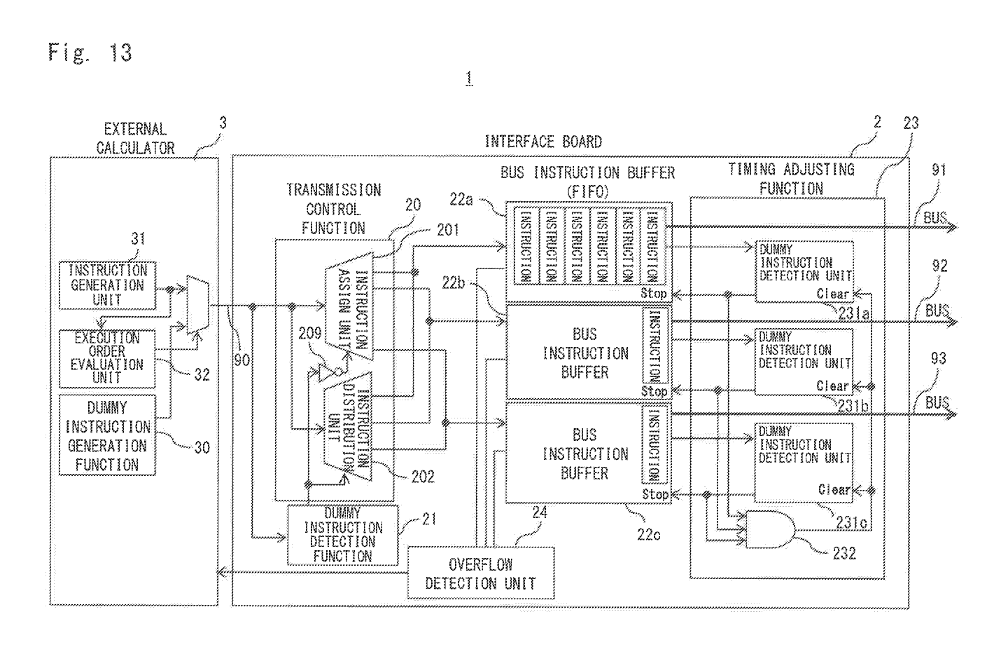

Next, a second embodiment will be described. In the following descriptions, the same contents as those in the first embodiment will be omitted as appropriate. The configurations of the interface board 2 and the external calculator 3 of the module control system 1 according to the second embodiment will be described with reference to FIG. 13. The interface board 2 according to the second embodiment further includes an overflow detection unit 24 in addition to the components included in the interface board 2 according to the first embodiment.

The overflow detection unit 24 detects an overflow in each of bus instruction buffers 22a to 22c. When the overflow detection unit 24 detects an overflow in at least one of the bus instruction buffers 22a to 22c, the overflow detection unit 24 transmits a notification signal to the external calculator 3 in order to notify the external calculator 3 of the detection of the overflow.

The dummy instruction generation function 30 and the instruction generation unit 31 of the external calculator 3 suspend generating and transmitting instructions in response to the notification signal from the interface board 2. The external calculator 3 may recover the interface board 2 by, for example, resetting the interface board 2 and then resume transmitting the instructions.

As described above, in the second embodiment, the overflow detection unit 24 detects an overflow of the bus instruction buffers 22 and notifies the external calculator 3, which is an input source of the instruction, of the detection. By doing so, the external calculator 3 can prevent, in response to the notification, an operation from being continued while the bus instruction buffers 22a to 22c of the interface board 2 overflow. It is thus possible to prevent operations from being continued when an abnormality occurs.

### MODIFIED EXAMPLE 1 OF SECOND EMBODIMENT

Although an example in which the interface board 2 includes the overflow detection unit 24 that detects an overflow of the bus instruction buffers 22a to 22c has been described so far, it is not limited to this. The interface board 2 may include a buffer full detection unit that detects a buffer full of the bus instruction buffers 22a to 22c (detects that the bus instruction buffers 22 are full) in place of the overflow detection unit 24.

In the modified example 1, when the buffer full detection unit detects that at least one of the bus instruction buffers 22a to 22c is full, the buffer full detection unit transmits a notification signal to the external calculator 3 in order to notify the external calculator 3 of the detection of the buffer full. The dummy instruction generation function 30 and the instruction generation unit 31 of the external calculator 3 suspend generating and transmitting instructions in response to the notification signal from the interface board 2. Moreover, when the buffer full of the bus instruction buffers 22a to 22c is resolved, the buffer full detection unit may cancel transmitting the notification signal to the external calculator 3. In this case, the dummy instruction generation function 30 and the instruction generation unit 31 of the external calculator 3 may resume generating and transmitting instructions when the transmission of the notification signal from the interface board 2 is canceled.

According to this modified example, it is possible to prevent the bus instruction buffers 22a to 22c of the interface board 2 from overflowing. Thus, it is possible to prevent the control from being continued when an abnormality occurs.

### MODIFIED EXAMPLE 2 OF SECOND EMBODIMENT

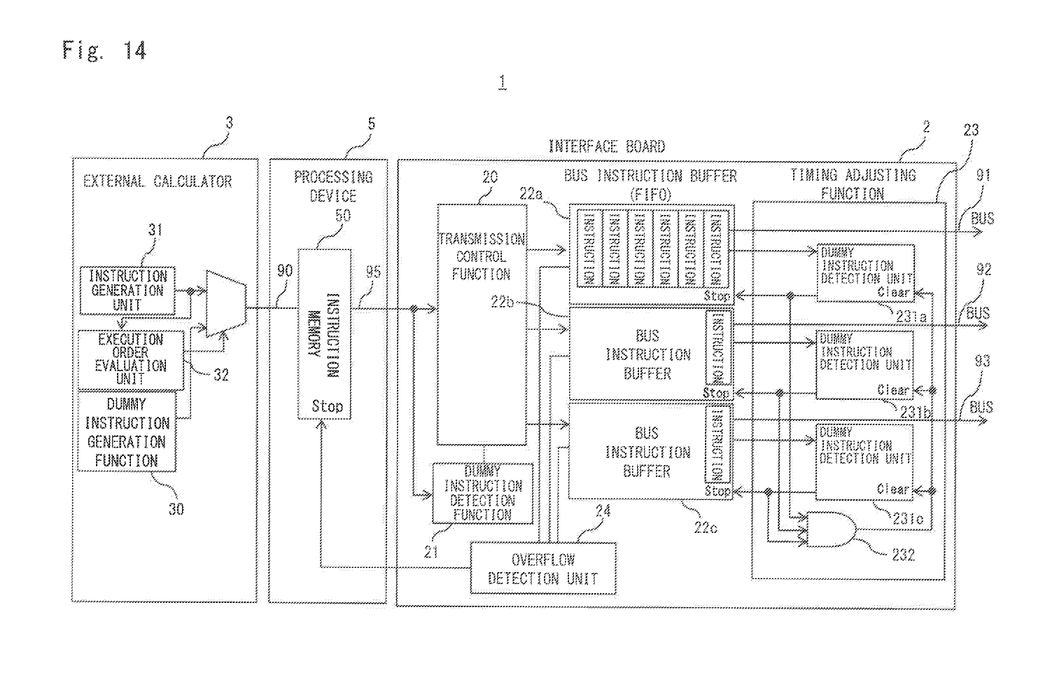

In the second embodiment, as shown in FIG. 14, the module control system 1 may connect the external calculator 3 to the interface board 2 with the processing device 5 interposed therebetween in a manner similar to the example shown in FIG. 11.

In this case, the overflow detection unit 24 transmits a notification signal to the processing device 5. The processing device 5 suspends transmitting the instructions accumulated in an instruction memory 50 in response to the notification signal from the interface board 2. Note that in a manner similar to the modified example 1, a buffer full detection unit may be included in place of the overflow detection unit 24.

Further, in a manner similar to the example shown in FIG. 12, the module control system 1 may be configured in such a way that when the processing device 5 executes an executable program that is generated by the compiler of the external calculator 3 collectively interpreting the source program 311, the instructions are transmitted to the interface board 2. In this case, a process for suspending the transmission of instructions in response to the notification signal from the interface board 2 may be included in the executable program, so that the CPU of the processing device 5 can suspends transmitting the instructions in response to the notification signal. Alternatively, an abnormality process may be included in the executable program, and when the CPU of the processing device 5 receives the notification signal while executing the executable program, the CPU may recover the interface board 2 by, for example, resetting the interface board 2 in the abnormality process and then resume the transmission of the instructions.

### Third Embodiment

Next, a third embodiment will be described. In the following descriptions, the same contents as those in the first and second embodiments will be omitted as appropriate.

There are following two major cases in which a user wants to keep an execution order of instructions.

(1) The User Simply wants to Keep an Order of Instructions

For example, as described above, the user wishes to acquire the sensor value by the first instruction and drive the motor based on the sensor value acquired by the second instruction.

(2) The User wants to Separate Instructions by each Control Cycle

For example, in motor control, a timing of a fixed cycle is determined for a timing at which the sensor value is sampled and an instruction timing to the motor based on the control theory. A control value of the motor is represented by a function of a cycle of the sampling and the instruction. The motor does not operate as designed if the cycle differs from an expected value.

The first and second embodiments can achieve (1) but not (2). Thus, in the third embodiment, a module control system 1 that can achieve both (1) and (2) will be described.

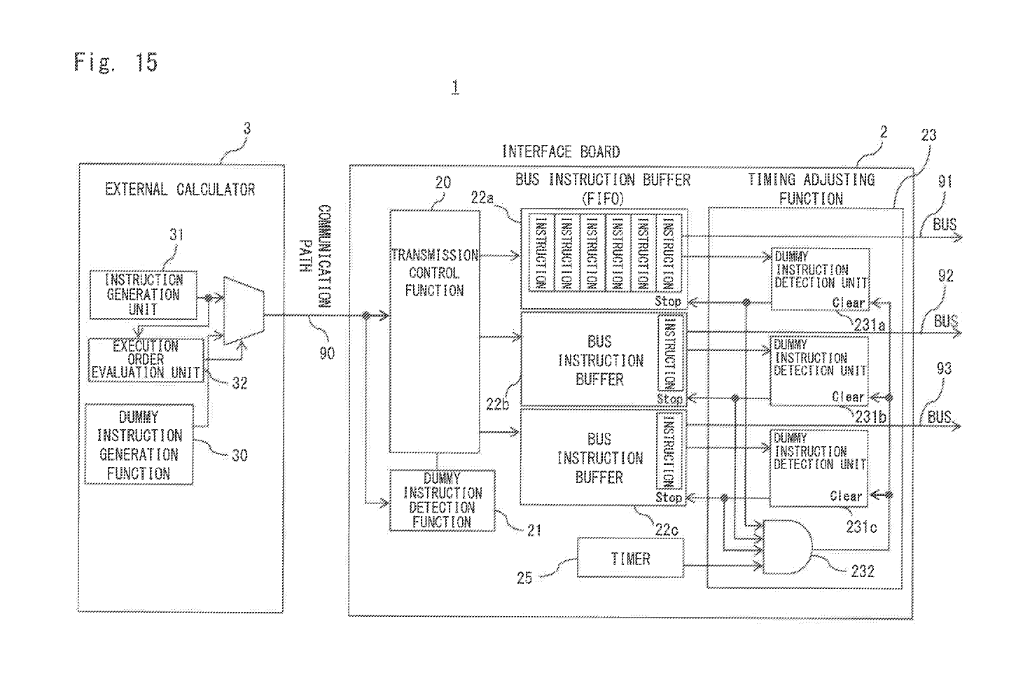

The configurations of the interface board and the external calculator according to the third embodiment will be described with reference to FIG. 15. A difference of the interface board 2 according to the third embodiment from the interface board 2 according to the first embodiment is that the interface board 2 according to the third embodiment further includes a timer 25 in addition to the components included in the interface board 2 according to the first embodiment.

The timer 25 is a circuit that outputs a notification signal to the AND circuit 232 in order to periodically notify the AND circuit 232 of a passage of a fixed cycle. Thus, when suspension signals are input from all of the dummy instruction detection unit 231a to 231c and the notification signal is input from the timer 25 to the AND circuit 232 according to the third embodiment, the AND circuit 232 outputs clear signals to all of the instruction detection units 231a to 231c. On the other hand, if at least one of the suspension signals from the dummy instruction detection units 231a to 231c and the suspension signal from the timer 25 is not input to the AND circuit 232, the AND circuit 232 does not output the clear signals to the dummy instruction detection units 231a to 231c.

To be more specific, the timer 25 outputs a pulse signal, a level of which rises to a high level for a fixed time, to the AND circuit 232 every time a time of the fixed cycle passes. Accordingly, this pulse signal (a high level signal) corresponds to the notification signal.

When the high level signals are input from all of the dummy instruction detection units 231a to 231c and the timer 25, the AND circuit 232 outputs the high level signals to all of the dummy instruction detection unit 231a to 231c. On the other hand, when a low level signal is input from at least one of the dummy instruction detection units 231a to 231c and the timer 25, the AND circuit 232 outputs low level signals to all of the dummy instruction detection units 231a to 231c. Note that the operations of the bus instruction buffers 22a to 22c and the dummy instruction detection units 231a to 231c that depend on whether the input signals are high levels or low levels have been described in the first embodiment.

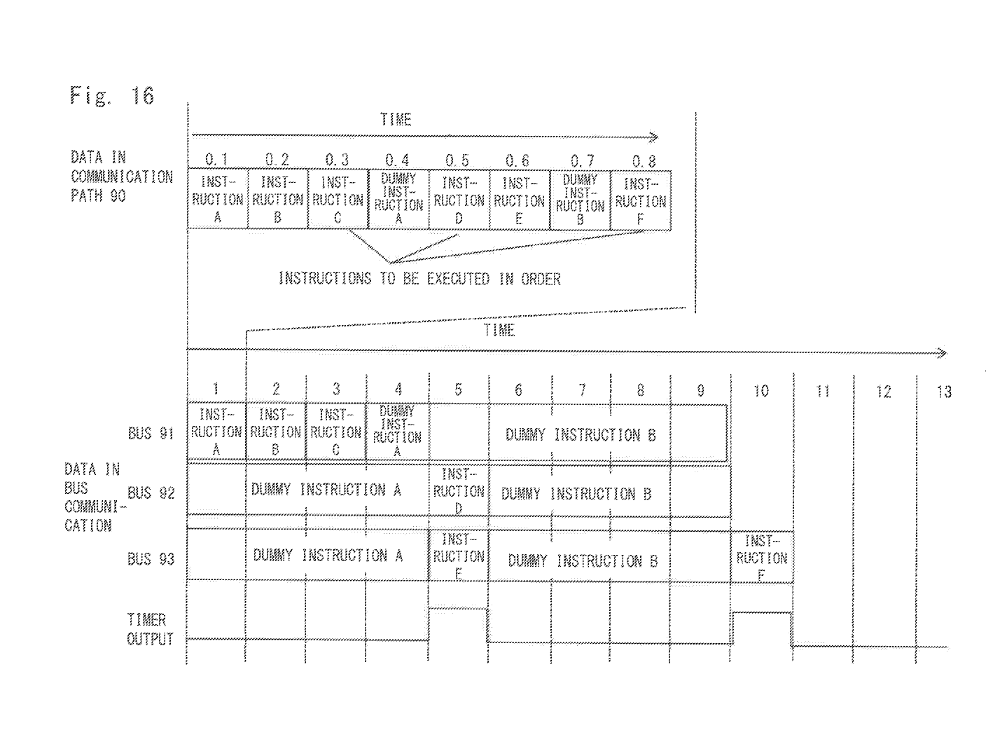

Next, an execution order of instructions according to the third embodiment will be described with reference to FIG. 16. With reference to FIG. 16, in a manner similar to that of the example shown in FIG. 4 according to the first embodiment, an example in which the instruction generation unit 31 of the external calculator 3 generates instructions A to F in this order will be described. Note that a cycle at which the timer 25 outputs the notification signal is a five unit time and indicates “time 5” and “time 10”. As states of the buses 91 to 93 from “time 1” to “time 3” are the same as those shown in FIG. 4, the descriptions thereof will be omitted.

### (Time 4)

Instructions transmitted from all of the bus instruction buffers 22a to 22c are dummy instructions. However, the timer 25 has not notified the timing adjusting function 23 of a passage of a time of a fixed cycle A. Accordingly, the timing adjusting function 23 suspends operations of the bus instruction buffers 22a to 22c that transmit dummy instructions A.

### (Time 5)

The timer 25 notifies the timing adjusting function 23 of a passage of a time of the fixed cycle. Thus, as the instructions transmitted from all of the bus instruction buffers 22a to 22c are the dummy instructions A, and the notification is transmitted from the timer 25, the timing adjusting function 23 resumes the operations of the bus instruction buffers 22a to 22c. At this time, the bus instruction buffers 22a to 22c discard the dummy instructions A.

Thus, the dummy instruction B stored in the bus instruction buffer 22a is transmitted to the bus 91. The bus instruction buffer 22b transmits the instruction D to the bus 92. The bus instruction buffer 22c also transmits the instruction E to the bus 93.

### (Time 6) to (Time 9)

The dummy instruction B stored in the bus instruction buffer 22b is transmitted to the bus 92. The dummy instruction B stored in the bus instruction buffer 22c is transmitted to the bus 93. Although the instructions transmitted from all of the bus instruction buffers 22a to 22c are the dummy instructions B, the timer 25 has not transmitted the notification to the timing adjusting function 23. The timing adjusting function 23 suspends the operations of the bus instruction buffers 22a to 22c that transmit the dummy instructions B.

### (Time 10)

The timer 25 notifies the timing adjusting function 23 of a passage of a time of the fixed cycle. Thus, as the instructions transmitted from all of the bus instruction buffers 22a to 22c are the dummy instructions B, and the notification is transmitted from the timer 25, the timing adjusting function 23 resumes the operations of the bus instruction buffers 22a to 22c. At this time, the bus instruction buffers 22a to 22c discard the dummy instructions B. Then, the bus instruction buffer 22c transmits the instruction F to the bus 93. The modules 4 connected to the bus 93 receive the instruction F transmitted from the bus instruction buffer 22c and execute it.

According to the above module control system 1 of the third embodiment, the modules 4 can be controlled by each control cycle by setting the cycle of the timer 25 to a control cycle. Moreover, according to the module control system 1 of the third embodiment, it is possible to separate instructions to be executed in each control cycle. For example, the instructions from the dummy instruction A to the dummy instruction B may be executed in a period from the time 5 to the time 9, and the instructions from the dummy instruction B onward may be executed in a period from the time 10. That is, instructions can be separated and executed in such a way that when the instructions D and E are the sensor value acquisition instructions and the instruction F is the motor drive instruction, the sensor value acquisition instructions are executed in the period from the time 5 to the time 9, and the motor drive instruction is executed in the period from the time 10.

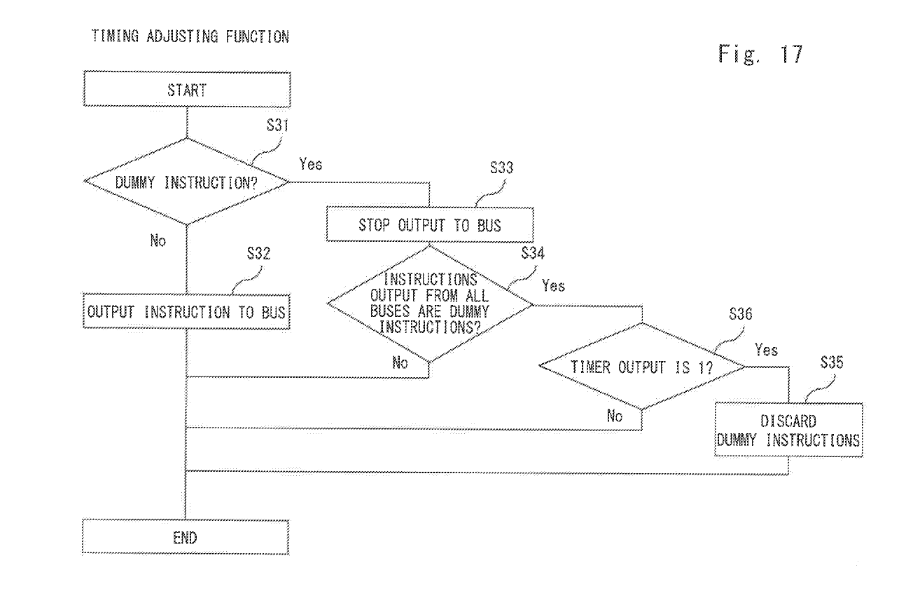

Next, an operation of the timing adjusting function 23 of the interface board 2 according to the third embodiment will be described with reference to FIG. 17. A difference of an operation of the timing adjusting function 23 according to the third embodiment from the operation of the timing adjusting function 23 according to the first embodiment is that the operation of the timing adjusting function 23 according to the third embodiment further includes the step S36 in addition to the operation of the timing adjusting function 23 according to the first embodiment shown in FIG. 8.

That is, the timing adjusting function 23 evaluates as to whether or not dummy instructions are output from all of the bus instruction buffers 22a to 22c, and the output of the timer 25 is one (a high level) (S34 and S36). When the timing adjusting function 23 determines that the dummy instructions are output from all of the bus instruction buffers 22a to 22c and the output of the timer 25 is one (a high level) (S34: Yes and S36: Yes), the timing adjusting function 23 instructs the bus instruction buffers 22a to 22c to discard the dummy instructions (S35). Then, the bus instruction buffers 22a to 22c resume outputting the instructions to the buses 91 to 93, respectively (S32).

On the other hand, when the timing adjusting function 23 determines that the dummy instructions are not output from all of the bus instruction buffers 22a to 22c or the output of the timer 25 is not 1 (a high level) (S34: No or S36: No), the timing adjusting function 23 does not instruct the bus instruction buffers 22a to 22c to discard the dummy instructions.

As described so far, in the third embodiment, the timing adjusting function 23 stops an output of instructions from the bus instruction buffer 22, an instruction output therefrom has become a dummy instruction, until instructions output from all of the bus instruction buffers 22a to 22c become dummy instructions and a notification signal is output from the timer 25. By doing so, the instructions following the dummy instruction can be executed at timings of the cycle of the timer 25. Thus, the modules 4 can be controlled by a predetermined control cycle. Moreover, the instructions between the dummy instructions can be separately executed by each cycle of the timer 25. That is, the instructions can be separated and executed in each control cycle.

### MODIFIED EXAMPLE OF THIRD EMBODIMENT

Also in the third embodiment, in a manner similar to the example shown in FIG. 11, the external calculator 3 may be connected to the interface board 2 with the processing device 5 interposed therebetween. Further, also in the third embodiment, in a manner similar to that the example shown in FIG. 12, the module control system 1 may be configured in such a way that when the processing device 5 executes the executable program that is generated by the compiler of the external calculator 3 collectively interpreting the source program 311, the instructions are transmitted to the interface board 2.

### Fourth Embodiment

Next, a fourth embodiment will be described. In the following descriptions, the same contents as those in the first to third embodiments will be omitted as appropriate. In the fourth embodiment, a configuration in which the problem of overflow, which is mentioned in the second embodiment, and the problem of the control cycle, which is mentioned in the third embodiment, can be solved at the same time will be described.

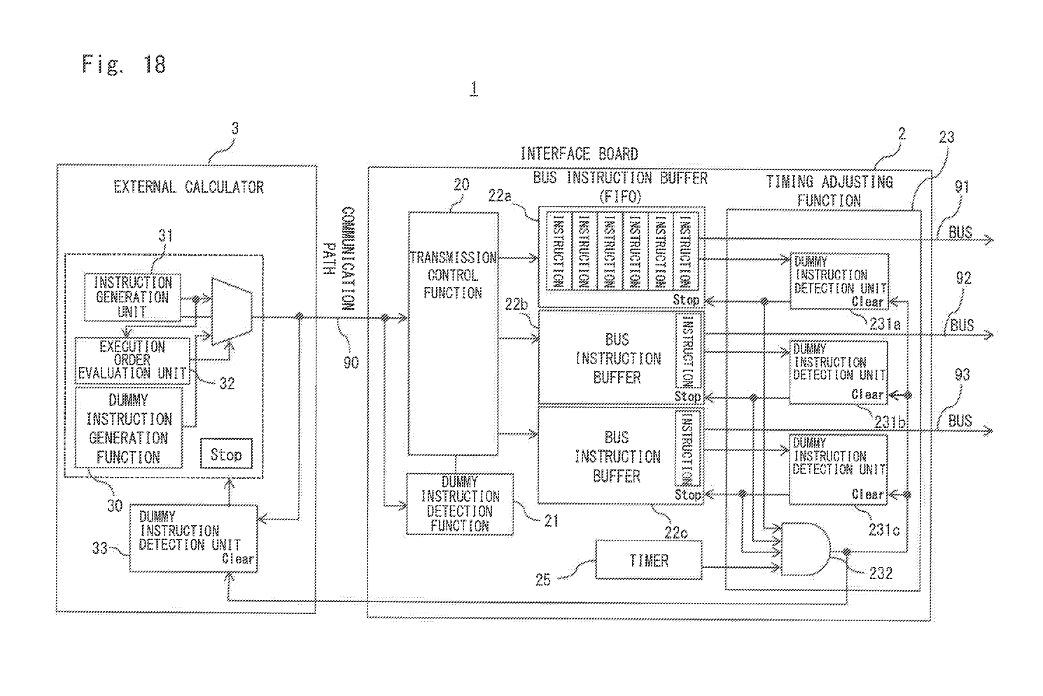

The configurations of the interface board 2 and the external calculator 3 according to the fourth embodiment will be described with reference to FIG. 18. The external calculator 3 according to the fourth embodiment further includes a dummy instruction detection unit 33 in addition to the components included in the external calculator 3 according to the third embodiment.

The dummy instruction detection unit 33 detects an instruction N after the timing adjusting function 23 detects a different dummy instruction (N is a predetermined positive integer). That is, the dummy instruction detection unit 33 detects an Nth dummy instruction (not including a first dummy instruction) from when the first dummy instruction is transmitted to the interface board 2. In other words, the dummy instruction detection unit 33 detects an N+1th dummy instruction from when the transmission of the instructions is started.

When the dummy instruction detection unit 33 detects the dummy instruction N after the dummy instruction detection unit 23 detects the different dummy instruction, the dummy instruction detection unit 33 suspends operations of a dummy instruction generation function 30, an instruction generation unit 31, and an execution order evaluation unit 32. In other words, the dummy instruction generation function 30 and the instruction generation unit 31 suspends generating and transmitting instructions.

Further, a difference of an AND circuit 232 according to the fourth embodiment from the AND circuit 232 according to the third embodiment is that the AND circuit 232 of the forth embodiment transmits a clear signal to the dummy instruction detection unit 33 of the external calculator 3 not only to the dummy instruction detection units 231a to 231c.

The dummy instruction detection unit 33 resumes the operations of the dummy instruction generation function 30, the instruction generation unit 31, and the execution order evaluation unit 32 in response to reception of the clear signal from the AND circuit 232. In other words, the dummy instruction generation function 30 and the instruction generation unit 31 resume generating and transmitting instructions.

In this way, when the timing adjusting function 23 waits for an output of an xth dummy instruction, the external calculator 3 stops transmitting instructions from an x+Nth dummy instruction onward. Thus, only the instructions transmitted from the xth dummy instruction until the x+Nth dummy instruction are stored in the bus instruction buffers 22a to 22c. It is thus possible to control the number of instructions stored in the bus instruction buffers 22a to 22c to thereby prevent the bus instruction buffers 22a to 22c from overflowing.

Note that after the first detection, the dummy instruction detection unit 33 may firstly resume the operations of the dummy instruction generation function 30, the instruction generation unit 31, and the execution order evaluation unit 32, and when the dummy instruction detection unit 33 detects a next dummy instruction transmitted to the interface board 2, the dummy instruction detection unit 33 may suspend the operations of the dummy instruction generation function 30, the instruction generation unit 31, and the execution order evaluation unit 32. As the instructions up to the N+1th dummy instruction have been transmitted first, by alternately repeating the transmission suspension and the transmission resumption for each dummy instruction, the bus instruction buffers 22a to 22c can be maintained in a state in which the instructions transmitted from the xth dummy instruction until the x+Nth dummy instruction are stored therein.

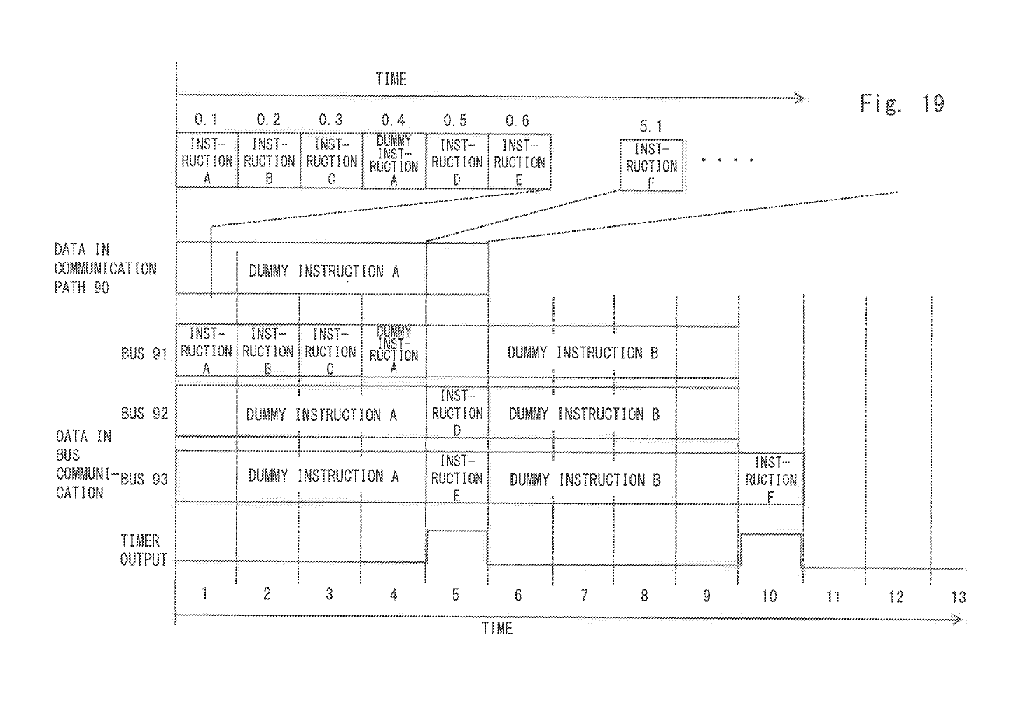

Next, an execution order of instructions according to the fourth embodiment will be described with reference to FIG. 19. With reference to FIG. 19, in a manner similar to that of the example shown in FIG. 16 according to the third embodiment, an example in which the instruction generation unit 31 of the external calculator 3 generates instructions A to F in this order will be described. Note that N is assumed to be one in order to simplify the descriptions.

As shown in FIG. 19, although states of the buses 91 to 93 are the same as those shown in the example of FIG. 16 according to the third embodiment, a state of the communication path 90 differs from that of the third embodiment. As shown in FIG. 16, when a second (N+1th) dummy instruction B is detected, the external calculator 3 suspends generating and transmitting instructions. Thus, the transmission of the dummy instruction B is not completed in the communication path 90. As described above, this state of the communication path 90 is continued until the dummy instructions A are transmitted to all of the buses 91 to 93 and until the “time 5” at which the pulse signal is output from the timer 25.

Thus, the transmission of the instructions to the buses 92 and 93 is suspended until the dummy instruction A is transmitted to the bus 91. However, only the instructions generated between the dummy instructions A and B are stored in the bus instruction buffers 22b and 22c that correspond to the buses 92 and 93, respectively. It is thus possible to prevent the bus instruction buffers 22b and 22c from overflowing.

As described above, in the fourth embodiment, the dummy instruction detection unit 33 suspends outputting instructions to the interface board 2 when a predetermined number of dummy instructions are input to the interface board 2. When instructions output from all of the bus instruction buffers 22a to 22c are the dummy instructions, and the notification signal is output from the timer 25, the timing adjusting function 23 outputs the clear signal to the external calculator 3. Then, the dummy instruction detection unit 33 resumes the interrupted output of the instructions in response to the output of the notification signal from the timing adjusting function 23.

Therefore, the number of instructions stored in the bus instruction buffers 22a to 22c is limited to a predetermined number of dummy instructions from a first dummy instruction. It is thus possible to control the number of instructions stored in the bus instruction buffers 22a to 22c to thereby prevent the bus instruction buffers 22a to 22c from overflowing.

### MODIFIED EXAMPLE OF FOURTH EMBODIMENT

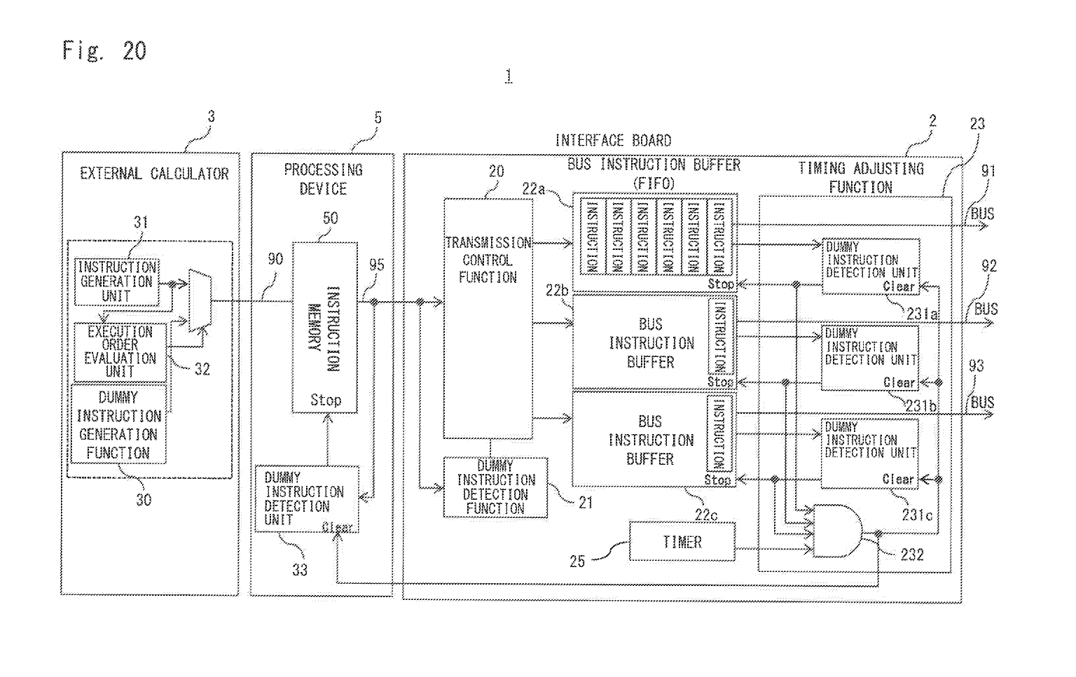

Also in the fourth embodiment, as shown in FIG. 20, in a manner similar to the example shown in FIG. 11, the module control system 1 may be configured in such a way that the external calculator 3 is connected to the interface board 2 with the processing device 5 interposed therebetween.

In this case, as shown in FIG. 20, the processing device 5 instead of the external calculator 3 may include the dummy instruction detection unit 33. When the dummy instruction detection unit 33 detects a dummy instruction N after the timing adjusting function 23 detects a different dummy instruction, the processing device 5 suspends transmitting the instructions accumulated in the instruction memory 50. Further, the processing device 5 resumes transmitting the instructions accumulated in the instruction memory 50 when the dummy instruction detection unit 33 receives the clear signal.

Further, also in the fourth embodiment, in a manner similar to the example shown in FIG. 12, the module control system 1 may be configured in such a way that when the processing device 5 executes the executable program that is generated by the compiler of the external calculator 3 collectively interpreting the source program 311, the instructions are transmitted to the interface board 2. In this case, a process for suspending the transmission of the instructions when a dummy instruction N before the timing adjusting function 23 detects a different dummy instruction may be included in the executable program, so that the CPU of the processing device 5 suspends transmitting the instructions in response to transmission of the dummy instruction N before the timing adjusting function 23 detects the different dummy instruction. Further, a process for resuming the transmission of the instructions in response to the clear signal from the interface board 2 may be included in the executable program, so that the CPU of the processing device 5 can resume transmitting the instructions in response to the clear signal. As a modified example according to the fourth embodiment, a configuration in which the interface board 2 does not include the timer 25 (a configuration according to the first embodiment further including the dummy instruction detection unit 33) may be employed.

### Fifth Embodiment

Next, a fifth embodiment will be described. In the following descriptions, the same contents as those in the first to fourth embodiments will be omitted as appropriate.

As described above, there are the following two cases in which: (1) the user simply wants to keep an order of instructions, and (2) the user wants to separate instructions by each control cycle. In consideration of an actual operation of the gadget (the modules 4), (1) and (2) are often combined. That is, there are many cases in which the user wants to achieve (1) at a certain timing, and the user wants to achieve also (2) at another timing. Thus, in the fifth embodiment, a method for achieving control where (1) and (2) are combined will be described.

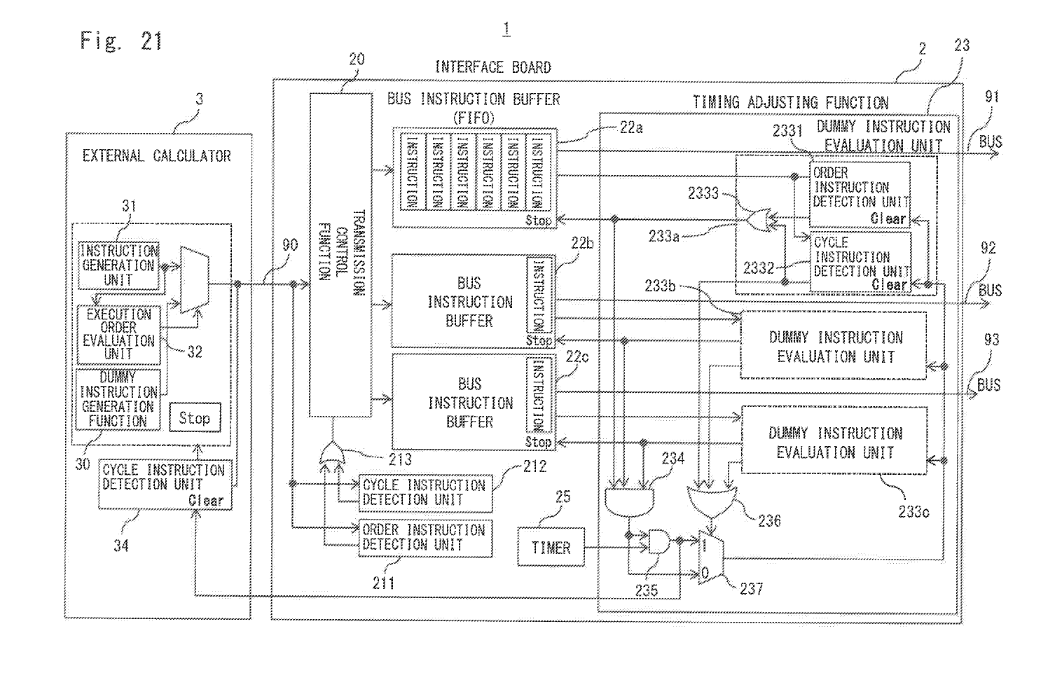

As shown in FIG. 21, a difference of the interface board 2 according to the fifth embodiment from the interface board 2 according to the fourth embodiment is that the interface board 2 according to the fifth embodiment includes an order instruction detection unit 211, a cycle instruction detection unit 212, and an OR circuit 213 in place of the dummy instruction detection function 21 included in the interface board 2 according to the fourth embodiment.

When an order input to the transmission control function 20 is an order instruction, the order instruction detection unit 211 outputs a broadcast instruction signal to the OR circuit 213. When an instruction input to the transmission control function 20 is a cycle instruction, the cycle instruction detection unit 212 outputs a broadcast instruction signal to the OR circuit 213.

The OR circuit 213 outputs a signal generated by ORing the signals input from the order instruction detection unit 211 and the cycle instruction detection unit 212 to a broadcast terminal included in the transmission control function 20. In other words, when the broadcast instruction signal is input from at least one of the order instruction detection unit 211 and the cycle instruction detection unit 212, the OR circuit 213 outputs the broadcast instruction signal to the transmission control function 20. On the other hand, when the broadcast instruction signal is not input from either of the order instruction detection unit 211 or the cycle instruction detection unit 212, the OR circuit 213 does not output the broadcast instruction signal.

To be more specific, the order instruction detection unit 211 and the cycle instruction detection unit 212 are achieved, for example, by the following circuits. Each of the order instruction detection unit 211 and the cycle instruction detection unit 212 outputs a signal that can be switched to a high level or a low level to the transmission control function 20. When the order instruction is input to the transmission control function 20, the order instruction detection unit 211 outputs a high level signal. On the other hand, when the order instruction is not input to the transmission control function 20, the order instruction detection unit 211 outputs a low level signal. When the cycle instruction is input to the transmission control function 20, the cycle instruction detection unit 212 outputs a high level signal. On the other hand, when the cycle instruction is not input to the transmission control function 20, the cycle instruction detection unit 212 outputs a low level signal. That is, the high level signal corresponds to the broadcast instruction signal.

Accordingly, when the high level signal is input from at least one of the order instruction detection unit 211 and the cycle instruction detection unit 212, the OR circuit 213 outputs a high level signal to the transmission control function 20. On the other hand, when the low level signals are input from both of the order instruction detection unit 211 and the cycle instruction detection unit 212, the OR circuit 213 outputs a low level signal to the transmission control function 20.

As described so far, in the fifth embodiment, there are order instruction and cycle instruction as the dummy instruction. As described in the first and second embodiments, the order instruction serves as the dummy instruction in the case (1) when the user simply wants to execute instructions in order. As described in the third and fourth embodiments, the cycle instruction serves as the dummy instruction in the case (2) when the user wants to separate instructions by each control cycle.

Further, as shown in FIG. 21, a difference of the interface board 2 according to the fifth embodiment from the interface board 2 according to the fourth embodiment is that the interface board 2 according to the fifth embodiment includes dummy instruction evaluation units 233a to 233c in place of the dummy instruction detection units 231a to 231c included in the interface board 2 according to the fourth embodiment. Another difference of the interface board 2 according to the fifth embodiment from the interface board 2 according to the fourth embodiment is that the interface board 2 according to the fifth embodiment includes AND circuits 234 and 235, an OR circuit 236, and a selection circuit 237 in place of the AND circuit 232 included in the interface board 2 according to the fourth embodiment. Each of the dummy instruction evaluation unit 233a to 233c includes an order instruction detection unit 2331, a cycle instruction detection unit 2332, and an OR circuit 2333.

Each of the dummy instruction evaluation unit 233a to 233c monitors instructions output from the respective bus instruction buffers 22a to 22c, respectively, and detects an output of the dummy instruction (the order instruction and the cycle instruction). The dummy instruction evaluation unit 233a monitors the bus instruction buffer 22a, the dummy instruction evaluation unit 233b monitors the bus instruction buffer 22b, and the dummy instruction evaluation unit 233c monitors the bus instruction buffer 22c.

When the order instruction or the cycle instruction is output from the bus instruction buffer 22a, the dummy instruction evaluation unit 233a outputs a suspension signal to the bus instruction buffer 22a. When the order instruction or the cycle instruction is output from the bus instruction buffer 22b, the dummy instruction evaluation unit 233b outputs a suspension signal to the bus instruction buffer 22b. When the order instruction or the cycle instruction is output from the bus instruction buffer 22c, the dummy instruction evaluation unit 233c outputs a suspension signal to the bus instruction buffer 22c. Further, when the order instruction is output from the bus instruction buffers 22a to 22c, the respective dummy instruction evaluation units 233a to 233c output a suspension signal to the AND circuit 234. When the cycle instruction is output from the bus instruction buffers 22a to 22c, the respective dummy instruction evaluation units 233a to 233c output a suspension signal to the OR circuit 236.

To be more specific, when the order instruction is output from the bus instruction buffer 22 to the dummy instruction evaluation units 233a to 233c, the corresponding the order instruction detection unit 2331 outputs a suspension signal to the corresponding OR circuit 2333. Further, when the cycle instruction is output from the bus instruction buffer 22, the corresponding cycle instruction detection unit 2332 outputs the suspension signal to the corresponding OR circuit 2333 and the OR circuit 236.

The OR circuit 2333 outputs a signal generated by ORing the signals input from the order instruction detection unit 2331 and the cycle instruction detection unit 2332 to the corresponding bus instruction buffer 22 and the AND circuit 234. In other words, when the suspension signal is input from at least one of the order instruction detection unit 2331 and the cycle instruction detection unit 2332, the OR circuit 2333 outputs the suspension signal to the OR circuit 2333 and the OR circuit 236. On the other hand, when the suspension signal is not input from either of the order instruction detection unit 2331 and the cycle instruction detection unit 2332, the OR circuit 2333 does not output the suspension signal.

To be more specific, the order instruction detection unit 2331, the cycle instruction detection unit 2332, and the OR circuit 2333 are achieved by, for example, the following circuits. Each of the order instruction detection unit 2331 and the cycle instruction detection unit 2332 outputs a signal that can be switched to a high level and a low level to the transmission control function 20. When the order instruction is output from the corresponding bus instruction buffer 22, the order instruction detection unit 2331 outputs a high level signal. On the other hand, when the order instruction is not output from the corresponding bus instruction buffer 22, the order instruction detection unit 2331 outputs a low level signal. When the order instruction is output from the corresponding bus instruction buffer 22, the order instruction detection unit 2332 outputs a high level signal. On the other hand, when the order instruction is not output from the corresponding bus instruction buffer 22, the order instruction detection unit 212 outputs a low level signal. That is, the high level signal corresponds to the suspension signal.

Accordingly, when the high level signal is input from at least one of the order instruction detection unit 2331 and the cycle instruction detection unit 2332, the OR circuit 2333 outputs a high level signal to the corresponding bus instruction buffer and the AND circuit 234. On the other hand, when the low level signals are input from both of the order instruction detection unit 2331 and the cycle instruction detection unit 2332, the OR circuit 2333 outputs a low level signal to the corresponding bus instruction buffer and the AND circuit 234.

The AND circuit 234 outputs a signal obtained by ANDing the signals input from the dummy instruction detection units 233a to 233c to the AND circuit 235 and the selection circuit 237. When the suspension signals are input from all of the dummy instruction evaluation unit 233a to 233c, the AND circuit 234 outputs a suspension signal to the AND circuit 235. This suspension signal serves as the clear signal. On the other hand, when the suspension signal is not input from at least one of the dummy instruction evaluation units 233a to 233c, the AND circuit 232 does not output the clear signal to the AND circuit 235 and the selection circuit 237.

The AND circuit 235 outputs a signal generated by ANDing the signals input from the AND circuit 234 and the timer 25 to the selection circuit 237. When the suspension signal is input from the AND circuit 234 and the notification signal is input from the timer 25, the AND circuit 235 outputs the clear signal to the selection circuit 237. On the other hand, when at least one of the clear signal from the AND circuit 234 and the notification signal from the timer 25 is not input, the AND circuit 235 does not output the clear signal to the selection circuit 237.

The OR circuit 236 outputs a signal generated by ANDing the signals input from the dummy instruction evaluation unit 233a to 233c to a signal selection terminal of the selection circuit 237. When the suspension signal is input from at least one of the dummy instruction evaluation units 233a to 233c, the OR circuit 236 outputs a selection signal for selecting the clear signal of the AND circuit 235 to the selection circuit 237. On the other hand, when the suspension signal is not input from any of the dummy instruction evaluation units 233a to 233c, the OR circuit 236 outputs a selection signal for selecting the clear signal of the AND circuit 234 to the selection circuit 237.

When the selection signal for selecting the clear signal of the AND circuit 234 is input from the OR circuit 236, the selection circuit 237 selects the clear signal input from the AND circuit 234 and outputs it to the dummy instruction evaluation units 233a to 233c. On the other hand, when the selection signal for selecting the clear signal of the AND circuit 235 is input from the OR circuit 236, the selection circuit 237 selects the clear signal input from the AND circuit 235 and outputs it to the dummy instruction evaluation unit 233a to 233c.

To be more specific, the AND circuits 234 and 235, the OR circuit 236, and the selection circuit 237 operate, for example, as described below. When the high level signals are input from all of the dummy instruction detection units 233a to 233c, the AND circuit 234 outputs high level signals to the AND circuit 235 and the selection circuit 237. On the other hand, when the low level signal is input from at least one of the dummy instruction detection units 233a to 233c, the AND circuit 234 outputs low level signals to the AND circuit 235 and the selection circuit 237.

When the high level signals are input from both of the AND circuit 234 and the timer 25, the AND circuit 235 outputs high level signals to the AND circuit 235 and the selection circuit 237. On the other hand, when the low level signal is input from at least one of the AND circuit 234 and the timer 25, the AND circuit 234 outputs low level signals to the AND circuit 235 and the selection circuit 237.

When the high level signal is input from at least one of the dummy instruction evaluation units 233a to 233c, the OR circuit 236 outputs a high level signal to the selection circuit 237. When the low level signals are input from all of the dummy instruction evaluation units 233a to 233c, the OR circuit 236 outputs a low level signal to the selection circuit 237.

When the high level signal is input from the OR circuit 236, the selection circuit 237 outputs the signal input from the AND circuit 235 to each of the dummy instruction evaluation units 233a to 233c. On the other hand, when the low level signal is input from the OR circuit 236, the selection circuit 237 outputs the signal input from the AND circuit 234 to each of the dummy instruction evaluation unit 233a to 233c.

Accordingly, the high level signal output from the OR circuit 236 corresponds to the selection signal for selecting the clear signal of the AND circuit 235. The low level signal output from the OR circuit 236 corresponds to the selection signal for selecting the clear signal of the AND circuit 234. The high level signals output from the AND circuits 234, 235, and the selection circuit 237 correspond to the clear signal.

With such a configuration, even when one of the order instruction and the cycle instruction is output from the bus instruction buffers 22, it is possible to suspend the bus instruction buffer 22 from outputting instructions. After that, when outputs from all of the bus instruction buffers 22a to 22c become the order instructions or the cycle instructions, the suspended output of the instructions from the bus instruction buffers 22 can be resumed. At this time, when the dummy instructions are the cycle instructions, the output of the instructions from the bus instruction buffers 22 can be resumed only if the timer 25 transmits the notification of the fixed cycle. On the other hand, when the dummy instructions are the order instructions, the output of the instructions from the bus instruction buffers 22 can be resumed regardless of whether or not the timer 25 transmits the notification of the fixed cycle.

Thus, an execution order of instructions can be guaranteed by the external calculator 3 inserting the order instruction between instructions which the user simply wants to execute in order. Additionally, an execution order of instructions can be guaranteed and the instructions can be separated and executed by a predetermined control cycle, by the external calculator 3 inserting the cycle instruction between instructions which the user wishes to separate by a predetermined control cycle.

Further, as shown in FIG. 21, a difference of the external calculator 3 according to the fifth embodiment from the external calculator 3 according to the fourth embodiment is that the external calculator 3 of the fifth embodiment includes a cycle instruction detection unit 34 in place of the dummy instruction detection unit 33 included in the external calculator 3 according to the fourth embodiment.

The cycle instruction detection unit 34 detects a cycle instruction N before the timing adjusting function 23 detects a different cycle instruction (N is a predetermined positive integer). That is, the cycle instruction detection unit 34 operates in a manner similar to the dummy instruction detection unit 33 according to the fourth embodiment except that the cycle instruction detection unit 34 detects only the cycle instruction and not the order instruction as the dummy instruction.

The AND circuit 235 outputs a signal also to the cycle instruction detection unit 34 of the external calculator 3. Accordingly, although it has been described that the dummy instruction detection unit 33 according to the fourth embodiment resumes the operation of the dummy instruction generation function 30, the instruction generation unit 31, and the execution order evaluation unit 32 in response to the clear signal from the AND circuit 232, the cycle instruction detection unit 34 resumes the operation of the dummy instruction generation function 30, the instruction generation unit 31, and the execution order evaluation unit 32 in response to the clear signal from the AND circuit 235.

In a manner similar to the fourth embodiment, it is thus possible to control the number of instructions stored in the bus instruction buffers 22a to 22c and prevent the bus instruction buffers 22a to 22c from overflowing.

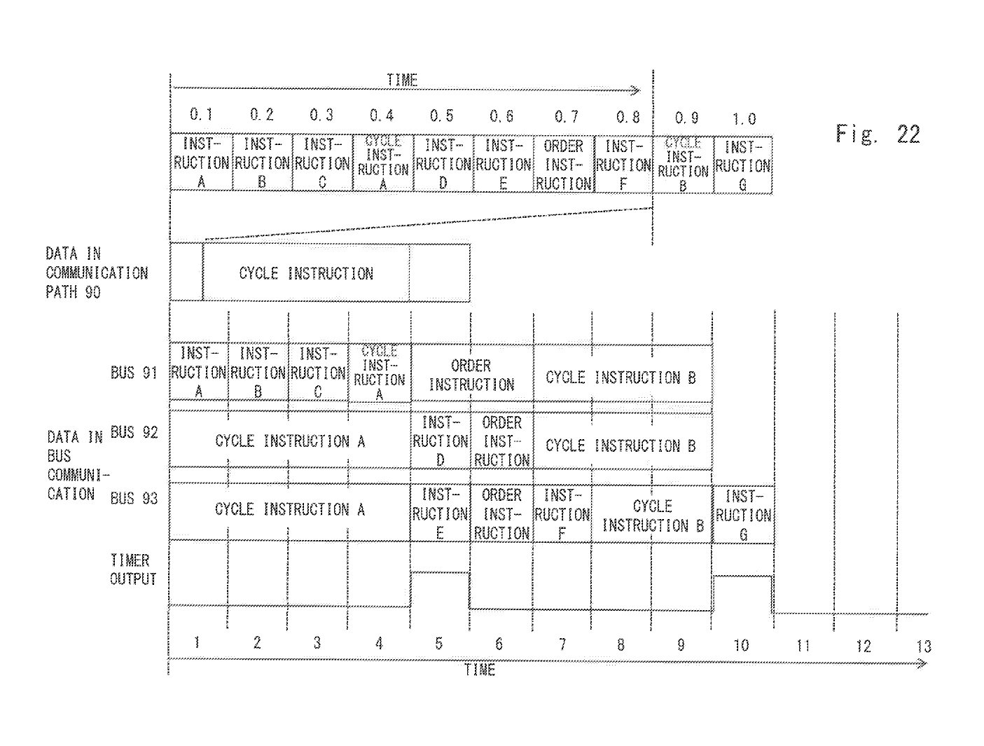

Next, an execution order of instructions according to the fifth embodiment will be described with reference to FIG. 22. With reference to FIG. 22, an example in which the instruction generation unit 31 of the external calculator 3 generates instructions A to G in this order will be described. In this example, the instructions E and F are the instructions that should be executed in an execution order. Further, the instructions C, D, and G are instructions that are separated and executed by a fixed cycle. In a manner similar to the example according to the fourth embodiment shown in FIG. 19, N is assumed to be one in order to simplify the descriptions. Further, in a manner similar to the example according to the fourth embodiment shown in FIG. 19, a cycle at which the timer 25 outputs the notification signal is a five unit time and indicates “time 5” and “time 10”.

In this case, the dummy instruction generation function 30 inserts the cycle instruction between the instructions C and D, inserts the order instruction between the instructions E and F, and inserts the cycle instruction between the instructions D and G. Accordingly, as indicated by “data in communication path 90” in FIG. 22, the external calculator 3 transmits the instructions one by one to the interface board 2 through the communication path 90 in the order of the instruction A, the instruction B, the instruction C, the cycle instruction A, the instruction D, the instruction E, the order instruction, the instruction F, and the cycle instruction B. In this case, as the states from “time 1” to “time 4” are the same as those in the example shown in FIG. 19 except that the dummy instructions are replaced by the cycle instructions, the descriptions thereof are omitted.

### (Time 5)

The timer 25 notifies the timing adjusting function 23 of a passage of a time of the fixed cycle. Thus, as the instructions transmitted from all of the bus instruction buffers 22a to 22c are the cycle instructions, and the notification is transmitted from the timer 25, the timing adjusting function 23 resumes the operations of the bus instruction buffers 22a to 22c.

Then, the order instruction stored in the bus instruction buffer 22a is transmitted to the bus 91. The instruction D stored in the instruction buffer 22b is transmitted to the bus 92. The bus instruction buffer 22c also transmits the instruction E to the bus 93.

### (Time 6)

The order instruction stored in the bus instruction buffer 22b is transmitted to the bus 92. The order instruction stored in the bus instruction buffer 22c is transmitted to the bus 93. Thus, the instructions transmitted from all of the bus instruction buffers 22a to 22c are the order instructions. Accordingly, although the timer 25 has not transmitted the notification to the timing adjusting function 23, the timing adjusting function 23 resumes the operations of the bus instruction buffers 22b and 22c.

### (Time 7)

The cycle instruction stored in the bus instruction buffer 22a is transmitted to the bus 91. On the other hand, the cycle instruction stored in the bus instruction buffer 22b, which has resumed its operation, is transmitted to the bus 92. The bus instruction buffer 22c also transmits the instruction F to the bus 93.

### (Time 8) to (Time 9)

The cycle instruction stored in the bus instruction buffer 22c is transmitted to the bus 93. Although the instructions transmitted from all of the bus instruction buffers 22a to 22c are the cycle instructions, the timer 25 has not transmitted the notification to the timing adjusting function 23. The dummy instruction evaluation units 233a to 233c of the timing adjusting function 23 suspend the operations of the bus instruction buffers 22a to 22c that transmit the cycle instructions.

### (Time 10)

The timer 25 notifies the timing adjusting function 23 of a passage of a time of the fixed cycle. Thus, as the instructions transmitted from all of the bus instruction buffers 22a to 22c are the cycle instructions, and the notification is transmitted from the timer 25, the timing adjusting function 23 resumes the operations of the bus instruction buffers 22a to 22c. Then, the bus instruction buffer 22b transmits the instruction G to the bus 92.

According to the abovementioned module control system 1 of the fifth embodiment, as illustrated above, it is possible to combine the two cases in which: (1) the user simply wants to keep an order of instructions, and (2) the user wants to separate instructions by each control cycle. For example, when the instruction D is the sensor value acquisition instruction and the instruction G is the motor drive instruction, instructions executed by each control cycle can be separated into the sensor value acquisition instruction and the motor drive instruction. Moreover, like the instructions E and F, instructions may be executed simply in order.

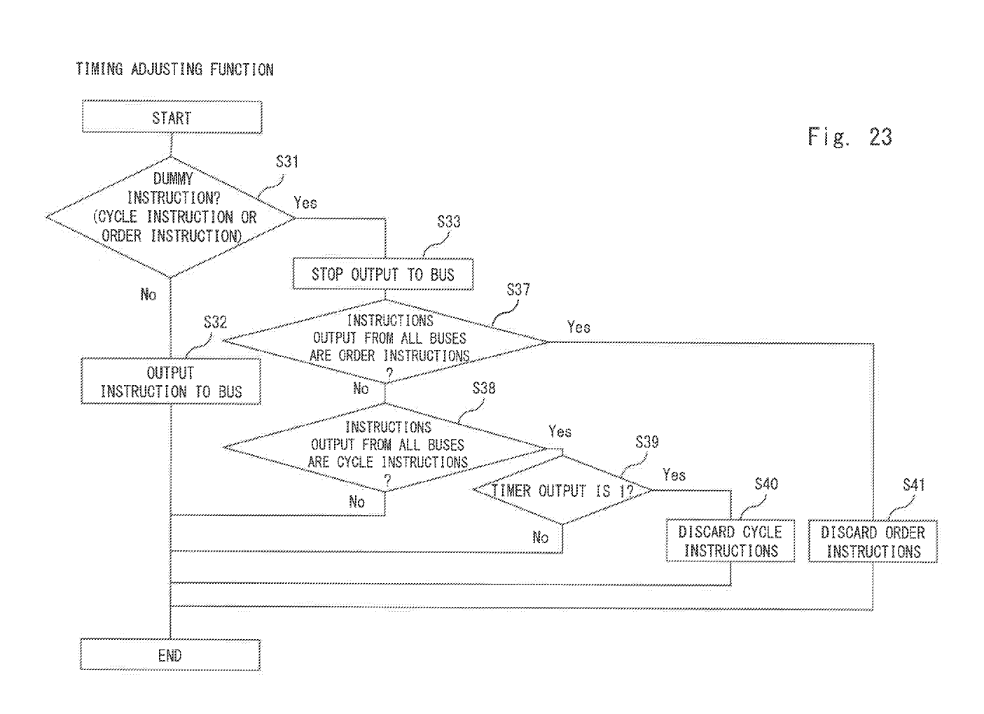

Next, an operation of the timing adjusting function 23 of the interface board 2 according to the fifth embodiment will be described with reference to FIG. 23. An operation of the timing adjusting function 23 according to the fifth embodiment further includes the steps S36 to S40 in place of the steps S34 to S35 following the step S33 of the operation of the timing adjusting function 23 according to the third embodiment shown in FIG. 17.

That is, the timing adjusting function 23 evaluates as to whether or not the order instructions are output from all of the bus instruction buffers 22a to 22c (S37). When the timing adjusting function 23 determines that the dummy instructions are output from all of the bus instruction buffers 22a to 22c (S37: Yes), the timing adjusting function 23 instructs the bus instruction buffers 22a to 22c to discard the order instructions (S41). Then, the bus instruction buffers 22a to 22c resume outputting the instructions to the buses 91 to 93, respectively (S32). On the other hand, when the timing adjusting function 23 determines that the order instructions are not output from all of the bus instruction buffers 22a to 22c (S37: No), the timing adjusting function 23 does not instruct the bus instruction buffers 22a to 22c to discard the order instructions.

Next, the timing adjusting function 23 evaluates as to whether or not the cycle instructions are output from all of the bus instruction buffers 22a to 22c, and the output of the timer 25 is one (a high level) (S38 and S39). When the timing adjusting function 23 determines that the cycle instructions are output from all of the bus instruction buffers 22a to 22c and the output of the timer 25 is one (a high level) (S38: Yes and S39: Yes), the timing adjusting function 23 instructs the bus instruction buffers 22a to 22c to discard the cycle instructions (S40). Then, the bus instruction buffers 22a to 22c resume outputting the instructions to the buses 91 to 93, respectively (S32). On the other hand, when the timing adjusting function 23 determines that the dummy instructions are not output from all of the bus instruction buffers 22a to 22c or the output of the timer 25 is not one (a high level) (S38: No or S39: No), the timing adjusting function 23 does not instruct the bus instruction buffers 22a to 22c to discard the cycle instructions.

As described above, in the fifth embodiment, when the dummy instruction is the order instruction, the timing adjusting function 23 stops an output of instructions from the bus instruction buffer 22a, an instruction output therefrom has become the order instruction, until the instructions output from all of the bus instruction buffers 22a to 22c become the order instructions regardless of whether or not the timer 25 has output the notification signal. Further, the timing adjusting function 23 stops an output of instructions from the bus instruction buffer 22a, an instruction output therefrom has become the cycle instruction, until the instructions output from all of the bus instruction buffers 22a to 22c become the cycle instructions and the timer outputs the notification signal.

By doing so, when the dummy instruction is the order instruction, as described in the first and second embodiments, it is possible to perform control when (1) the user simply wants to execute instructions in order, while when the dummy instruction is the cycle instruction, as described in the third and fourth embodiments, it is possible to perform control when (2) the user wants to separate instructions by each control cycle. Therefore, the control (1) when the user simply wants to execute instructions in order and the control (2) when the user wants to separate instructions by each control cycle can be combined.

### MODIFIED EXAMPLE OF FIFTH EMBODIMENT

Also in the fifth embodiment, in a manner similar to the example shown in FIG. 11, the module control system 1 may be configured in such a way that the external calculator 3 is connected to the interface board 2 with the processing device 5 interposed therebetween.

In this case, in a manner similar to the example shown in FIG. 20, the processing device 5 instead of the external calculator 3 may include the cycle instruction detection unit 34. When the cycle instruction detection unit 34 detects a dummy instruction N before the timing adjusting function 23 detects a different dummy instruction, the processing device 5 suspends transmitting the instructions accumulated in the instruction memory 50. Further, the processing device 5 resumes transmitting the instructions accumulated in the instruction memory 50 when the cycle instruction detection unit 34 receives the clear signal.

Further, also in the fifth embodiment, as shown in FIG. 12, the module control system 1 may be configured in such a way that when the processing device 5 executes the executable program that is generated by the compiler of the external calculator 3 collectively interpreting the source program 311, the instructions are transmitted to the interface board 2. In this case, a process for suspending the transmission of the instructions when the cycle instruction N before the timing adjusting function 23 detects the different cycle instruction may be included in the executable program, so that the CPU of the processing device 5 can suspend transmitting the instructions in response to transmission of the cycle instruction N before the timing adjusting function 23 detects the different cycle instruction. In addition, a process for resuming the transmission of the instructions in response to the clear signal from the interface board 2 may be included in the executable program, so that the CPU of the processing device 5 can resume transmitting the instructions in response to the clear signal.

### Sixth Embodiment

Next, a sixth embodiment will be described. In the following descriptions, the same contents as those in the first to fifth embodiments will be omitted as appropriate.

In the fifth embodiment, the order instruction and the cycle instruction are prepared as the dummy instructions. As the order instruction and the cycle instructions are normally distributed to all of the bus instruction buffers 22a to 22c in the order they are transmitted from the external calculator 3 through the transmission control function 20, the order instruction and the cycle instruction will not be mixed as the dummy instructions output at the same period from the bus instruction buffers 22a to 22c. However, if there is a processing error due to power noise or the like, the order instruction and the cycle instruction may be mixed as the dummy instructions output at the same period from the bus instruction buffers 22a to 22c. There is a problem in this case in the fifth embodiment that the suspended output of the instructions from the bus instruction buffers 22a to 22c will not be canceled, and the interface board 2 will freeze. To this end, in the sixth embodiment, a method for avoiding this freeze will be described.

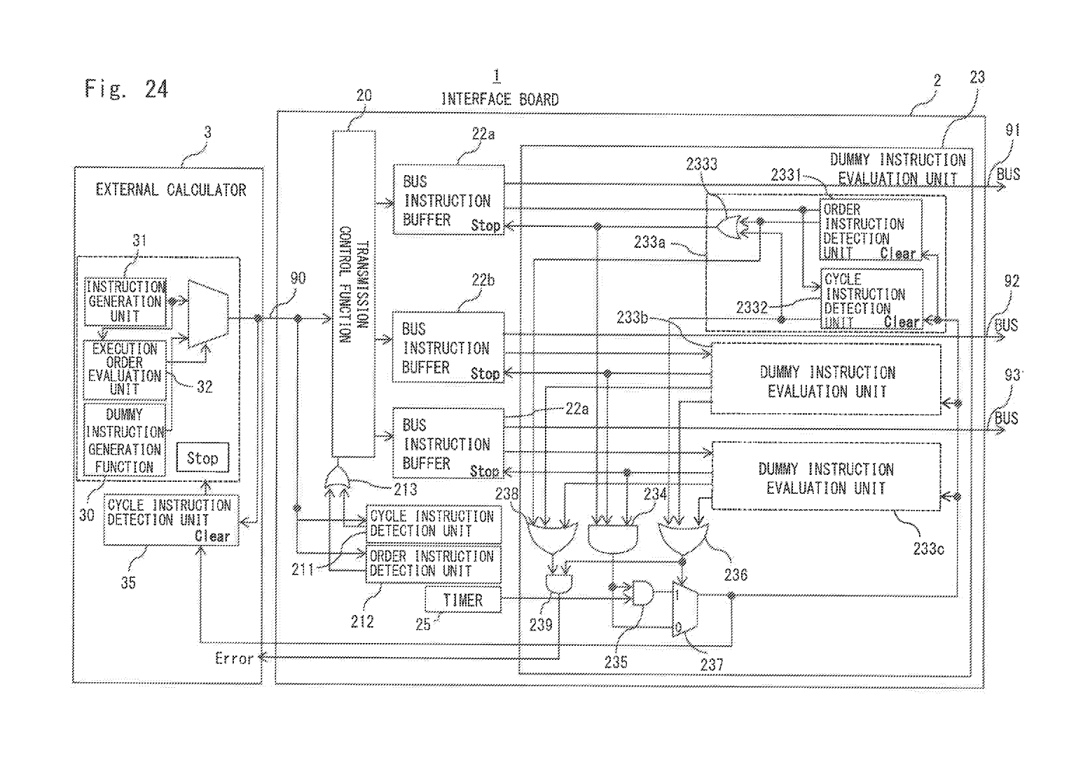

As shown in FIG. 24, a difference of the interface board 2 according to the sixth embodiment from the interface board 2 according to the fifth embodiment is that the interface board 2 according to the sixth embodiment further includes an OR circuit 238 and an AND circuit 239 in addition to the components included in the interface board 2 according to the fifth embodiment.

In the sixth embodiment, each of order instruction detection units 2331 of the dummy instruction evaluation units 233a to 233c outputs a signal also to the OR circuit 238. Further, the OR circuit 236 outputs a signal also to the AND circuit 239.

That is, the dummy instruction evaluation unit 233 evaluates as to whether or not the instruction output from the corresponding bus instruction buffer 22 is either the order instruction or the cycle instruction. When the instruction is the order instruction, the dummy instruction evaluation unit 233 outputs a suspension signal to the OR circuit 238, while when the instruction is the cycle instruction, the dummy instruction evaluation unit 233 outputs a suspension signal to the OR circuit 236.

The OR circuit 238 outputs a signal generated by ORing the signals input from the order instruction detection units 2331 of the respective the dummy instruction evaluation units 233a to 233c to the AND circuit 239. When the notification signal is input from at least one of the dummy instruction evaluation units 233a to 233c, the OR circuit 238 outputs a notification signal to the AND circuit 239. On the other hand, when the notification signal is not input from any of the dummy instruction evaluation units 233a to 233c, the OR 238 circuit does not output the notification signal to the AND circuit 239.

The AND circuit 239 transmits a signal generated by ANDing the signals input from the OR circuits 236 and 238 to the external calculator 3. When the notification signals are input from both of the OR circuits 236 and 238, the AND circuit 239 outputs the notification signal to the external calculator 3. On the other hand, when the notification signal is not input from at least one of the OR circuits 236 and 238, the AND circuit 239 does not output the notification signal to the external calculator 3. That is, the AND circuit 239 transmits the notification signal to the external calculator 3 when results of the evaluation by the dummy instruction evaluation units 233a to 233c as to whether the dummy instruction is the order instruction or the cycle instruction are inconsistent.

To be more specific, the OR circuit 238 and the AND circuit 239 operate, for example, as described below. When the high level signal is input from at least one of the dummy instruction evaluation units 233a to 233c, the OR circuit 238 outputs a high level signal to the AND circuit 239. On the other hand, when the low level signals are input from all of the dummy instruction evaluation units 233a to 233c, the OR circuit 238 outputs a low level signal to the AND circuit 239.

When the high level signals are input from both of the OR circuits 236 and 238, the AND circuit 235 outputs a high level signal to the external calculator 3. On the other hand, when the low level signal is input from at least one of the OR circuits 236 and 238, the AND circuit 235 outputs a low level signal to the external calculator 3. Accordingly, the high level signal serves as the notification signal.

The notification signal from the AND circuit 239 serves as a signal for notifying the external calculator 3 of an abnormality. In this way, in the sixth embodiment, the external calculator 3 is notified of the abnormality when the results of evaluation by the dummy instruction evaluation units 233a to 233c are inconsistent.

In this way, the external calculator 3 can, for example, reset the interface board 2 in response to the notification signal from the AND circuit 239 of the interface board 2. Therefore, in a configuration in which the output of the instructions are made to wait until all of the dummy instruction evaluation units 233a to 233c evaluate that either the order instructions or the cycle instructions are output, the interface board 2 will not freeze.

### MODIFIED EXAMPLE OF SIXTH EMBODIMENT

Also in the sixth embodiment, in a manner similar to the fifth embodiment, the external calculator 3 may be connected to the interface board 2 with the processing device 5 interposed therebetween. Further, the processing device 5 instead of the external calculator 3 may include the cycle instruction detection unit 34. Furthermore, the processing device 5 may execute the executable program that is generated by the compiler of the external calculator 3 collectively interpreting the source program 311.

### Seventh Embodiment

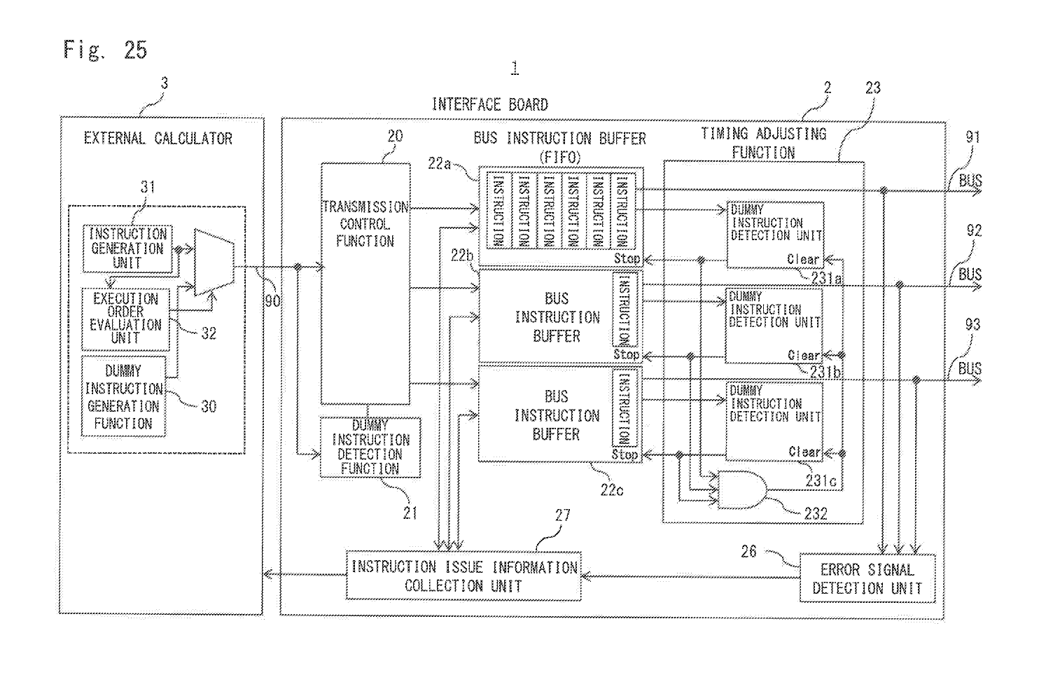

Next, a seventh embodiment will be described. In the following descriptions, the same contents as those in the first embodiment will be omitted as appropriate. The configurations of the interface board 2 and the external calculator 3 of the module control system 1 according to the seventh embodiment will be described with reference to FIG. 25. The interface board 2 according to the seventh embodiment further includes an error signal detection unit 26 and an instruction issue information collection unit 27 in addition to the components included in the interface board 2 according to the first embodiment.

The error signal detection unit 26 monitors the buses 91 to 93. When the error signal detection unit 26 detects an error occurred in the buses 91 to 93, the error detection unit 26 transmits a notification signal to the instruction issue information collection unit 27 in order to notify the instruction issue information collection unit 27 of the detection of the error. For example, when an error packet is defined by the communication standard of the buses 91 to 93, the error signal detection unit 26 determines that an error has occurred when detecting such an error. Alternatively, when an error packet is not defined by the communication standard of the buses 91 to 93, the error signal detection unit 26 may transmit a user-defined error packet when the modules 4 detect an abnormality in the communication to thereby determine that an error has occurred when detecting the error packet.

The instruction issue information collection unit 27 collects information related to the instructions stored in the bus instruction buffers 22a to 22c in response to the notification signal from the error signal detection unit 26. The information may be collected from all of the bus instruction buffers 22a to 22c or from only the bus instruction buffer 22 corresponding to the bus in which an abnormality is detected by the error signal detection unit 26. Then, the instruction issue information collection unit 27 transmits a notification signal to the external calculator 3 in order to notify the external calculator 3 of the error. This notification signal includes the collected information. This information indicates, for example, types and the number of instructions stored in the bus instruction buffers 22a to 22c.

As described above, in the seventh embodiment, the error signal detection unit 26 detects an abnormality in the buses 91 to 93 between the bus instruction buffers 22a to 22c and the group of modules 4. When the abnormality is detected by the error signal detection unit 26, the instruction issue information collection unit 27 collects the information related to the instructions stored in the bus instruction buffers 22a to 22c.

By doing so, the external calculator 3 can recognize the kind of the instruction transmitted in which the error has occurred. It is thus possible for the external calculator 3 to, for example, reset the bus instruction buffers 22a to 22c of the interface board 2 and then execute a recovery process such as retransmitting instructions from the instruction in which the error has occurred.

### MODIFIED EXAMPLE OF SEVENTH EMBODIMENT

Also in the seventh embodiment, in a manner similar to the example shown in FIG. 11, a module control system 1 may be configured in such a way that the external calculator 3 is connected to the interface board 2 with the processing device 5 interposed therebetween.

In this case the instruction issue information collection unit 27 transmits the notification information also to the processing device 5 (not shown). The processing device 5 suspends transmitting the instructions accumulated in an instruction memory 50 in response to the notification signal from the instruction issue information collection unit 27. Then, the external calculator 3 may execute a recovery process such as by resetting the bus instruction buffers 22a to 22c of the interface board 2 and the instruction memory 50 of the processing device 5, and then retransmitting the instructions from the instruction in which the error has occurred.

Further, in a manner similar to FIG. 12, the module control system 1 may be configured in such a way that when the processing device 5 executes the executable program that is generated by the compiler of the external calculator 3 collectively interpreting the source program 311, the instructions are transmitted to the interface board 2. In this case, a process for suspending the transmission of instructions in response to the notification signal from the interface board 2 may be included in the executable program, so that the CPU of the processing device 5 can suspend transmitting the instructions in response to the notification signal. Alternatively, an abnormality process may be included in the executable program, and when the CPU of the processing device 5 receives the notification signal while executing the executable program, the CPU may perform a recovery process by, for example, resetting the bus instruction buffers 22a to 22c of the interface board 2 in the abnormality process and then retransmitting the instructions from the instruction in which the error has occurred.

### Eighth Embodiment

Next, an eighth embodiment will be described. In the following descriptions, the same contents as those in the first embodiment will be omitted as appropriate.

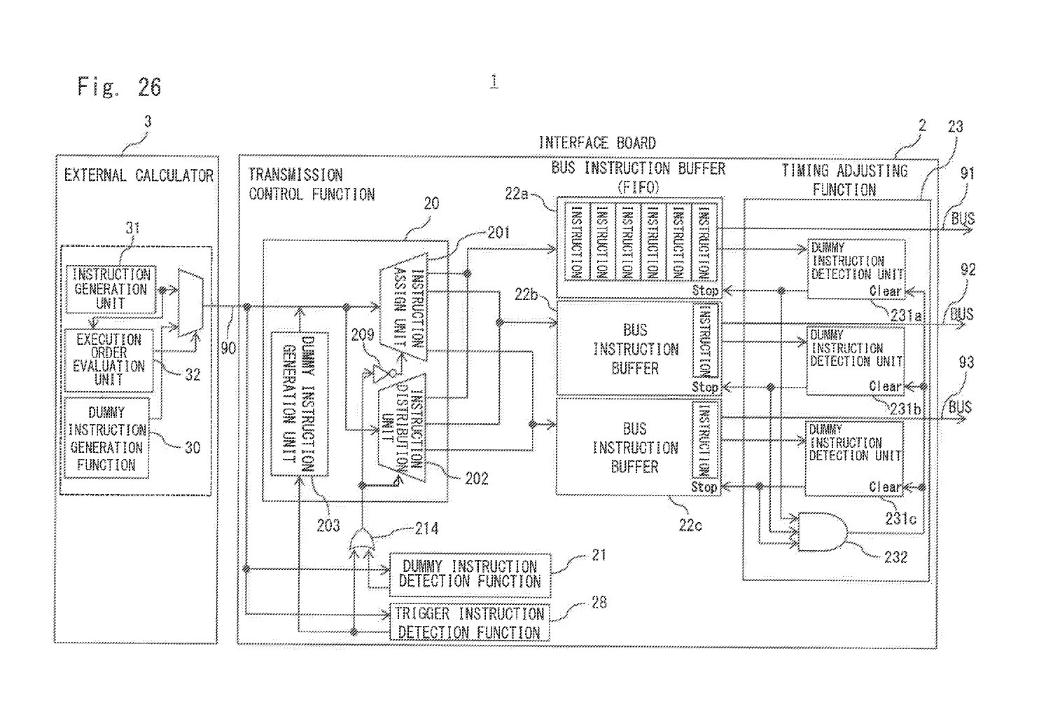

The configurations of the interface board 2 and the external calculator 3 of the module control system 1 according to the eighth embodiment will be described with reference to FIG. 26. As shown in FIG. 26, a difference of the interface board 2 according to the eighth embodiment from the interface board 2 according to the first embodiment is that the interface board 2 according to the eighth embodiment further includes a trigger instruction detection function 28 and an OR circuit 214 in addition to the components included in the interface board 2 according to the first embodiment. A difference of the transmission control function 20 according to the eighth embodiment from the transmission control function 20 according to the first embodiment is that the transmission control function 20 according to the eighth embodiment further includes a dummy instruction generation unit 203 in addition to the components included in the transmission control function 20 according to the first embodiment.

When an instruction input to the transmission control function 20 is a trigger instruction, the trigger instruction detection function 28 outputs a broadcast instruction signal to the dummy instruction generation unit 203 and the OR circuit 214, while when the input instruction is not the trigger instruction, the trigger instruction detection function 28 does not output the broadcast instruction signal.

The OR circuit 214 outputs a signal generated by ORing the signals input from the dummy instruction detection function 21 and the trigger instruction detection function 28 to an instruction assign unit 201 and an instruction distribution unit 202. That is, in the eighth embodiment, the signal output from the dummy instruction detection function 21 is input to the OR circuit 214 and not to the instruction assign unit 201 and the instruction distribution unit 202, to which the signal output from the dummy instruction detection function 21 is input in the first embodiment.

When the broadcast signal is input from at least one of the dummy instruction detection function 21 and the trigger instruction detection function 28, the OR circuit 214 outputs a broadcast signal to the instruction assign unit 201 and the instruction distribution unit 202. On the other hand, when the broadcast instruction signal is not input from either of the dummy instruction detection function 21 or the trigger instruction detection function 28, the OR circuit 214 does not output the broadcast instruction signal to the instruction assign unit 201 and the instruction distribution unit 202.

When the broadcast instruction signal is input from the trigger instruction detection function 28, the dummy instruction generation unit 203 generates a dummy instruction and outputs it to the instruction assign unit 201 and the instruction distribution unit 202. That is, the broadcast instruction signal from the trigger instruction detection function 28 to the dummy instruction generation unit 203 serves as a dummy instruction generation instruction signal. Note that in this case, the instruction distribution unit 202 distributes the dummy instruction input from the dummy instruction generation unit 203 to the bus instruction buffers 22a to 22c and then distributes a trigger instruction input from the external calculator 3 to the buffers 22a to 22c.

To be more specific, each of the dummy instruction detection function 21 and the trigger instruction detection function 28, which are achieved by the following circuits, outputs a signal that can be switched to a high level or a low level to the OR circuit 214. When the instruction input to the transmission control function 20 is the trigger instruction, the trigger instruction detection function 28 outputs a high level signal to the OR circuit 214. On the other hand, when the instruction input to the transmission control function 20 is not the trigger instruction, the trigger instruction detection function 28 outputs a low level signal to the OR circuit 214.

When the a signal input from at least one of the dummy instruction detection function 21 and the trigger instruction detection function 28 is the high level signal, the OR circuit 214 outputs a high level to the instruction assign unit 201 and the instruction distribution unit 202. On the other hand, when the signals input from both of the dummy instruction detection function 21 and the trigger instruction detection function 28 are the low level signals, the OR circuit 214 outputs a low level signal to the instruction assign unit 201 and the instruction distribution unit 202. Note that as described in the first embodiment, these signals are input as they are to the instruction distribution unit 202, and these signals are inverted by the inverter 209 and then input to the instruction assign unit 201. When the high level signal is input from the trigger instruction detection function 28, the dummy instruction generation unit 203 generates a dummy instruction. That is, the high level signal corresponds to the broadcast instruction signal.

With such a configuration, when the trigger instruction signal is transmitted from the external calculator 3, the dummy instructions can be stored in all of the bus instruction buffers 22a to 22c and the trigger instruction can be stored therein after the dummy instruction. As described in the above first to seventh embodiments, an order of instructions is guaranteed by making the outputs from the bus instruction buffers 22a to 22c wait by using the dummy instruction. Accordingly, the instructions following the dummy instruction are transmitted to the buses 91 to 93 at the same time, so that execution timings of the instructions can be aligned. Therefore, in the eighth embodiment, as the instruction generation unit 31 of the external calculator 3 transmits the instruction, execution timings of which by the modules 4 should be aligned, as the trigger instruction, the execution timings of the instructions can be aligned.

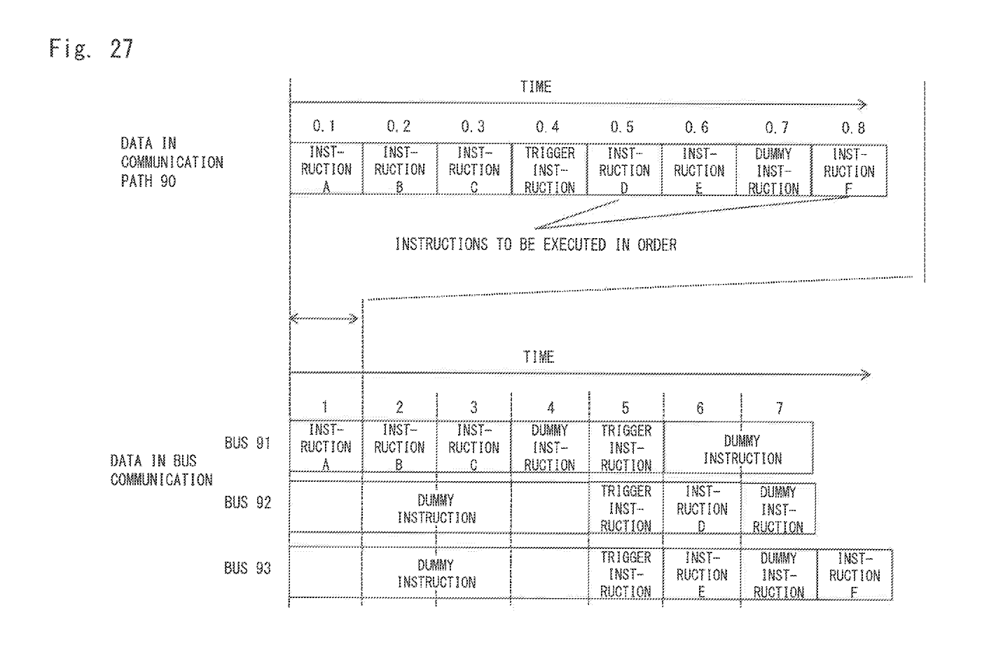

Next, an execution order of instructions according to the eighth embodiment will be described with reference to FIG. 27. With reference to FIG. 27, an example in which the instruction generation unit 31 of the external calculator 3 generates instructions A to C, a trigger instruction, and instructions D and F in this order will be described. In this example, the instructions D and F are the instructions that should be executed in an execution order.

In this case, the dummy instruction generation function 30 of the external calculator 3 inserts the dummy instruction between the instructions D and F. Accordingly, as indicated by “data in communication path 90” in FIG. 4, the external calculator 3 transmits the instructions one by one to the interface board 2 through the communication path 90 in the order of the instruction A, the instruction B, the instruction C, the trigger instruction, the instruction D, the instruction E, the dummy instruction B, and the instruction F.

In this case, the dummy instruction generation unit 203 inserts the dummy instruction between the instruction C and the trigger instruction. As states of the buses 91 to 93 from “time 1” to “time 4” are the same as those shown in FIG. 4, the descriptions thereof will be omitted.

### (Time 5)

As the operations of the bus instruction buffers 22b and 22c are resumed at the “time 4”, all of the respective bus instruction buffers 22a to 22c transmit the trigger instructions stored after the dummy instruction to the buses 91 to 93, respectively. Thus, the trigger instructions are executed at the same time by the modules 4 connected to the buses 91 to 93, respectively.

As the operation from the “time 6” onward is the same as the operation from the “time 5” in the example shown in FIG. 4, the descriptions thereof will be omitted. As described above, in the eighth embodiment, it is possible to execute the trigger instructions at the same time by making instructions wait for the dummy instructions in order to prevent overtaking of the instructions that should be executed in an execution order.

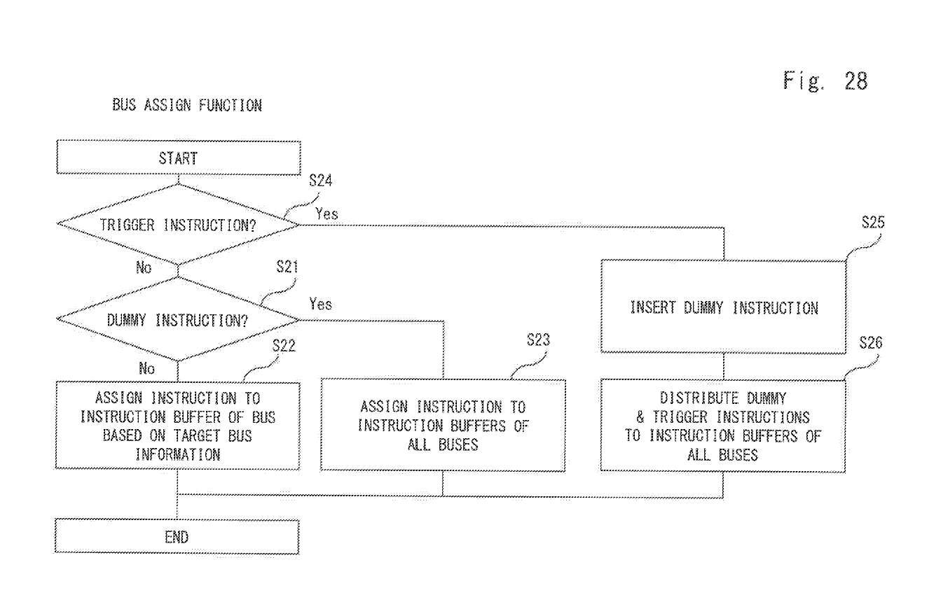

Next, operations of the transmission control function 20, the dummy instruction detection function 21, and the trigger instruction detection function 28 of the interface board 2 according to the eighth embodiment will be described with reference to FIG. 28. A difference of the operation of the interface board 2 according to the eighth embodiment from the interface board 2 according to the first embodiment shown in FIG. 2 is that the operation of the interface board 2 according to the eighth embodiment further includes the steps S24 to S26 in addition to the operation of the interface board 2 according to the first embodiment.

That is, the trigger instruction detection function 28 evaluates as to whether or not an instruction received from the external calculator 3 is a trigger instruction (S24). When the trigger instruction detection function 28 determines that the instruction received from the external calculator 3 is the trigger instruction (S24: Yes), the dummy instruction generation unit 203 generates a dummy instruction and inserts it before the trigger instruction (S25). The transmission control function 20 controls the instruction distribution unit 202 to distribute the dummy instruction and the trigger instruction to all of the buses (S26).

When the instruction received from the external calculator 3 is not a trigger instruction but is a dummy instruction (S24: No, S21: Yes), the step S23 is executed. When the instruction received from the external calculator 3 is neither a trigger instruction nor a dummy instruction (S24: No, S21: No), the step S22 is executed.

As described so far, in the eighth embodiment, when the input instruction is a trigger instruction, the transmission control function 20 inserts a dummy instruction before the trigger instruction and distributes the dummy instruction together with the trigger instruction to all of the bus instruction buffers 22a to 22c.

In this manner, by transmitting the trigger instructions to all of the buses 91 to 93 using the mechanism in which the output of the instructions is made to wait until the outputs from all of the bus instruction buffers 22a to 22c become the dummy instructions, the trigger instructions can be executed at the same time.

### MODIFIED EXAMPLE 1 OF EIGHTH EMBODIMENT

Also in the eighth embodiment, in a manner similar to the example shown in FIG. 11, the external calculator 3 may be connected to the interface board 2 with the processing device 5 interposed therebetween. Further, also in the third embodiment, in a manner similar to the example shown in FIG. 12, the module control system 1 may be configured in such a way that when the processing device 5 executes the executable program that is generated by the compiler of the external calculator 3 collectively interpreting the source program 311, the instructions are transmitted to the interface board 2.

### MODIFIED EXAMPLE 2 OF EIGHTH EMBODIMENT

In the above descriptions, although the dummy instructions are generated and inserted by the transmission control function 20 in order to align the execution timings of the trigger instructions, it is not limited to this. In the external calculator 3, the dummy instruction generation function 30 may generate the dummy instruction and insert it before the trigger instruction. By doing so, the dummy instruction generation unit 203 is no longer needed in the transmission control function 20.

### Ninth Embodiment

Next, a first configuration example, which is a more detailed configuration example of the module control system 1, will be described as a ninth embodiment.

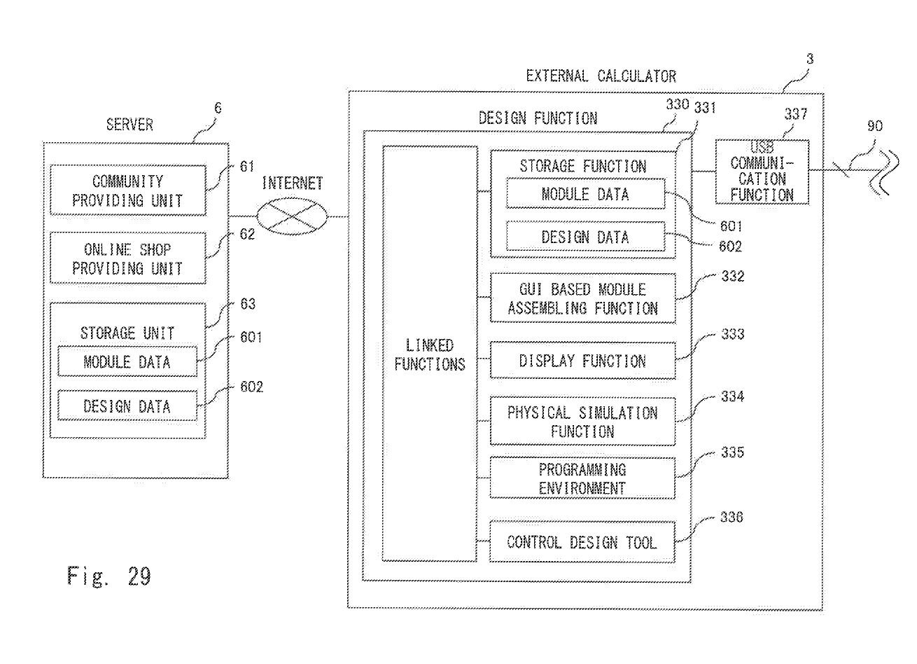

As shown in FIGS. 29 to 31, the module control system 1 according to the ninth embodiment includes the interface board 2, the external calculator 3, the plurality of modules 4, the processing device 5, and a server 6.

As shown in FIG. 29, the server 6 includes a community providing unit 61, an online shop providing unit 62, and a storage unit 63. The server 6 is connected to the external calculator 3 via the Internet.

The community providing unit 61 provides an internet community service to the external calculator 3. The online shop providing unit 62 provides an online shop service to the external calculator 3.

Module data 601, design data 602, and the like are stored in the storage unit 63. That is, the storage unit 63 includes a storage device that can store the data 601 and 602. The storage device is, for example, a memory, a hard disk, or the like. The module data 601 is data of the modules 4. The module data 601 indicates, for example, shapes, weights, and physical characteristics of the modules 4. The number of the module data pieces 601 is the same as the number of types of the modules 4. The design data 602 indicates a virtual model of the gadget built by the plurality of modules 4.

When a user of the external calculator 3 uses a community provided by the community providing unit 61, the user can share the design data 602 created by the user himself or herself with other users on the server 6. Further, the user of the external calculator 3 can purchase the design data 602, software for creating the design data, the modules 4, and the like on an online shop provided by the online shop providing unit 62.

As shown in FIG. 29, the external calculator 3 includes a design function 330 and a USB (Universal Serial Bus) communication function 337. The design function 330 includes a storage function 331, a GUI (Graphical User Interface) based module assembling function 332, a display function 333, a physical simulation function 334, a programming environment 335, and a control design tool 336. The external calculator 3 includes the design function 330 linked with these functions 331 and 336 to thereby provide an environment for the user to comfortably design the gadget and a program for operating the gadget.

The storage function 331 stores the module data 601, the design data 602, and the like acquired from the server 3. The storage function 331 includes a storage device that can store the data 601 and 602. The storage device is, for example, a memory, a hard disk, or the like.

The module assembling function 332 provides a function that enables the user to virtually assemble the modules 4 and create a virtual model of the gadget on GUI. The design data 602 indicating the virtual model created in this manner is stored in the storage function 331. The user can create the virtual model by operating an input device of the external calculator 3.

The display function 333 displays the modules 4 and the virtual model of the gadget in three-dimensional computer graphics. To be more specific, the display function 333 is achieved by the CPU of the external calculator 3 displaying images on a display device included in the external calculator 3.

The physical simulation function 334 provides a function that performs an operation simulation of the gadget by the virtual model indicated by the design data 602. The physical simulation function 334 to use the module data 601 of the modules 4 constituting the gadget to thereby carry out an operating simulation in consideration of the shapes of the modules 4.

The programming environment 335 provides an environment for the user to create the abovementioned source program 311. The programming environment 335 is, for example, an integrated development environment. The user uses the programming environment 335 to create the source program 311 by operating the input device of the external calculator 3.

The control design tool 336 is an automatic generation tool of the source program 311 for controlling the plurality of modules 4. For example, the control design tool 336 may be a tool for automatically generating the source program 311 based on the design data 602.

The USB communication function 337 enables communication compliant with the USB communication standard with the interface board 2. That is, in the ninth embodiment, an example in which the communication path 90 for connecting the external calculator 3 to the interface board 2 is a USB bus will be described.

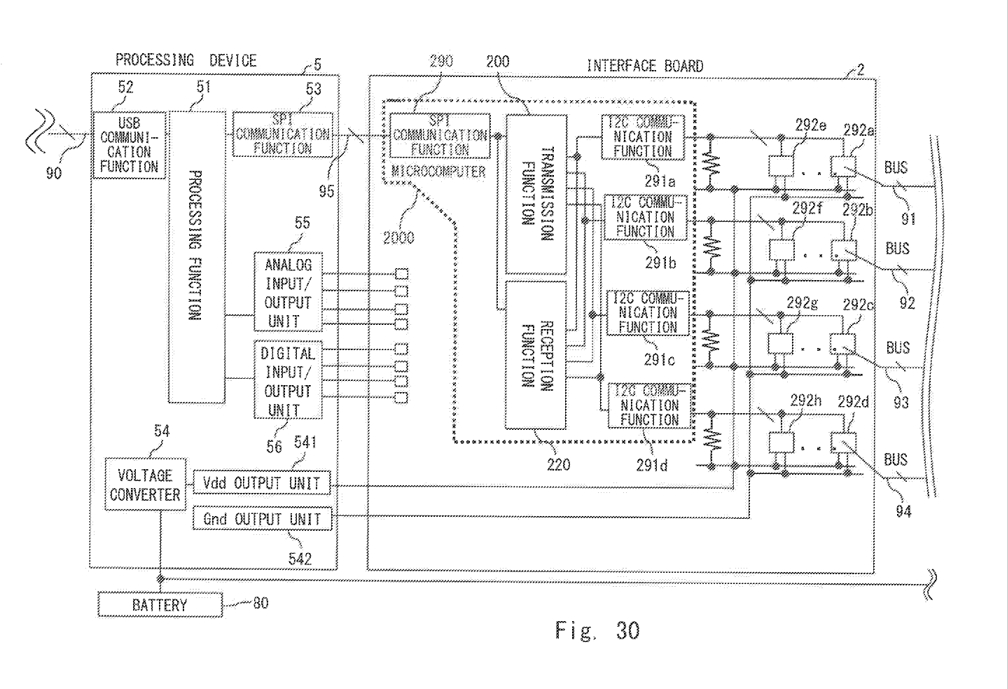

As shown in FIG. 30, the processing device 5 includes a processing function 51, a USB communication function 52, an SPI communication function 53, a voltage converter 54, an analog input/output unit 55, and a digital input/output unit 56.

The processing function 51 integrally controls the processing device 5. The processing function 51 includes a CPU, a memory, and the like (not shown). When the CPU executes a program stored in the memory, the function as the processing device 5 is carried out. For example, the processing function 51 receives instructions from the external calculator 3 through the USB communication function 52. The processing function 51 transmits the received instructions to the interface board 2 through the SPI (Serial Peripheral Interface) communication function 53. In this case, the memory included in the processing function 51 serves as the instruction memory 50. Further, when the processing function 51 executes the executable program stored in the memory by the CPU, the processing function 51 can serve as a program execution unit 301.

The USB communication function 52 enables communication compliant with the USB communication standard with the external calculator 3. The SPI communication function 53 enables communication compliant with the SPI communication standard with the interface board 2. That is, in the ninth embodiment, an example in which the communication path 95 connecting the processing device 5 to the interface board 2 is an SPI bus will be described.

The voltage converter 54 converts a voltage supplied by the battery 80 into a voltage that can be supplied to the interface board 2. A Vdd output unit 541 supplies the voltage converted by the voltage converter 54 to the interface board 2 as the power supply voltage. A Gnd output unit 542 supplies a ground voltage to the interface board 2.

The analog input/output unit 55 receives an arbitrary analog signal from a device connected to connectors of the analog input/output unit 55. The analog input/output unit 55 outputs the input analog signal to the processing function 51 and the interface board 2. The digital input/output unit 56 receives an arbitrary digital signal from a device connected to connectors the digital input/output unit 56. The digital input/output unit 56 outputs the input digital signal to the processing function 51 and the interface board 2.

Thus, it is possible to supply analog and digital signals from an external device(s) to the interface board 2 through the connectors of the processing device 5. Therefore, for example, when the processing device 5 is disposed on the interface board 2, the supply of the analog and digital signals from the external device(s) to the interface board 2 will not be interrupted.

As shown in FIG. 30, the interface board 2 includes a transmission function 200, a reception function 220, an SPI communication function 290, a plurality of I2C communication functions 291a to 291d, and connectors 292a to 292h.

The transmission function 200 and the reception function 220 are the same as those described in the first to eighth embodiments. The SPI communication function 290 enables communication compliant with the SPI communication standard with the processing device 5. The I2C communication functions 291a to 291d achieve communication compliant with the I2C communication standard with the modules 4 through the connectors 292a to 292h. With reference to FIG. 30, an example in which the modules 4 are connected to the four connectors 292a to 292d will be described. When the plurality of modules 4 are connected to the four connectors 292a to 292d, signals lines inside the interface board 2 and the plurality of modules 4 are connected to thereby form the buses 91 to 94. The connectors 292a to 292h are, typically, four pin connectors. In this case, each of the buses 91 to 94 includes two signal lines, one power supply voltage line, and one ground voltage line. The power supply voltage output by the Vdd output unit 541 is supplied to the power supply voltage lines. The ground voltage output by the Gnd output unit 542 is supplied to the ground voltage lines.

As described above, the transmission function 200 can assign or distribute and then transmit instructions received from the processing device 5 through the transmission control function 20 to the buses 91 to 94. The transmission function 200, the reception function 220, the SPI communication function 290, and the I2C communication functions 291a to 291d are achieved by, for example, a microcomputer 2000.

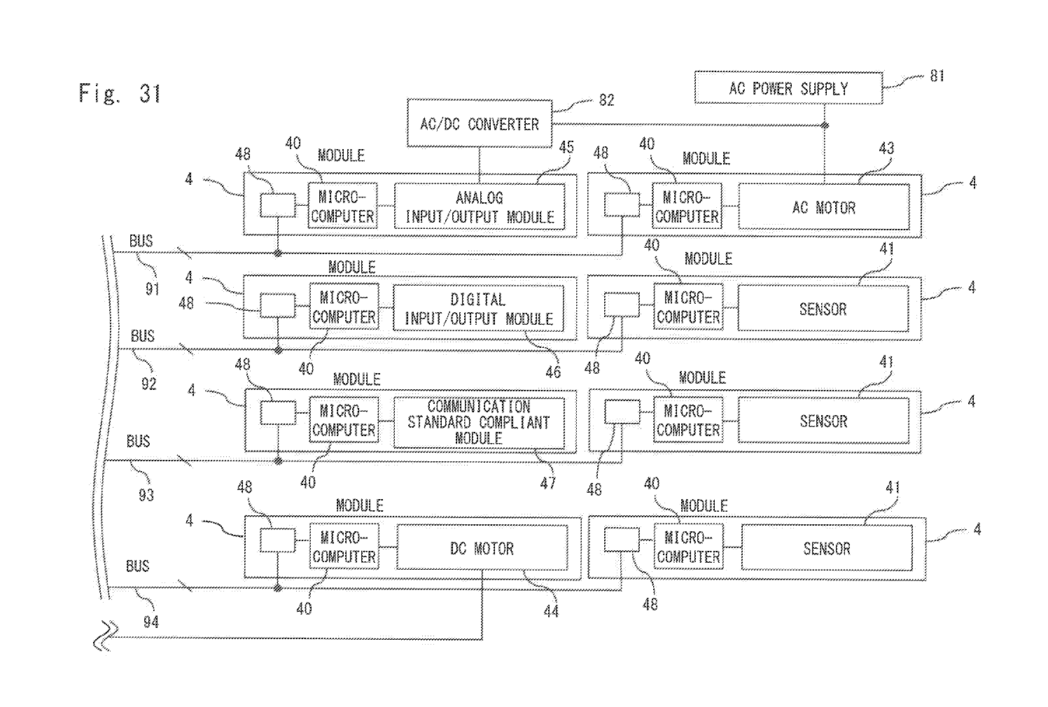

As shown in FIG. 31, the modules 4 each include a microcomputer 40 and a connector 48. As described above, when the connectors 292a to 292d of the interface board 2 are connected to the connectors 48 of the plurality of modules 4, the buses 91 to 94 are formed. The microcomputers 40 operate by the power supply voltage and the ground voltage supplied by the interface board 2 through the corresponding connectors 48. Further, the microcomputers 40 receive the instructions by signals supplied by the interface board 2 through the corresponding connectors 48 and execute them.

The modules 4 can be employed in various forms. For example, as shown in FIG. 31, the module 4 may include one or more of a sensor 41, an AC (Alternating Current) motor 43, a DC (Direct Current) motor 44, an analog input/output module 45, a digital input/output module 46, and a communication standard compliant module 47. The sensor 41 is the same as the one described in the first embodiment.

The AC motor 43 is driven by an alternating current supplied by an AC power supply 81. A DC motor 44 is driven by a direct current supplied by the battery 80. In this way, if there is a device(s) that runs short of power supplied through the buses 91 to 94 inside the modules 4, the battery 80 and the AC power supply 81 may directly supply power to such a device(s). Moreover, the plurality of modules 4 are not limited to a combination of the modules 4 each including the AC motor 43 and the modules 4 each including the DC motor 44, in which such a combination is shown in FIG. 31. There may be only the modules 4 each including the AC motor 43 or only the modules 4 each including the DC motor 44. Further, as shown in FIG. 31, the alternating current from the AC power supply 81 may be converted into a direct current by an AC/DC converter 82 and supplied to a device(s) inside the module 4 (the device is the analog input/output module 45 in the example of FIG. 31).

The analog input/output module 45 inputs and outputs analog signals from and to the external device. The digital input/output module 46 inputs and outputs digital signals from and to the external device. As described so far, the modules 4 may be connected to the external device and operate by transmitting and receiving arbitrary signals to and from the external device.
The communication standard compliant module 47 transmits and receives information to and from the external device in accordance with an arbitrary communication standard. This communication may be established by means of a cable or wirelessly. As mentioned above, the modules 4 may operate by transmitting and receiving information to and from the external device.

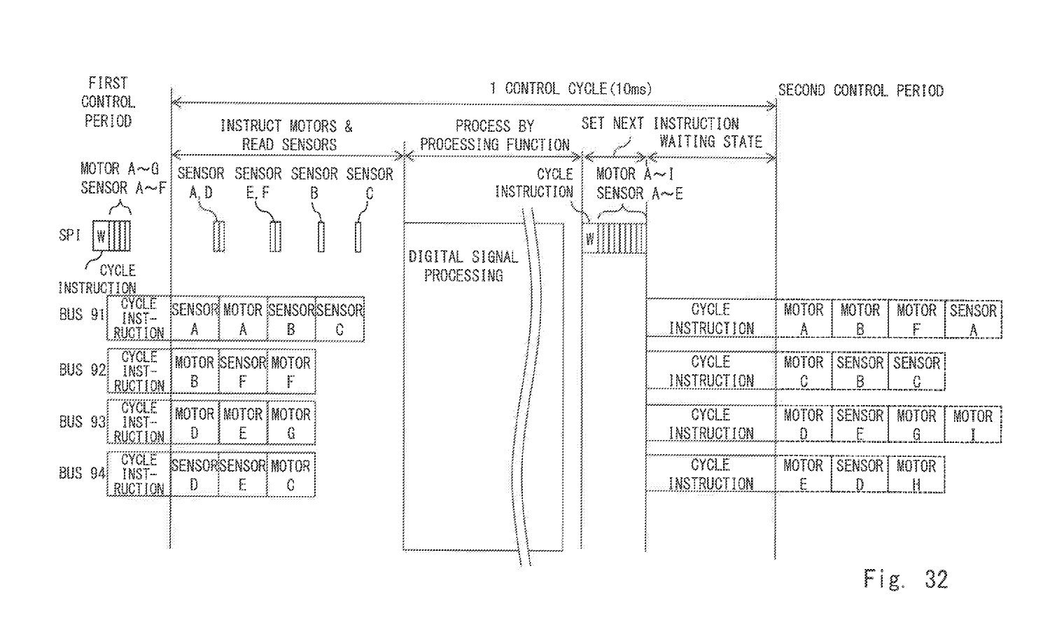

Next, an operation example of the module control system 1 according to the ninth embodiment will be described. The operation of the module control system 1 according to the ninth embodiment will be described with reference to FIG. 32. A period of a control cycle (e.g., 10 msec) is indicated as a “control period”.

As shown in FIG. 32, a cycle instruction, sensor value acquisition instructions A to F, and motor drive instructions A to G are transmitted from the processing device 5 to the interface board 2 in SPI communication in a first control period.

As described above, the timing adjusting function 23 make an output of instructions wait until instructions to all of the buses 91 to 94 will become cycle instructions. Thus, the sensor value acquisition instructions A to F and the motor drive instructions A to G following the cycle instructions are simultaneously transmitted at a timing when the instructions from all of the buses 91 to 94 become the cycle instructions and then executed by the modules 4, respectively.

At this time, sensor values A to F acquired by the sensor value acquisition instructions A to F are transmitted from the modules 4 to the processing device 5 in the SPI communication whenever necessary. Further, these sensor values are transmitted from the processing device 5 to the external calculator 3. The external calculator 3 calculates instruction values for motor drive instructions A to I in a second control cycle based on the sensor values A to F transmitted from the modules 4.

As shown in FIG. 32, the cycle instruction, the sensor value acquisition instructions A to E, and the motor drive instructions A to I are transmitted from the processing device 5 to the interface board 2 in the SPI communication in a second control period.

As described above, the timing adjusting function 23 make an output of instructions wait until instructions to all of the buses 91 to 94 will become cycle instructions. Thus, the sensor value acquisition instructions A to E and the motor drive instructions A to I following the cycle instructions are simultaneously transmitted at a timing when the cycle instructions are output from all of the buses 91 to 94 and then executed by the modules 4, respectively.

In this manner, the control using the cycle instructions enables the instructions to be separated by each control cycle. By repeatedly executing these instructions, the gadget (the modules 4) can be controlled. This control is suitable for, for example, motor control based on the sensor values shown in FIG. 32. In the motor control, acquisition of the sensor values and driving of the motors based on the sensor values are repeated. On the other hand, the control using the cycle instructions enables the acquisition of sensor values and driving of the motors to be repeated by each control cycle, thereby realizing preferable motor control. Further, as described above, in a control period, by simultaneously executing the motor drive instruction and the sensor value acquisition instruction for acquiring a sensor value to be used in generating the motor drive instruction in a next control period, the motor can be consecutively driven though the respective control cycles.

The contents described in the first to eighth embodiments can be carried out without hindrance in an integrated system in which a development environment is embedded as in the module control system 1 according to the ninth embodiment.

### Tenth Embodiment

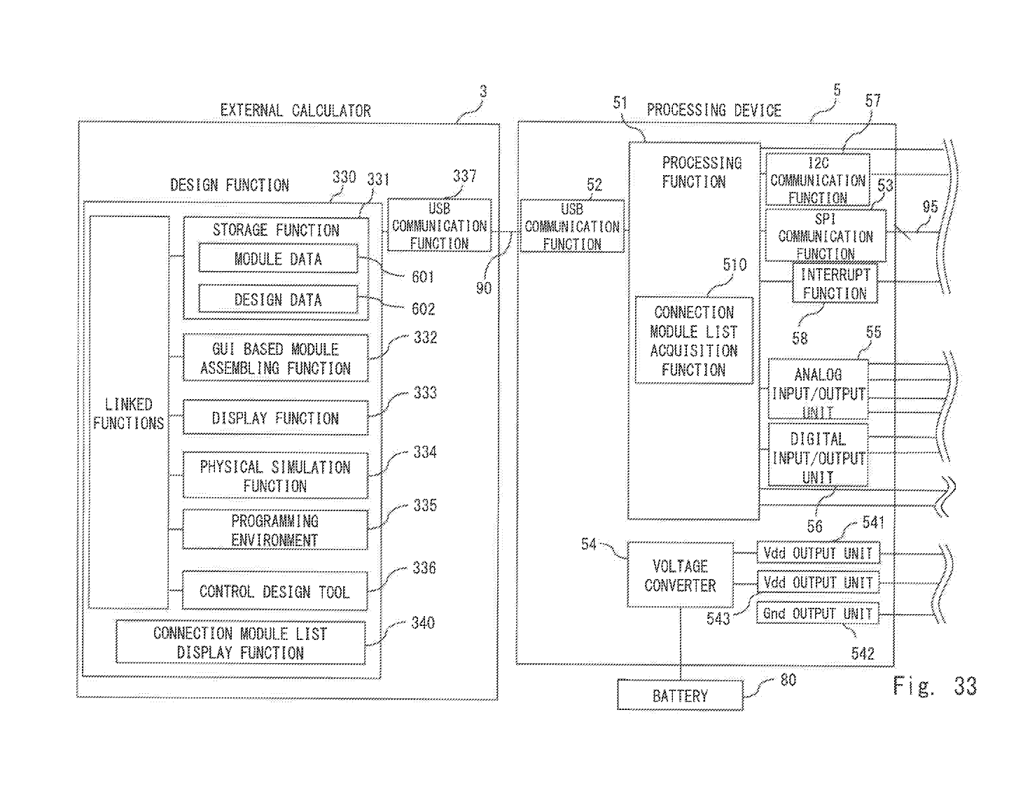

Next, a tenth embodiment will be described. A second configuration example, which is a more detailed configuration example of the module control system 1, will be described as the tenth embodiment. A configuration of the module control system 1 according to the tenth embodiment will be described with reference to FIGS. 33 to 35. Although the server 6 is not shown in FIG. 33, it is obvious that the module control system 1 according to the tenth embodiment may include the server 6.

As shown in FIG. 33, a difference of the external calculator 3 according to the tenth embodiment from the external calculator 3 according to the ninth embodiment is that the external calculator 3 according to the tenth embodiment further includes a connection module list display function 340 in addition to the components included in the external calculator 3 according to the ninth embodiment. The connection module list display function 340 displays a list of the plurality of modules 4 connected to the interface board 2 by the display function 333.

As shown in FIG. 33, a difference of the processing device 5 according to the tenth embodiment from the processing device 5 according to the ninth embodiment is that the processing device 5 according to the tenth embodiment further includes an I2C communication function 57, an interrupt function 58, and a Vdd output function 543 in addition to the components included in the processing device 5 according to the ninth embodiment.

The I2C communication function 57 achieves communication compliant with the I2C communication standard with the interface board 2. That is, in the tenth embodiment, a communication path through which instructions are transmitted is included in addition to the communication path 95 compliant with the SPI communication standard.

The interrupt function 58 receives an interrupt signal from the interface board 2.

The Vdd output unit 543 supplies a voltage converted by the voltage converter 54 to the interface board 2 as the power supply voltage. The voltage converter 54 according to the tenth embodiment converts a voltage supplied by the battery 80 and generates a first voltage and a second voltage that differs from the first voltage. The Vdd output unit 541 supplies the first voltage to the interface board 2, and the Vdd output unit 542 supplies the second voltage to the interface board 2.

The connection module list acquisition function 510 acquires a list of the plurality of modules 4 connected to the interface board 2 and transmits list information indicating the list of the plurality of modules 4 to the external calculator 3. Thus, the connection module list display function 340 of the external calculator 3 can display the list of the plurality of modules 4 based on the list information received from the processing device 5. This enables the user to easily check the plurality of modules 4 constituting the gadget.

Note that the connection module list acquisition function 510 transmits a module information reply instruction to each of the plurality of modules 4 so as to acquire the list of the plurality of modules 4. Each of the plurality of modules 4 replies to the module information reply instruction from the processing device 5 with information identifying itself. This information is, for example, a module ID uniquely allocated to each of the modules 4. In this case, a list of module IDs of the plurality of modules 4 is acquired as the list of the plurality of modules 4.

The list of the modules 4 is acquired by, for example, including a process for transmitting the module information reply instruction in the abovementioned executable program and the processing function 51 executing the executable program.

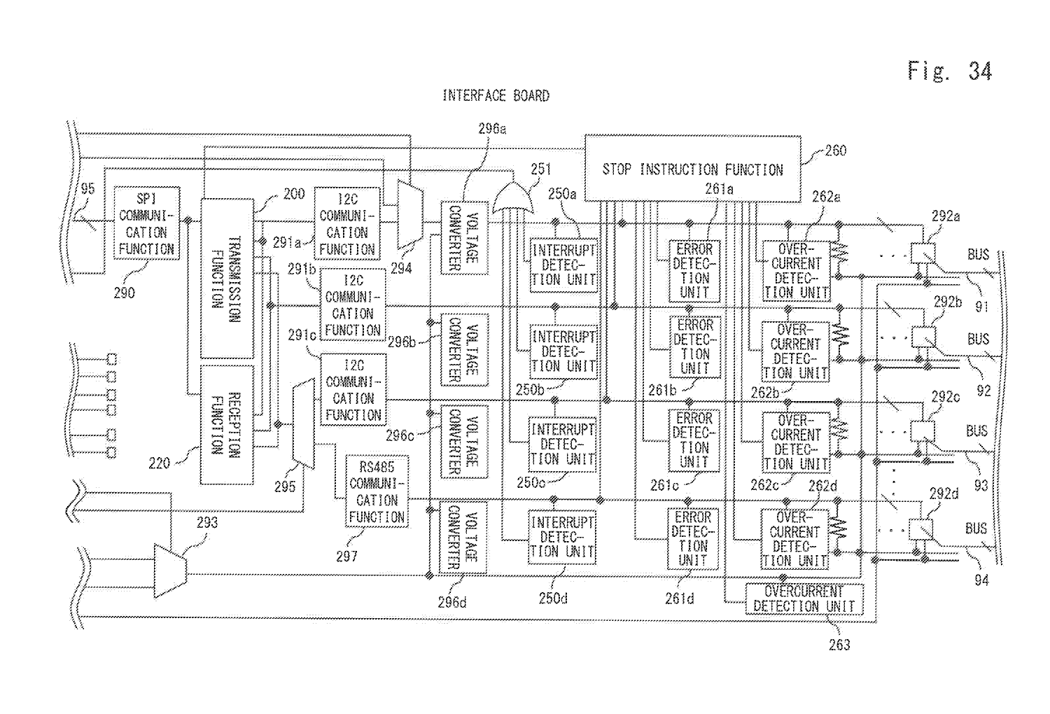

As shown in FIG. 34, the interface board 2 according to the tenth embodiment further includes a plurality of interrupt detection units 250a to 250d, an OR circuit 251, a suspension instruction function 260, a plurality of error detection units 261a to 261d, a plurality of overcurrent detection units 262a to 262d, an overcurrent detection unit 263, selection circuits 293 and 294, an assign circuit 295, and a plurality of voltage converters 296a to 296d in addition to the components included in the interface board 2 according to the ninth embodiment. The interface board 2 according to the tenth embodiment includes an RS485 communication function 297 in place of the I2C communication function 291d that is included in the interface board 2 according to the ninth embodiment.

Each of the plurality of interrupt detection units 250a to 250d detects an interruption packet transmitted to the corresponding buses 91 to 94. When the interrupt detection units 250a to 250d detects an interruption packet, the corresponding one of the interrupt detection units 250a to 250d outputs an interruption signal to the OR circuit 251. The OR circuit 251 transmits a signal generated by ORing the signals from the plurality of interrupt detection units 250a to 250d to the interrupt function 58 of the processing device 5. That is, when the interruption signal is input from at least one of the plurality of interrupt detection units 250a to 250d is input to the OR circuit 251, the OR circuit 251 transmits an interruption signal to the interrupt function 58 of the processing device 5. For example, when the module 4 detects an event that needs to be urgently dealt with, the module 4 transmits an interruption packet. Then, when the processing function 51 receives an interruption signal based on the interruption packet through the interrupt function 58, the processing function 51 can promptly deal with the event.

When the error detection units 261a to 261d detect an error, and when the overcurrent detection units 262a to 262d and 263 detect an overcurrent, the suspension instruction function 260 transmits a suspension instruction to the processing device 5. In response to the suspension instruction from the suspension instruction function 260 of the interface board 2, the processing device 5 performs an abnormality process. The abnormality process is, for example, resetting the interface board 2, suspending the gadget (the plurality of modules 4), or the like. By doing so, malfunctions of the gadget can be prevented.

Each of the plurality of error detection units 261a to 261d detects an error packet transmitted to the corresponding one of the buses 91 to 94 as the abovementioned error. Each of the plurality of overcurrent detection units 262a to 262d detects an overcurrent of a signal transmitted to the corresponding one of the buses 91 to 94 from the corresponding one of the voltage converters 296a to 296d as the abovementioned error. The overcurrent detection unit 263 detects an overcurrent of a current supplied together with the power supply voltage from the Vdd output units 541 and 543 to the buses 91 to 94 through the selection circuit 293 as the abovementioned error.

A selection unit 293 selects one of the voltage supplied by the Vdd output unit 541 and the voltage supplied by the Vdd output unit 543 and supplies the selected voltage to each of the buses 91 to 94 as the power supply voltage. The selection of the voltage is switched by a signal output by the processing function 51 of the processing device 5 to the selection unit 293. The processing function 51 selects an appropriate voltage according to an operating voltage of the modules 4 to be used.

The selection unit 294 selects either the instruction transmitted by the I2C communication function 57 of the processing device 5 or the instruction transmitted by the I2C communication function 291a of the interface board 2 and transmits the selected instruction to the bus 91. The selection of the signal is switched by a signal input from the processing function 51 of the processing device 5 to the selection unit 294. In this way, in order to debug the operation of the modules 4, an arbitrary instruction can be transmitted to the modules 4 through the I2C communication function 57 and not through the transmission function 200.

An assign unit 295 assigns the instruction transmitted from the transmission function 200 to the I2C communication function 291c or the RS485 communication function 297. Thus, it is possible to combine the modules 4 each compliant with different communication standards from one another in the plurality of modules 4. For example, in order to use the module 4 compliant with the RS485 communication not only the modules 4 compliant with the I2C communication, the modules 4 compliant with the RS485 communication are connected to a tip of the connector 292d instead of a tip of the connector 292c. By doing so, it is possible to control the gadget composed of the modules 4 compliant with the I2C communication that are connected to the connectors 292a to 292b and the modules 4 compliant with the RS485 communication connected to the connector 292d. Note that when the gadget is composed of only the modules 4 compliant with the I2C communication, the modules 4 may be connected to the tip of the connector 292c instead of the tip of the connector 292d. One of the I2C communication function 291c and the RS485 communication function 297 to which the assign unit 295 assigns the instruction is switched by a signal input from the processing function 51 of the processing device 5 to the assign unit 295.

Each of the voltage converters 296a to 296d converts the voltage input from the selection unit 293 into a voltage that can be used for signals in the buses 91 to 94.

The RS485 communication function 292 achieves communication compliant with the RS485 communication standard with the modules 4. The RS485 communication function 297 achieves communication with the bus 94 connected to the connector 292d.

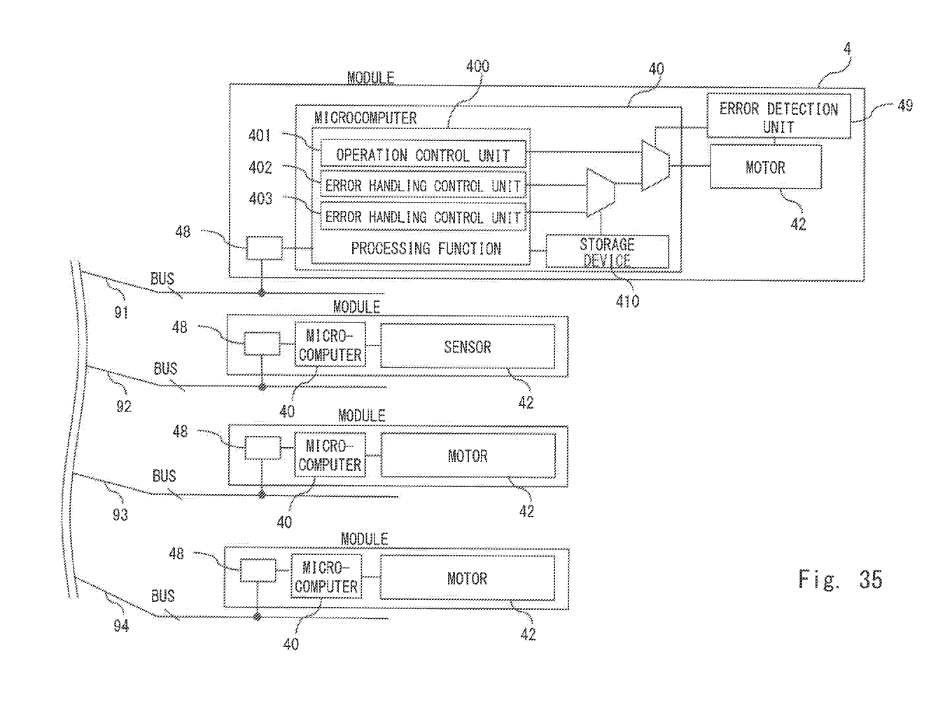

As shown in FIG. 35, the modules 4 each include a microcomputer 40, a motor 42, a connector 48, and an error detection unit 49. The connector 48 and the motor 42 are the same as those described in the first to ninth embodiments.

The microcomputer 40 includes a processing function 400 and a storage device 410. The processing function 400 includes an operation control unit 401 and error handling control units 402 and 403.

The operation control unit 401 executes control on the motor 42 in a normal state in which no abnormality is detected in the motor 42. The error handling control units 402 and 403 executes control on the motor 42 in an abnormal state in which an abnormality is detected in the motor 42.

The storage device 410 previously stores selection information indicating the control to be carried out in the abnormal state by one of the error handling control units 402 and 403. The processing function 400 determines one of the error handling control units 402 and 403 that executes the control according to the selection information stored in the storage device 410 and carries out the control. In this way, it is possible to change the control carried out by the error handling control unit 402 or 403 in the abnormal state according to the gadget in which the modules 4 are used.

The error detection unit 49 detects an abnormality of the above motor 42. When the error detection unit 49 detects an abnormality in the motor 42, the error detection unit 49 notifies the processing function 400 of the abnormality.

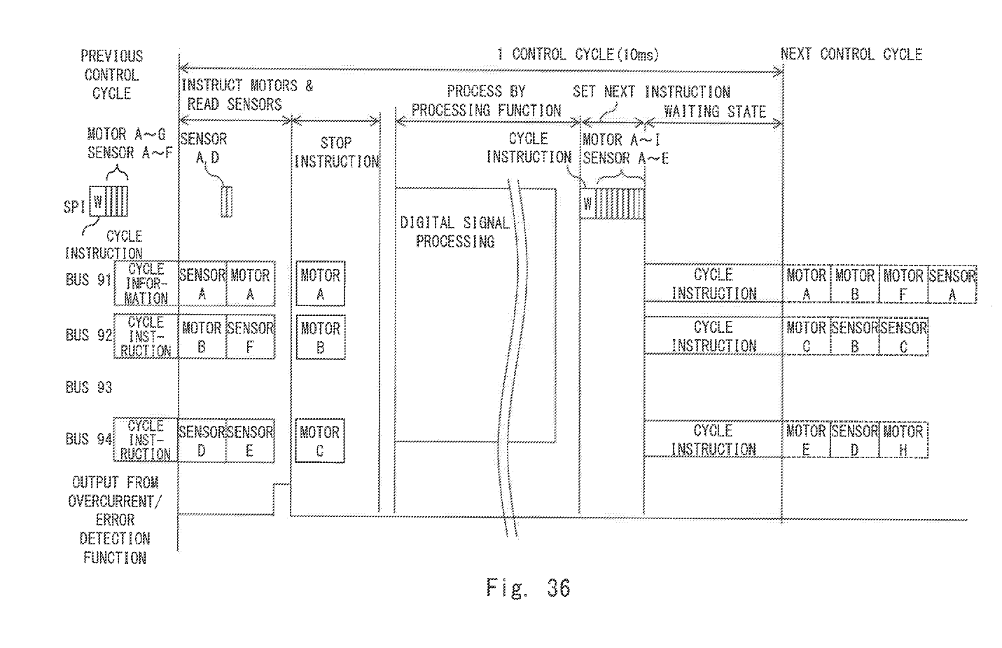

Next, a second operating example, which is a more detailed operating example of the module control system 1, will be described. An operation of the module control system 1 according to the tenth embodiment will be described with reference to FIG. 36. A period of a control cycle (e.g., 10 msec) is indicated as a “control period”.

As shown in FIG. 36, in a manner similar to the example described in the ninth embodiment with reference to FIG. 32, the cycle instruction, the sensor value acquisition instructions A to F, and the motor drive instructions A to G are transmitted from the processing device 5 to the interface board 2 in the SPI communication in a first control period.

As described above, the timing adjusting function 23 make an output of instructions wait until instructions to all of the buses 91 to 94 will become cycle instructions. Thus, the sensor value acquisition instructions A to F and the motor drive instructions A to G following the cycle instructions are simultaneously transmitted at a timing when the cycle instructions are output from all of the buses 91 to 94 and then executed by the modules 4, respectively.

At this time, suppose that an abnormality has been detected during transmission of the sensor value acquisition instructions A to F and the motor drive instructions A to G, and the suspension instruction function 260 has transmitted the suspension instruction to the processing device 5. In this case, the processing device 5 executes the control according to the abnormality. For example, as shown in FIG. 36, the processing device 5 may transmit the motor drive instruction for suspending the motor 42 to the modules.

Then, after the processing device 5 recovers the interface board 2 by, for example, resetting the interface board 2, the processing device 5 may resume normal transmission of the sensor value acquisition instructions and the motor drive instructions from a second control period.

In this way, as described above, the control using the cycle instructions can separate instructions by each control cycle. By repeatedly executing these instructions, the gadget (the modules 4) can be controlled. In the tenth embodiment, even when an abnormality occurs in such a case, the suspension instruction function 260 can detect the abnormality and notifies the processing device 5 of the abnormality. Accordingly, as described above, the processing device 5 can recover the abnormal state and resume the control in response to the notification from the suspension instruction function 260 of the interface board 2.

As has been described so far, the contents described in the first to eighth embodiment can be carried out without hindrance in a system in which various abnormal detection functions are embedded like the module control system 1 according to the tenth embodiment.

Note that the present invention is not limited to the above embodiments, and modifications can be made without departing from the scope thereof.

In the above first to tenth embodiment, although the dummy instructions are discarded when the dummy instructions are output from all of the bus instruction buffers 22, it is not limited to this. Even when the dummy instructions are output from all of the bus instruction buffers 22, the dummy instructions may not be discarded but instead may be transmitted to the modules 4. In this case, the dummy instructions may be those that do not influence the control on the modules 4. For example, these instructions may be those that do not execute any process even when received by the modules 4. However, it is preferable that, as described above, the dummy instructions are discarded in order to eliminate unnecessary transmission of instructions.

Further, in the above first to tenth embodiments, even when there are instructions that should be executed in an execution order, if these instructions are instructed to be transmitted to the same bus, the dummy instruction may not be inserted between these instructions. This is because there is no overtaking of the instructions for the instructions transmitted to the same bus. For example, when the execution order evaluation unit 32 determines that an instruction generated by codes in an ith line and an instruction generated by codes in an i−1th line and the lines before i−1th line will be transmitted to the same bus based on corresponding data, the execution order evaluation unit 32 may not determine that there is a restriction in an order of these instructions.

In the above first to eighth embodiments, although a specific example in which the transmission control function 20, the dummy instruction detection function 21, and the timing adjusting function 23 are achieved by circuits has been described, it is not limited to this. Alternatively, a CPU included in the microcomputer 2000 of the interface board 2 may execute a program for executing at least some of these functions. That is, as described in the ninth embodiment, in the first to eighth embodiments, the transmission function 200 and the reception function 220 may be achieved by the microcomputer 2000.

Moreover, in the above first to tenth embodiments, although an example in which a connection scheme of communication paths between the interface board 2 and the modules 4 is a bus connection has been described, it is not limited to this. The connection scheme of the connection paths between the interface board 2 and the modules 4 may be, for example, a peer-to-peer connection. In this case, the communication paths may be achieved by cables or wirelessly.

This is because even in this case, the problem described with reference to FIG. 10 still occurs if the following two conditions are satisfied.
Condition 1: (the number of communication paths between the interface board 2 and the modules 4×a speed of the communication paths)<a speed of a communication path between the external calculator 3 and the interface board 2
Condition 2: there is a deviation in the number of instructions transmitted through the communication paths between the interface board 2 and the modules 4

In the peer-to-peer connection, only one module 4 is connected through one communication path, while in the bus connection, a plurality of modules 4 are connected through one communication path. For this reason, in the case of the bus connection, the above problem becomes apparent when only the condition 1 is satisfied. Accordingly, in the first to tenth embodiments, it is effective when the connection scheme of the communication paths between the interface board 2 and the modules 4 is the bus connection as described above.

### REFERENCE SIGNS LIST

1 MODULE CONTROL SYSTEM
2 INTERFACE BOARD
3 EXTERNAL CALCULATOR
4 MODULE
5 PROCESSING DEVICE
6 SERVER
20 TRANSMISSION CONTROL FUNCTION
21 DUMMY INSTRUCTION DETECTION FUNCTION
22a, 22b, 22c BUS INSTRUCTION BUFFER
23 TIMING ADJUSTING FUNCTION
24 OVERFLOW DETECTION UNIT
25 TIMER
26 ERROR SIGNAL DETECTION UNIT
27 INSTRUCTION ISSUE INFORMATION COLLECTION UNIT
28 TRIGGER INSTRUCTION DETECTION FUNCTION
30 DUMMY INSTRUCTION GENERATION FUNCTION
31 INSTRUCTION GENERATION UNIT
32 EXECUTION ORDER EVALUATION UNIT
33 DUMMY INSTRUCTION DETECTION UNIT
34 CYCLE INSTRUCTION DETECTION UNIT
40 MICROCOMPUTER
41 SENSOR
42 MOTOR
43 AC MOTOR
44 DC MOTOR
45 ANALOG INPUT/OUTPUT MODULE
46 DIGITAL INPUT/OUTPUT MODULE
47 COMMUNICATION STANDARD COMPLIANT MODULE
48 CONNECTOR
49 ERROR DETECTION UNIT
50 INSTRUCTION MEMORY
51 PROCESSING FUNCTION
52 USB COMMUNICATION FUNCTION
53 SPI COMMUNICATION FUNCTION
54 VOLTAGE CONVERTER
55 ANALOG INPUT/OUTPUT UNIT
56 DIGITAL INPUT/OUTPUT UNIT
57 I2C COMMUNICATION FUNCTION
58 INTERRUPT FUNCTION
61 COMMUNITY PROVIDING UNIT
62 ONLINE SHOP PROVIDING UNIT
63 STORAGE UNIT
80 BATTERY
81 AC POWER SUPPLY
82 AC/DC CONVERTER
90 COMMUNICATION PATH
91, 92, 93 BUS
200 TRANSMISSION FUNCTION
201 INSTRUCTION ASSIGN UNIT
202 INSTRUCTION DISTRIBUTION UNIT
203 DUMMY INSTRUCTION GENERATION UNIT
209 INVERTER
211 ORDER INSTRUCTION DETECTION UNIT
212 CYCLE INSTRUCTION DETECTION UNIT
213, 214, 236, 238, 2333 OR CIRCUIT
220 RECEPTION FUNCTION
221 RECEPTION CONTROL FUNCTION
222a, 222b, 222c RECEPTION BUS INSTRUCTION BUFFER
231a, 231b, 231c DUMMY INSTRUCTION DETECTION UNIT
233a, 233b, 231c DUMMY INSTRUCTION EVALUATION FUNCTION
232, 234, 235, 239 AND CIRCUIT
237 SELECTION CIRCUIT
250a, 250b, 250c, 250d INTERRUPT DETECTION UNIT
261a, 261b, 261c, 261d ERROR DETECTION UNIT
262a, 262b, 262c, 262d, 263 OVERCURRENT DETECTION UNIT
251 OR CIRCUIT
290 SPI COMMUNICATION FUNCTION
291a, 291b, 291c, 291d I2C COMMUNICATION FUNCTION
292a, 292b, 292c, 292d, 292e, 292f, 292g, 292h CONNECTOR
293, 294 SELECTION UNIT
295 ASSIGN UNIT
297 RS485 COMMUNICATION FUNCTION
300 CPU
301 MEMORY
302 HARD DISK
303 COMMUNICATION CONTROLLER
310 INTERPRETER
311 SOURCE PROGRAM
320 PROGRAM GENERATION UNIT
321 PROGRAM EXECUTION UNIT
330 DESIGN FUNCTION
331 STORAGE FUNCTION
332 MODULE ASSEMBLING FUNCTION
333 DISPLAY FUNCTION
334 PHYSICAL SIMULATION FUNCTION
335 PROGRAMMING ENVIRONMENT
336 CONTROL DESIGN TOOL
337 USB COMMUNICATION FUNCTION
340 CONNECTION MODULE LIST DISPLAY FUNCTION
400 PROCESSING FUNCTION
401 OPERATION CONTROL UNIT
402, 403 ERROR HANDLING CONTROL UNIT
410 STORAGE DEVICE
510 CONNECTION MODULE LIST ACQUISITION FUNCTION
541, 543 Vdd OUTPUT UNIT
542 Gnd OUTPUT UNIT
601 MODULE DATA
602 DESIGN DATA
2000 MICROCOMPUTER
2331 ORDER INSTRUCTION DETECTION UNIT
2332 CYCLE INSTRUCTION DETECTION UNIT

1. An instruction execution control system comprising:
a plurality of instruction storage units configured to output instructions in an FIFO order to a plurality of instruction execution units configured to execute the instructions;
an instruction control unit configured to assign each of a plurality of the sequentially input instructions to one of the plurality of instruction storage units; and
an output control unit configured to control the output of the instructions from the plurality of instruction storage units, wherein
when the input instruction is a dummy instruction to be inserted between instructions that should be executed in an execution order, the instruction control unit distributes the input instruction to all of the plurality of instruction storage units, and
the output control unit stops the output of the instructions from the instruction storage unit, the instruction output therefrom has become the dummy instruction, to the instruction execution unit until the instructions output from all of the plurality of instruction storage units become the dummy instructions.

2. The instruction execution control system according to claim 1, further comprising a detection unit configured to detect that the instruction storage units overflow or are full and to notify an input source of the instruction of the detection.

3. The instruction execution control system according to claim 1, further comprising a timer configured to output a notification signal by a fixed cycle, wherein the output control unit stops the output of he instructions from the instruction storage units, the instruction output therefrom has become the dummy instruction, until the notification signal is output from the timer while the instructions output from all of the plurality of instruction storage units are the dummy instructions,

4. The instruction execution control system according to claim 3, further comprising:
an interface device comprising the plurality of instruction storage units, the instruction control unit, the output control unit, and the timer: and
an external device configured to output the instructions to the interface device, wherein
the external device comprises a dummy instruction detection unit that interrupts the output of the instructions to the interface device when a predetermined number of the dummy instructions is input to the interface device,
the output control unit outputs a notification signal to the dummy instruction detection unit when the instructions output from all of the plurality of instruction storage units become the dummy instructions and the notification signal is output from the timer, and
the dummy instruction detection unit resumes the interrupted output of the instructions when the notification signal is output from the output control unit.

5. The instruction execution control system according to claim 3, wherein
the instruction execution control system inputs an order instruction and a cycle instruction as the dummy instruction,
when the dummy instruction is the order instruction, the output control unit stops the output of the instructions from the instruction storage unit, the instruction output therefrom has become the order instruction, until the instructions output from all of the plurality of instruction storage units become the order instructions regardless of whether or not the timer outputs the notification signal, and
when the dummy instruction is the cycle instruction, the output control unit stops the output of the instructions from the instruction storage unit, the instruction output therefrom has become the cycle instruction, until the notification signal is output from the timer while the instructions output from all of the plurality of instruction storage units are the order instructions.

6. The instruction execution control system according to claim 5, further comprising:
an interface device comprising the plurality of instruction storage units, the instruction control unit, the output control unit, and the timer: and
an external device configured to output the instructions to the interface device, wherein
the external device comprises a cycle instruction detection unit that interrupts the output of the instructions to the interface device when a predetermined number of the cycle instructions is input to the interface device,
the output control unit outputs a notification signal to the cycle instruction detection unit when the instructions output from all of the plurality of instruction storage units become the cycle instructions, and the notification signal is output from the timer, and
the cycle instruction detection unit resumes the interrupted output of the instructions when the notification signal is output from the output control unit.

7. The instruction execution control system according to claim 5, wherein the output control unit comprises:
a plurality of dummy instruction evaluation units that evaluate as to whether the instructions output from the respective plurality of instruction storage units are one of the order instructions and the cycle instructions; and
a notification unit that notifies an input source of the instruction of an abnormality when results of the evaluation by the plurality of dummy instruction evaluation units are inconsistent.

8. The instruction execution control system according to claim 1, further comprising:
an abnormality detection unit configured to detect an abnormality in communication paths between the instruction storage units and the instruction execution units, the instructions being transmitted through the communication paths; and
an information collection unit configured to collect information related to the instruction stored in the instruction storage units when the abnormality is detected by the abnormality detection unit.

9. The instruction execution control system according to claim 1, wherein when the instruction is a trigger instruction, the instruction control unit inserts the dummy instruction before the trigger instruction and distributes the dummy instruction to all of the plurality of instruction storage units while distributing the trigger instruction to all of the plurality of instruction storage units.

10. The instruction execution control system according to claim 1, wherein the instruction storage units discard the dummy instructions when the stopped output of the instructions from the output control unit is canceled.

11. The instruction execution control system according to claim 1, further comprising:
an interface device comprising the plurality of instruction storage units, the instruction control unit, and the output control unit: and
an external device configured to output the instructions to the interface device, wherein
the external device comprises:
an instruction generation unit configured to generate the instructions;
an execution order evaluation unit configured to evaluate as to whether or not there are instructions that should be executed in an execution order among the instructions generated by the instruction generation unit; and
a dummy instruction generation unit configured to generate the dummy instruction and insert the dummy instruction between the instructions which the execution order evaluation unit has evaluated should be executed in the execution order.

12. An instruction execution control method comprising:
an instruction control step for assigning each of sequentially input instructions to one of the plurality of instruction storage units; and
an instruction output step for outputting, in an FIFO order, the instructions stored in each of the plurality of instruction storage units to a plurality of instruction execution units, the plurality of instruction execution units each executing the instructions, wherein
in the instruction control step, when the input instruction is a dummy instruction to be inserted between instructions that should be executed in an execution order, the input instruction is distributed to all of the plurality of instruction storage units, and
in the instruction output step, the output of the instructions from the instruction storage unit, the instruction output therefrom has become the dummy instruction, to the instruction execution unit is stopped until the instructions output from all of the plurality of instruction storage units become the dummy instructions.
